(19) United States
(12) Patent Application Publication
(10) Pub. No.: US 2010/0105975 A1
(43) Pub. Date: Apr. 29, 2010

(54) Nuclear Assisted Hydrocarbon Production Method

(76) Inventor: JAMES RUSSELL BAIRD, NANAIMO (CA)

Correspondence Address: James Russell Baird, 293 Harwell Road, Montreal, QC, H4A 2Z6, CA

(21) Appl. No.: 12/249,928

(22) Filed: Oct. 12, 2008

(51) Int. Cl. G21F 9/00; E21B 43/00

(52) U.S. Cl. 588/16; 166/247

(57) ABSTRACT

A method is disclosed for the temporary or permanent storage of nuclear waste materials comprising the placing of waste materials into one or more repositories or boreholes constructed into an unconventional oil formation. The thermal flux of the waste materials fracture the formation, alters the chemical and/or physical properties of hydrocarbon material within the subterranean formation to allow removal of the altered material. A mixture of hydrocarbons, hydrogen, and/or other formation fluids are produced from the formation. The radioactivity of high-level radioactive waste affords proliferation resistance to plutonium placed in the periphery of the repository or the deepest portion of a borehole.

### BACKGROUND OF THE INVENTION

1. Field of the Invention

The present invention relates generally to methods and systems for storage of spent nuclear fuel and plutonium and the production of hydrocarbons, hydrogen gas (H₂), and/or other products from various unconventional oil formations. Certain embodiments relate to in situ conversion of hydrocarbons using a spent nuclear fuel heat source to produce hydrocarbons, H₂, and/or novel product streams from underground unconventional oil formations.

2. Description of the Prior Art

The problem of storage of nuclear waste products from both military and civilian sources is presently becoming so acute that further progress, particularly in the field of development of nuclear energy, is threatened. The United States is in gridlock regarding nuclear waste management. Existing nuclear power plants have become de facto long-term storage sites using facilities, which were designed only to temporarily house such materials. The lack of a publicly acceptable solution to the problem of nuclear waste impedes the potential of nuclear power to address what many consider is an emerging energy crisis in the United States. There are three main problems associated with nuclear waste; radioactivity, heat and the weapons potential of plutonium in the waste. For a repository at Yucca Mountain, the U.S. Nuclear Regulatory Commission (NRC) has established a peak radiation dose limit of 15 mrem/year for people living in the vicinity of the repository, with no more than 4 mrem/year from certain radionuclides in the groundwater. These limits were based on U.S. Environmental Protection Agency (EPA) standards set for individual radiation protection. In EPA's 2001 final standards rulemaking the Agency noted that it is not possible to make reliable estimates of the repository's performance over such long time frames. In the face of these uncertainties, EPA adopted a 10,000-year compliance period. However Jul. 9, 2004 the United States Court of Appeals determined that the 10,000-year regulatory period was not “based upon and consistent with” with National Academy of Science (NAS) findings, as required by Section 801 of the U.S. Energy Policy Act of 1992. In a 1995 study NAS had recommended “that compliance with the standard be measured at the time of peak risk, whenever it occurs.” The Department of Energy's (DOE) projections show that the peak risk to an individual from leaking radioactivity from a Yucca Mountain repository would occur at about 300,000 years after closure of the site and that the peak dose would be 37 to 150 times greater than permitted by the EPA's groundwater protection standard. It has also been argued that igneous disruption at Yucca Mountain could return radioactivity to the surface. Radiation from spent nuclear fuel (SNF) can cause serious harm or death thus it is important this radiation be isolated from the biosphere. High-level radioactive waste (HLW) from nuclear reactors may contain plutonium. Ordinarily, this plutonium is reactor-grade plutonium (RGP), containing a mixture of plutonium-239 (highly suitable for building nuclear weapons), plutonium-240 (an undesirable contaminant and highly radioactive), plutonium-241, and plutonium-238. These isotopes are difficult to separate but it is generally agreed RGP can produce a highly destructive explosion. Moreover, HLW is full of highly radioactive fission products. Most fission products are relatively short-lived. This is a concern since if the waste is stored, perhaps in deep geological storage as is widely considered the present state-of-the-art, over many years the fission products decay, decreasing the radioactivity of the waste and making the plutonium easier to access. It is desirable therefore, as a proliferation precaution, that SNF should be disposed of in a country that currently possess nuclear weapons or one with a demonstrated capability to build and maintain its own nuclear arsenal but has chosen not to do so. Fission products and actinides existing in SNF produce enough heat to produce mechanical cracking and hydro-fraturing of the rock surrounding a repository. To reduce these effects that would degrade the geologic containment properties of a repository it has been recommended HLW be stored for at least a century before being permanently sequestered. Heat production from the short-lived fission products in nuclear waste falls an order of magnitude per decade for most spent fuels. A CANDU fuel bundle produces 2,000 Watts after it leaves a reactor, 60 W after one year and 1 W after 100 years. Swedish spent fuel produces (per tonne of U) 10⁴ W after 1 year and 1 W after 1000 years. Century long cooling would virtually eliminate the problem of thermal stresses and would allow closer packing in a repository and the more sophisticated engineering of smaller cavities. The zone of a rock mass influenced by an excavation increases in size with at least the square, and possibly the cube, of the largest dimension of the excavation therefore to preserve the geologic containment properties of a repository the excavation should be kept as small as possible. Century long storage would also reduce the chance of hydrothermal convection transporting hazardous material from a geologic waste repository back into the biosphere. According to Hardin, E. L., et al. 1998. Near-Field/Altered-Zone Models Report. Milestone report for the CRWMS Management and Operating Contractor, DOE, UCRL-ID-129179. SP3100M3. Livermore, Calif.: Lawrence Livermore National Laboratory, “Radioactive decay of high-level nuclear waste emplaced in a Yucca Mountain repository will produce an initial heat flux on the order of 30 to 50 times the heat flux in the Geysers geothermal reservoir in California.” Another alternative that has been suggested to reduce the thermal flux of SNF is the removal of the long-lived actinides from the waste but this is expensive and many argue is a proliferation risk because of the weapons potential of the actinide plutonium. The reprocessing of SNF to recover plutonium for nuclear weapons or for energy production has also resulted in extensive environmental degradation of the sites where the fuel was reprocessed. Current reprocessing art has not progressed much beyond the methods that have caused past environmental damage and would likely cause considerable further damage if implemented. The radiation emitted by SNF can ionize water into its hydrogen and oxygen components, which can react with spent fuel bundles and their containers to increase the potential for hazardous material transport beyond the confines of a nuclear waste repository.

In a Dec. 1, 2007 presentation to The Santa Fe Council on International Relations, Richard Garwin, IBM Fellow Emeritus stated, “It will probably take a terrorist explosion to bring the world to the shared commitment that such a thing should never happen again, and that nuclear war with large numbers of nuclear weapons would not be a good idea either . . . . When that commitment does exist, the International Atomic Agency (IAEA) will have its budget for safeguards and enforcement multiplied by five or ten from the current $109 M per year. Enrichment facilities will either be openly operated under the control of IAEA and a supporting coalition of nations, or they will be shut down and dismantled. The secure fuel cycle will operate with competitive, commercial, mined geologic repositories in various countries of the world, to reduce the amount of aged spent fuel potentially available to terrorists or proliferators, and far better security will be provided to the fresh fuel and to the spent fuel in cooling ponds near reactors.”

Century long temporary storage of HLW does not address the acute threat to the development of nuclear energy posed by current inventories of SNF, nor does it secure the fuel cycle. The aging of this fuel also increases the potential availability of plutonium to terrorist or proliferators.

Some have explored finding alternate approaches to deep geological disposal. For example, disposal in deep boreholes (over 2 km depth) drilled from the surface has received some study, but on the whole would require substantial research and development and may be impracticable.

Canadian Patent 2,005,376 and U.S. Pat. No. 5,022,788 have been issued to this writer for a method for the disposal of nuclear and toxic waste materials comprising the placing of waste materials into waste repositories radiating from an access tunnel constructed into a subtending tectonic plate adjacent or as near as possible a subduction zone. The waste materials descend within the tectonic plate into the mantle of the earth. The cost of research has proven a barrier to the development of this approach as well.

Options other than geologic storage have been considered, including launching waste into space and disposal in deep sea beds or Antarctic ice sheets. These have been judged too risky or infeasible, or violate international treaties.

It is evident that either a new approach, an improved approach or a less expensive approach is needed to resolve the problems associated with the current nuclear waste disposal art.

With the Cold War behind them, the United States and Russia pledged to eliminate excess weapons-grade plutonium (WGP) in order to prevent its theft or diversion for illegal nuclear programs and to prevent its reincorporation into their weapons programs. On Mar. 1, 1995, approximately 200 metric tons (MT) of U.S.-origin weapons-usable fissile materials were declared surplus to U.S. defense needs (38.2 MT of WGP and 174.3 MT of highly enriched uranium). In addition, DOE announced that it had 14.3 MT of other than WGP that would be included in the disposition program. From a nonproliferation standpoint, plutonium is of the greatest concern because only 8 kilograms are needed to make a nuclear bomb with a yield equal to that of the device used on Nagasaki. In July 1998, the U.S. and Russian governments signed an agreement on scientific and technical cooperation to govern joint activities in plutonium disposition. The United States and Russia each declared 50 MT of plutonium to be surplus to their security needs. In September 2000, both countries formally agreed to transform 34 MT each of excess military plutonium into a proliferation-resistant form over the course of 20 years. Russia intends to irradiate all 34 MT of its plutonium in commercial nuclear power reactors, utilizing the so-called MOX fuel option. According to the 2000 agreement, the United States also planned to irradiate the majority of its surplus plutonium as MOX fuel. The rest of the U.S. plutonium was planned to be immobilized with highly radioactive waste for subsequent deep-earth disposal. In early 2002, due to steep increases of the U.S. disposition program costs, the U.S. administration announced its decision to concentrate on the MOX option solely, canceling the immobilization track.

Plutonium disposition programs in both countries are still in early stages. The start-up costs of plutonium disposition are extremely high, as neither Russia nor the United States has industrial-scale MOX fuel production facilities. The Russian program is currently estimated at $2 billion, and the U.S. program at $3.8 billion. However, international funding for the Russian program has not yet been secured. In addition to remaining financial uncertainties about the Russian program, other implementation issues, including verification, monitoring, licensing and others, must be resolved before the program in both countries can move forward. The year 2007, initially agreed in the September 2000 agreement as the start date for plutonium irradiation has passed without an ounce of plutonium being irradiated.

Producing fissile materials is the major obstacle to the manufacturing of nuclear weapons by proliferant states and terrorists. Thus, elimination of surpluses of military plutonium would greatly reduce the risk that it could be stolen or diverted to illegal nuclear programs, and also ensures that neither the United States nor Russia will reincorporate it into warheads in the future. In addition, disposition of plutonium would reduce storage costs of plutonium, which are very high over the long term.

Unlike weapons-grade uranium, which can be rendered unusable for nuclear weapons by blending it with lower-grade uranium (a blend that can then be used as fuel in nuclear power plants), plutonium cannot be blended with other materials or diluted to make it unusable in weapons. However, steps can be taken to greatly complicate the use of plutonium for nuclear arms. The process of separating plutonium and uranium from spent fuel is technically difficult and expensive. Consequently, plutonium in spent fuel is considered to have relatively modest proliferation risk. For the disposition of WGP, specialists have sought to devise methods based on these properties of spent fuel to make WGP inaccessible for weapons use, a goal commonly known as the “spent fuel standard.”

During the early 1990s, U.S. and Russian technical and government committees considered several plutonium disposition options. In the end, two options were identified as meeting the two states' nonproliferation objectives: (1) irradiating plutonium as nuclear power reactor fuel; and (2) immobilizing it with HLW in an inert matrix (such as glass or ceramic), and then disposing of the material in a geologic repository, where other nuclear wastes will also be stored.

The irradiation option involves the production of special fuel consisting of both plutonium and uranium oxides, which is called mixed-oxide, or MOX, fuel. Russia considers plutonium a valuable energy source and insists on using its surplus plutonium as fuel rather than immobilizing it. Moreover, because irradiation of MOX in nuclear power plants transforms WGP into lesser quality RGP (while immobilized plutonium remains weapons-grade), Russia insisted that the United States adopt the MOX option as well for the bulk of its surplus plutonium. Russia argued that if the United States merely immobilized its surplus plutonium, the United States might some day re-separate the WGP and reuse it for nuclear arms.

To ensure that plutonium subject to disposition is irreversibly removed from use in nuclear weapons, the September 2000 agreement specified the two sides would implement monitoring and inspection activities. The agreement also provides for IAEA verification once appropriate agreements with the IAEA are concluded.

Opponents of the MOX burning option assert that immobilization of plutonium is safer, faster, and cheaper. They also argue that channeling WGP into the civilian nuclear fuel cycle would increase, rather than decrease, the risk of diversion of the material. In addition, burning MOX fuel in reactors would reduce—but not completely eliminate—military plutonium in the resulting spent fuel. Thus, after years of “cooling” the irradiated fuel elements, the two countries would have to decide what to do with the spent fuel, which would still contain plutonium, although at significantly lower level than fresh MOX fuel. The United States plans to dispose of its spent MOX fuel in a geologic repository, along with conventional spent fuel from nuclear power plants. Russia's plans are uncertain, but it has reserved the right to reprocess its spent MOX fuel once all 34 MT of plutonium are irradiated—that is, to separate plutonium from the spent MOX fuel for reuse in “second generation” MOX fuel for nuclear power plants.

In addition to weapons plutonium, the accumulation of civil plutonium is of concern. Current light water reactor fuel cycles (LWRs) were originally envisioned to include continuous reprocessing of spent fuel and the eventual use of fast reactor technology to close the fuel cycle. Failure to evolve beyond current once-through fuel cycles has resulted in unabated growth in plutonium inventories. Globally, civilian reactors have discharged some 1400 MT of plutonium, and this inventory is projected to grow by 75 MT per year.

Every country that has embarked on commercial reprocessing has accumulated a huge stockpile of separated plutonium. Plutonium separation by the civilian reprocessing industry has gotten so far ahead of plutonium recycling that the world stockpile of separated civilian plutonium has reached 330 tons and is still growing. Using the IAEA's conservative assumption that 8 kilograms is required to produce a first-generation nuclear bomb, this material represents more than 30,000 bomb equivalents—an enormous potential threat.

For the foreseeable future civil plutonium will be separated faster than it will be used in reactors. This is partly due to the limited capacity for mixed oxide fuel fabrication. As a result, approximately 20 tons of plutonium will be separated each year, and at most, less than one-half of this would be used in the reactors.

These expanding stockpiles of plutonium resulting from civil reprocessing are a growing proliferation concern.

It is evident that either a new approach, an improved approach, a less expensive approach, or an approach that would be mutually acceptable to the nuclear weapon state parties to the Treaty on the Non-Proliferation of Nuclear Weapons (NPT) is needed to resolve the problems associated with the current art for disposing of plutonium of both military and civilian origin.

The best long-term permeability data for moderately deep systems are to be derived from older rocks carrying significant deposits of oil and gas. Such rocks are invariably of sedimentary origin, and it is for sediments that the most reliable data on fluid flow are at present to be found. The fact that oil and gas, often under significant pressure, are found in these formations is proof of the containment properties of sedimentary rock.

Heavy oil, oil sands, oil shale and bitumen exist in amounts, greater than remaining reserves of conventional oil. Recovery of this unconventional oil is more costly and energy intensive than conventional drilling. Estimates range between 1.5 and 6 units of energy can be produced for each unit of energy provided for North American oil shale or heavy oil production methods. In most instances using the current art this energy will come from fossil fuel burning and thus significant amounts of carbon dioxide (CO2) will be produced. CO₂ is a greenhouse gas (GHG) that reduces the Earth's radiant heat loss to space and contributes to global temperatures rise. It is believed this temperature rise may be reaching critical levels thus there is a global demand to decrease the release of CO₂ into the atmosphere.

The fossil fuels currently used to recover North America's unconventional oil are also expensive and better used for other purposes such as making electricity and home heating. Burning a clean fuel [natural gas] to make a dirty fuel [from oil sands] has been characterized as a form of reverse alchemy, like turning gold into lead.

Hydrocarbons obtained from subterranean (e.g., sedimentary) formations are often used as energy resources, as feedstocks, and as consumer products. Concerns over depletion of available hydrocarbon resources and over declining overall quality of produced hydrocarbons have led to development of processes for more efficient recovery, processing and/or use of available hydrocarbon resources. In situ processes may be used to remove hydrocarbon materials from subterranean formations. Chemical and/or physical properties of hydrocarbon material within a subterranean formation may need to be changed to allow hydrocarbon material to be more easily removed from the subterranean formation. The chemical and physical changes may include in situ reactions that produce removable fluids, composition changes, solubility changes, density changes, phase changes, and/or viscosity changes of the hydrocarbon material within the formation. A fluid may be, but is not limited to, a gas, a liquid, an emulsion, a slurry, and/or a stream of solid particles that has flow characteristics similar to liquid flow.

Kerogen is a mixture of organic chemical compounds that make up a portion of the organic matter in sedimentary rocks. It begins as living organisms, becomes sediment, (comparable to top soil) and then, as they are overlain, begin the change from sediment to sedimentary rock—a process know as diagenesis. Kerogen is insoluble in normal organic solvents because of the huge molecular weight (upwards of 1,000) of its component compounds. The soluble portion is known as bitumen. When heated to the right temperatures in the Earth's crust, some types of kerogen release oil or gas, collectively know as hydrocarbons. When such kerogens are present in high concentration in rocks such as shale, and have not been heated to a sufficient temperature to release their hydrocarbons, they may form oil shale deposits or heavy oil.

The temperature required to crack the complex carbon bonds in kerogen to release oil or gas is at least 50° C. with some producing oil fields having temperatures as high as 115° C. The basic principle is that an undisturbed geologic formation's temperature increases predictably with depth. The increase in temperature with depth is the geothermal gradient and is approximately 1.8° C. per 100 m. Once kerogen has been buried by approximately 2,700 m of sediment it attains the temperature required (50° C.) to start breaking down the atomic bonds of its long chain molecules to produce conventional oil.

Heavy oil is any type of crude oil which does not flow easily. It is referred to as “heavy” because its density or specific gravity is higher than light crude oil. Heavy crude oil has been defined as any liquid petroleum with an API gravity less than 20°.

Lloydminster Heavy Oils of Alberta and Saskatchewan, Canada, were produced in rock that was too shallow for millions of years to produce oil then was covered by sufficient sedimentation to start the conversion process and then massive erosion removed sufficient overburden to lower the temperature sufficiently to halt conversion. The temperature of Lloydminster Heavy Oil is less than 22° C. so this material must be warmed approximately 30° C. to complete the in situ cracking of the heavy oil molecules to produce conventional oil.

Bitumen is a mixture of organic liquids that are highly viscous, black, sticky, entirely soluble in carbon disulfide, and composed primarily of highly condensed polycyclic aromatic hydrocarbons. Naturally occurring or crude bitumen is a sticky, tar-like form of petroleum which is so thick and heavy that it must be heated or diluted before it will flow. At room temperature, it is much like cold molasses. Refined bitumen is the residual (bottom) fraction obtained by fractional distillation of crude oil. It is the heaviest fraction and the one with the highest boiling point, boiling at 525° C. Geologists speculate that the bitumen found in Alberta's oil sands is the result of bacteria feeding on the lighter hydrocarbon chains that were formed millions of years ago from the remains of tiny creatures buried in the seabed of an ancient ocean that covered the province. The light oil eventually migrated, saturating large areas of sand near the surface where the bacteria consumed all but the molasses-like bitumen.

Oil sands consist of a combination of sand and clay with bitumen. About one third of the world's reserves are in Venezuela, one third in Canada and the rest mainly in the Middle East. In its natural state, bitumen will not flow to a wellbore. The major challenge of recovering bitumen from depth is to overcome its high viscosity to allow it to flow to a wellbore. To do this, thermal (or other non-primary) in-situ methods are used, most commonly Cyclic Steam Stimulation (CSS) and Steam Assisted Gravity Drainage (SAGD) both of which are methods patented by Imperial Oil Limited.

Canada's largest in-situ bitumen recovery project uses CSS at Cold Lake. Steam injected down the wellbore into the reservoir heats the bitumen, followed by a soak time, and then the same wellbore is used to pump up fluids. At Cold Lake, Alberta about 3200 wells are currently operating from multiple pads, with two above ground pipelines, one to deliver steam and the other to transport fluids back to the processing plant. At Athabasca, the SAGD technology is used. Horizontal well pairs (700 metres long with 5-metre vertical separation) are drilled from surface pads to intersect bitumen pay. Steam from the upper injector well expands, reducing the viscosity of the bitumen, allowing the bitumen to flow. A shell forms at the cold interface with the unheated reservoir, along which heated bitumen/condensate drain by gravity to the lower producing well. Locally electrical submersible pumps (ESPs) may assist in lift.

Oil shale extraction refers to the process in which kerogen is converted into synthetic crude oil through the chemical process of pyrolysis. In this process, oil shale is heated in the absence of oxygen to a temperature at which oil shale is decomposed and kerogen is pyrolysed into a petroleum-like condensable shale oil—a form of non-conventional oil—and combustible shale gas (shale gas can also refer to gas occurring naturally in shales). The process also produces a solid residue in form of spent shale (char). Decomposition of oil shale begins at relatively low temperatures but proceeds more rapidly and more completely at higher temperature.

The extraction techniques can be broadly classified into two primary methods, the ex situ method and the in situ method. There are hundreds of patents for oil shale retorting technologies. However, only a few dozen have been tested in a pilot plant (with capacity 1 to 10 tonnes of oil shale per hour) and less than ten technologies have been tested at a demonstration scale (40 to 400 tonnes per hour). As of 2008, only four technologies are in commercial use, namely Kiviter, Galoter, Fushun, and Petrosix.

All oil shale processes require a source of heat. The non-condensable retort gas and char may be burnt and the heat energy may be reused for heating the raw oil shale or generating electricity. Also heat of the spent shale may be reused for the same purpose. Most commercial technologies burn the oil shale at the deposit to supply heat or reuse the spent shale, supplemented by gas or other fuels, although some experimental methods use electricity, radiofrequency and microwaves, reactive fluids. The heating methods may be direct or indirect heating and there are several methods for the heat transfer. Almost all commercial retorts currently in operation or in development stages are internal heating retorts.

U.S. Pat. No. 7,225,866 to Berchenko, et al., proposes an in situ thermal method for processing of an oil shale formation using a pattern of heat sources.

Section 526 of the U.S. Energy Independence and Security Act of 2007 prohibits a federal agency from entering into a contract for procurement of an alternative or synthetic fuel, including a fuel produced from unconventional petroleum sources, for any mobility-related use (other than for research or testing), unless the contract specifies that the lifecycle GHG emissions associated with the production and combustion of the fuel supplied under the contract must, on an ongoing basis, be less than or equal to such emissions from the equivalent conventional fuel produced from conventional petroleum sources.

No current technology for producing unconventional petroleum from heavy oil, oil sand or oil shale can meet this standard. The potential for developing America's unconventional oil using existing technology or selling foreign sourced unconventional oil produced with existing technology in the United States of America is therefore limited.

It is evident that a less carbon intensive and more economical approach is needed to produce North America's unconventional petroleum sources.

Radiolysis is the dissociation of molecules by radiation. The high-energy flux of SNF in a kerogen formation would dissociate (fracture) the long chain kerogen molecules into oil and gas.

Water dissociates under alpha radiation, as is emitted by plutonium actinides in SNF, into hydrogen and oxygen. The presence of hydrogen in a kerogen formation would assist in cracking long chain molecules in a similar fashion to the hydrocracking method. Major products from hydrocracking are jet fuel, diesel, relatively high octane rating gasoline fractions and LPG. All these products have a very low content of sulfur and contaminants.

### SUMMARY OF THE INVENTION

The present invention is concerned with disposing of nuclear waste and, more specifically, to a method of disposing of nuclear waste in underground rock formations using either a horizontal repository or multiple vertical boreholes.

An objective of the present invention is to provide a viable, economic, competitive and commercial, geologic repository or repositories in either Canada and/or the United States of America, under the control of the IAEA, to reduce the potential availability of aged spent fuel to terrorists or proliferators.

Another objective of this invention is to provide a means and political setting for the storage of SNF that affords the future option of retrieval, either to recover the uranium and plutonium from the aged spent fuel for future energy needs or in the case of unforeseen environmental consequence, or leaving the waste permanently emplaced in a safe geologic formation.

In an embodiment WGP excess to defense needs and/or RGP reprocessed from spent commercial fuel is placed in the side wall of an underground repository such that HLW later inserted in the repository will provide a radiological barrier preventing access to said plutonium.

In some embodiments WGP excess to defense needs and/or RGP reprocessed from spent commercial fuel is inserted in vertical boreholes in an unconventional oil formation such that HLW later inserted above the plutonium provides a radiological barrier preventing access to said plutonium.

Another objective of the present invention is to minimize the size of the excavation of a geologic repository to preserve the containment properties of the sedimentary geology in which the waste is placed.

Another object of the present invention is to provide a method of disposing of nuclear waste in an underground sedimentary rock formation, which will provide prolonged safety from the nuclear waste and added protection to human health and the environment.

In some embodiments nuclear waste is buried in an underground sedimentary rock formation, in a horizontally extending repository positioned well below the earth's surface.

In some embodiments nuclear waste is placed in vertically extending boreholes in an underground formation.

In some embodiments the heat flux of SNF in an unconventional oil formation cracks and mobilizes unconventional oil.

In some embodiments the heat produced by SNF placed in a repository produces mechanical cracking and hydro-fraturing in an unconventional oil formation to facilitate mobility and recovery of the unconventional oil.

In some embodiments bitumen is produced using a Nuclear Assisted Gravity Drainage method where a non carbon dioxide emitting, in situ, nuclear waste repository or open boreholes filled with nuclear waste substitute for the steam chamber in the SAGD method.

In some embodiments a pattern of bore holes filled with nuclear waste provides a non-greenhouse gas emitting heat source for extracting oil from shale.

In some embodiments the high-energy flux of SNF in a kerogen formation dissociates (fractures) the long chain kerogen molecules into oil and gas.

In some embodiments the hydrogen dissociated from in situ water in an unconventional oil formation facilitates hydrocracking of long chain kerogen molecules.

In some embodiments the heat flux of nuclear waste fractures a portion of a formation to facilitate the flow of synthetic oil produced by radiolysis, hydrocracking and/or pyrolysis to a collecting wellbore.

Another objective of this invention is to produce unconventional oil sources with the least possible concurrent production of the GHG CO₂.

Another objective of this invention is to use the containment properties of rocks of sedimentary origin to permit the option of either temporary or permanent disposition of nuclear waste within the sedimentary formation.

According to the invention, there is provided a method for disposing nuclear waste material comprising the steps of (a) forming a repository in an unconventional oil formation; (b) inserting SNF into said repository; and (c) recovering hydrocarbons, H₂, and/or other formation fluids produced by the heat of said SNF.

The novel features which are considered characteristic for the invention are set forth in the appended claims. The invention itself, however, both as to its construction and its method of operation, together with additional objects and advantages thereof, will be best understood from the following description of the specific embodiments when read and understood in connection with the accompanying drawings. Attention is called to the fact, however, that the drawings are illustrative only, and that changes may be made in the specific construction illustrated and described within the scope of the appended claims.

Other objects and advantages of the present invention will be apparent upon consideration of the following specification, with reference to the accompanying drawings in which like numerals correspond to like parts shown in the drawings.

### BRIEF DESCRIPTION OF THE DRAWINGS

Reference will now be made to preferred embodiments of the present invention, by way of example only, in which:

FIG. 1 depicts the location of unconventional oil deposits in the United States of America.

FIG. 2 depicts the location of Alberta unconventional oil deposits.

FIG. 3 depicts the effect of ionizing radiation as it passes through matter for reference.

FIG. 4 is a vertical cross-section through a geothermal reservoir.

FIGS. 5(a), (b), (c) and (d) show four kinds of hydrocarbon traps for reference.

FIG. 6 depicts the hydraulic conductivity of rocks and soil.

FIG. 7 depicts the decay heat/time generated by spent PWR fuel irradiated to 50 GWd/MTHM for reference.

FIG. 8 depicts the Transient Thermal Response of a Repository at Yucca Mountain with removal of Plutonium and Americium from Spent PWR Fuel with increased drift loading for reference.

FIG. 9 depicts the effects of heat conduction in a HLW repository.

FIG. 10 depicts a horizontal HLW repository for reference.

FIG. 11 depicts vertical boreholes for HLW for reference.

FIG. 12 depicts a temporary/permanent repository.

FIG. 13(a) depicts the irretrievable placement of plutonium in a repository.

FIG. 13(b) is a plan view of a repository in which plutonium has been placed, prior to insertion of HLW

FIG. 14 depicts the irretrievable placement of plutonium in a borehole.

FIG. 15 depicts a van Krevelen diagrams for reference.

FIG. 16 is a schematic of the oil window for reference.

FIG. 17 is a schematic of the radiolysis of water for reference.

FIG. 18 depicts high-energy flux of SNF cracking long chain kerogen molecules according to another aspect of the present invention.

FIG. 19 is a plot of the oil viscosity (cp) versus temperature for Athabasca Bitumen, Canada (8.6° API).

FIG. 20 depicts a schematic cross-section of the heavy oil formation beneath Lloydminster, Alberta.

FIG. 21 depicts a schematic cross-section of the oil sands Alberta.

FIG. 22 depicts a Nuclear Assisted Gravity Drainage (NAGD) chamber according to a one aspect of the present invention.

FIG. 23 is a schematic vertical cross-section of the Green River oil shale formation in the central portion of the Piceance Basin area of Colorado.

FIGS. 24(a) (b) and (c) depicts the stages of heat flux fracturing of a formation for reference.

FIG. 25 is a schematic vertical cross section of an oil shale pattern of boreholes according to the current art.

FIG. 26 depicts a cross-sectional representation of an embodiment for treating a lean zone and a rich zone of a formation.

FIGS. 27(a) (b) and (c) depicts the treatment of an oil shale formation using a series of horizontal repositories.

FIG. 28 depicts an illustration of stages of heating an oil shale formation.

FIG. 29 is a schematic vertical cross section of geothermal energy production according to one embodiment of the current invention.

FIG. 30 is a pie chart of the potential energy saving afforded by this invention to produce North America's unconventional oil, and

FIG. 31 depicts the CO₂ saving afforded by this invention.

### DESCRIPTION OF THE PREFERRED EMBODIMENT

In respect of the following and previously set out description and explanation, it should be understood that while the information given is considered to be correct, such explanations are necessarily somewhat speculative since the amount of factual information relating to geologic processes that took place millions of years ago is limited. Applicant would not want to be bound, therefore, by the following if, subsequently, new and better information becomes available. The explanations hereinafter given are made for the purpose of full and complete disclosure of the invention but the qualification given above should be borne in mind.

The following description generally relates to systems and methods for eliminating SNF and plutonium in an unconventional oil formation. Such formations may be treated to yield relatively high quality hydrocarbon products, H₂, and other products.

“Hydrocarbons” are organic material with molecular structures containing carbon and hydrogen. Hydrocarbons may also include other elements, such as, but not limited to, halogens, metallic elements, nitrogen, oxygen, and/or sulfur. Hydrocarbons may be, but are not limited to, kerogen, bitumen, pyrobitumen, oils, natural mineral waxes, and asphaltites. Hydrocarbons may be located within or adjacent to mineral matrices within the earth. Matrices may include, but are not limited to, sedimentary rock, sands, silicilytes, carbonates, diatomites, and other porous media. “Hydrocarbon fluids” are fluids that include hydrocarbons. Hydrocarbon fluids may include, entrain, or be entrained in non-hydrocarbon fluids (e.g., H₂), nitrogen (N₂), carbon monoxide, CO₂, hydrogen sulfide, water, and ammonia).

A “formation” includes one or more hydrocarbon containing layers, one or more non-hydrocarbon layers, an overburden, and/or an underburden. An “overburden” and/or an “underburden” includes one or more different types of impermeable materials. For example, overburden and/or underburden may include rock, shale, mudstone, or wet/tight carbonate (i.e., an impermeable carbonate without hydrocarbons). In some embodiments of in situ conversion processes, an overburden and/or an underburden may include a hydrocarbon containing layer or hydrocarbon containing layers that are relatively impermeable and are not subjected to temperatures during in situ conversion processing that results in significant characteristic changes of the hydrocarbon containing layers of the overburden and/or underburden. For example, an underburden may contain shale or mudstone. In some cases, the overburden and/or underburden may be somewhat permeable.

In this specification the following terms shall have the following meanings. The term “spent nuclear fuel” (SNF) shall mean nuclear fuel that has been irradiated in a nuclear reactor (usually at a nuclear power plant) to the point where it is no longer useful in sustaining a nuclear reaction. The term “radionuclide” shall mean an unstable isotope of an element that decays or disintegrates spontaneously, emitting radiation. The term “unconventional oil” shall mean resources such as oil shale, bitumen and heavy oil that can be liquefied and used like oil. The term “heavy oil” shall mean a type of crude oil that is very viscous and does not flow easily. The common characteristic properties are high specific gravity, low hydrogen to carbon ratios, high carbon residues, and high contents of asphaltenes, such as might be found under Lloydminster, Alberta. The term “bitumen” shall mean heavy or viscous hydrocarbons and covers a wide range of in situ characteristics, such as might be found in the Alberta tar sands. The term “oil shale” shall mean a sedimentary rock containing solid, combustible organic matter, often called kerogen, in a mineral matrix that is largely insoluble in petroleum solvents, but decomposes to yield oil when heated, such as might be found in the United States in the Green River Formation, which covers portions of Colorado, Utah, and Wyoming. The term “repository” shall mean a place to store SNF and/or RGP separated from SNF and/or weapons-usable fissile materials from nuclear weapons dismantlement and production processes. A repository shall be a drift or tunnel essentially horizontally bored from a vertical shaft into an unconventional oil formation and/or a vertically drilled borehole. A repository shall store SNF and/or plutonium either permanently or for for latter reuse. The term “Bremsstrahlung” shall mean electromagnetic radiation produced by the deceleration of a charged particle, such as an electron, when deflected by another charged particle, such as an atomic nucleus. The term “high-level waste” (HLW) shall mean, irradiated fuel and the liquid and sludge from reprocessing irradiated fuel to recover plutonium (including solids resulting from stabilization of reprocessing wastes). The term “pyrolysis” shall mean the transformation of kerogen into one or more hydrocarbons by heat alone without oxidation. The term “spent fuel standard” shall mean the equivalent level of proliferation resistance afforded plutonium in SNF, which because of radioactivity, is a tremendous danger to anyone exposed to it, and must be reprocessed before plutonium can be available for weapons use. The term “diagenesis” shall mean the low-temperature chemical and biological reactions undergone by sediment after its initial deposition and during and after its lithification, exclusive of surface alterations. The term “catagenesis” shall mean the cracking process in which organic kerogens are broken down into bitumen and wet gas. The term “metagenesis” shall mean the stage in the kerogen maturation process following catagenesis in which dry-gas is generated. The term “senescence” shall mean the biological processes of a living organism approaching an advanced age (i.e., the combination of processes of deterioration which follow the period of development of an organism). The term “Condensable hydrocarbons” shall mean hydrocarbons that condense at 25° C. at one atmosphere absolute pressure. Condensable hydrocarbons may include a mixture of hydrocarbons having carbon numbers greater than 4. “Non-condensable hydrocarbons” are hydrocarbons that do not condense at 25° C. and one atmosphere absolute pressure. Non-condensable hydrocarbons may include hydrocarbons having carbon numbers less than 5. The terms “formation fluids” and “produced fluids” refer to fluids removed from an unconventional oil formation and may include pyrolyzation fluid, synthesis gas, mobilized hydrocarbon, and water (steam). The term “pyrolyzation fluids” or “pyrolysis products” refers to fluid produced substantially during pyrolysis of hydrocarbons. Fluid produced by pyrolysis reactions may mix with other fluids in a formation. The mixture would be considered pyrolyzation fluid or pyrolyzation product. As used herein the term “light hydrocarbon fractions” refers hydrocarbons of a carbon number less than 25 that have been generated by the maturation and/or fracturing of kerogen or bitumen. The term “carbon number” shall mean the number of carbon atoms within a molecule. A hydrocarbon fluid may include various hydrocarbons having varying numbers of carbon atoms. The hydrocarbon fluid may be described by a carbon number distribution. Carbon numbers and/or carbon number distributions may be determined by true boiling point distribution and/or gas-liquid chromatography. The term “nuclear energy” shall mean the residual heat energy produced by the process of radioactive decay of the fission products and actinides in SNF or weapons-usable fissile materials from nuclear weapons dismantlement and production processes.

### DETAILED DESCRIPTION

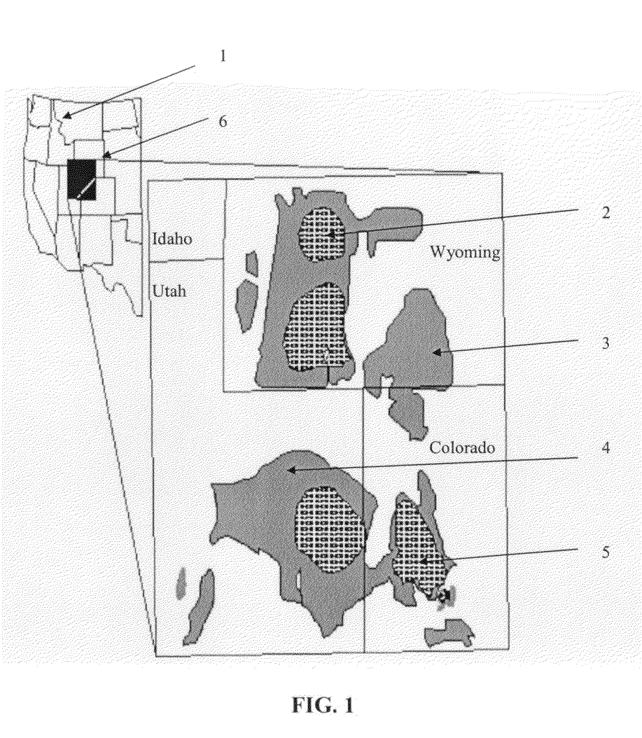

A preferred embodiment of the method of disposing of nuclear waste in underground rock formations in accordance with the present invention will now be described with reference to FIGS. 1 through 31 in which the present invention is illustrated.

Specifically, FIG. 1 shows the location of the major oil shale deposits in United Sates of America 1. These are the Green River Basin of Wyoming 2; the Washakie Basin of Wyoming and Colorado, 3; the Uinta Basin of Utah 4 and the Piceance Creek Basin of Colorado 5. While oil shale is found in many places worldwide, by far the largest deposits in the world are found in the United States in the Green River Formation 6. Estimates of the oil resource in place within the Green River Formation 6 range from 1.2 to 1.8 trillion barrels. Not all resources in place are recoverable; however, even a moderate estimate of 800 billion barrels of recoverable oil from oil shale in the Green River Formation 6 is three times greater than the proven oil reserves of Saudi Arabia. Present U.S. demand for petroleum products is about 20 million barrels per day. If oil shale could be used to meet a quarter of that demand, the estimated 800 billion barrels of recoverable oil from the Green River Formation 6 would last for more than 400 years. The major U.S. oil shale deposits shown in FIG. 1 are located in sedimentary rock where there is little chance of igneous disruption. Oil shale formations are also substantially impermeable to fluids under native conditions thus the likelihood of contaminating the water table above or below the formation with radionuclides from nuclear waste placed in the formation is minimized. This invention proposes a method of heating in situ a block of the oil shale containing kerogen in an inorganic matrix with nuclear waste to a temperature of about 270° C. The thermal flux of the nuclear waste fractures the formation, alters the chemical and/or physical properties of the kerogen and allows removal of a mixture of hydrocarbons, H₂, and/or other formation fluids at a production well. The technology for producing hydrocarbons from oil shale is well known in the industry and does not form a part of this inventive concept. It is an objective of this invention to use the global inventory of SNF as a heat resource for the production of the oil shale deposits shown in FIG. 1. This is the surest way the United States can prevent the plutonium contained in foreign sourced waste from ever being used to construct a nuclear weapon for use against it.

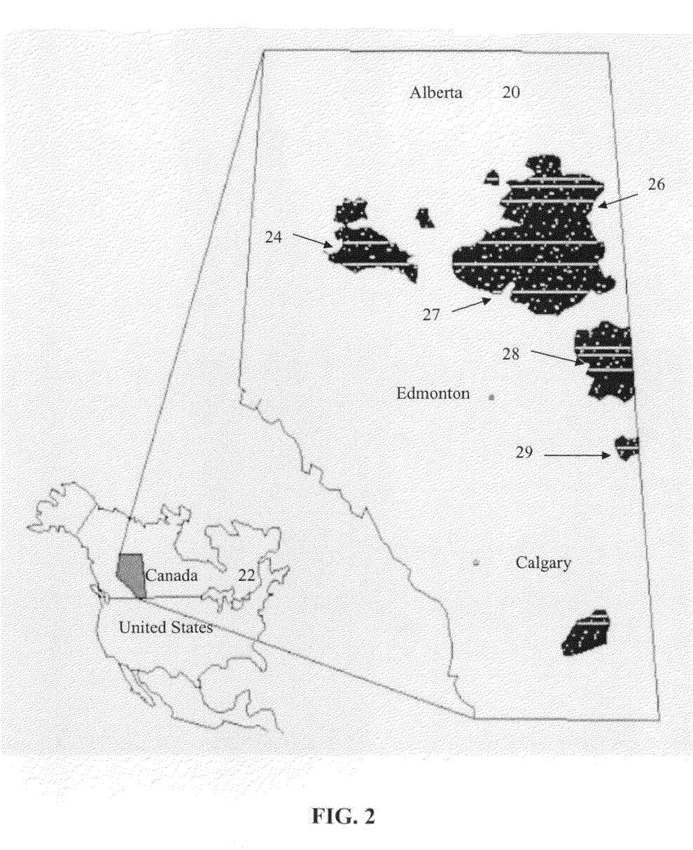

FIG. 2 depicts the location of Alberta 20, Canada's 22, unconventional oil deposits: Peace River Oil Sands 24, Athabasca Oil Sands 26, Wabasca Oil Sands 27, Cold Lake Oil Sands 28 and Lloydminster Heavy Oils 29.

Next to the Green River Formation 6, Alberta 20 sits atop the second largest petroleum deposit outside the Arabian Peninsula—as many as 300 billion recoverable barrels and another trillion-plus barrels that could be recovered with improved technology.

A study by Professor Charles Hall of the of the State University of New York College of Environmental Science and Forestry, published on line at (http://www.theoildrum.com/node/3839) indicates the Energy Return on Investment (EROI) for oil sands is 5.2/1.

$$\begin{matrix}EROI = \frac{{E}_{output}}{{E}_{input}} \\ = \frac{{E}_{boe}}{( {E}_{direct} + {E}_{indirect} + {E}_{Labor} + {E}_{env .} )}\end{matrix}$$

Where: Eoutput=Eboe=Energy content of one barrel of oil equivalent (6164 MJ)

Einput=Total energy input (MJ/boe)

Edirect=Direct energy demand (only the energy flows) (MJ/boe)

Eindirect=Indirect energy demand (e.g. energy to make capital equipment) (MJ/boe)

ELabor=Labor energy demand (Includes labor and maintenance) (MJ/boe)

Eenv.=Environmental energy demand (Kyoto protocol, others) (MJ/boe)

According to the same study, the EROI for oil shale is generally in the range of 1.5:1 to 4:1, with a few extreme values between 7:1 and 13:1. The main difference between oil sands and oil shale is oil sands are particles of sand, surrounded by a microscopic layer of water that is itself surrounded by heavy bitumen. Separating the oil from the oil sands is much easier because of this water layer, since the oil is “suspended” in the water/sand layer and not directly stuck on or in the sand, as is the case for oil shale. This makes oil shale more energy intensive to separate. Shell reports its In situ Conversion Process (ICP) (U.S. Pat. No. 7,225,866 to Berchenko, et al.) will consume 1 Btu for every 3 Btu's of energy produced. On the basis of this study 73 percent more oil can be produced from Alberta's oil sands than from U.S. oil shale deposits using the available heat of SNF.

Canada 22 and the five “nuclear weapons states”, the United States, Russia (successor state to the Soviet Union), the United Kingdom, France and China are signatories to the NPT. As such they have agreed under Article VI of the NPT to undertake to pursue negotiations in good faith on effective measures relating to cessation of the nuclear arms race at an early date and to nuclear disarmament, and on a Treaty on general and complete disarmament under strict and effective international control.

Some governments, especially those belonging to the Non-Aligned Movement of 118 member states, argue that the nuclear weapons states have failed to meet their Article VI NPT obligations.

In its 1995 Implementation Plan for Long-Term Storage and Disposition of Weapons-Usable Fissile Materials Programmatic Environmental Impact Statement, DOE/EIS-0229-IP March 1995, the DOE chose to consider Canadian Deuterium Uranium (CANDU) reactors at the Bruce Power Station in Ontario, Canada 22, as a viable alternative for the disposition of weapons-usable fissile materials from United States nuclear weapons dismantlement and production processes. At the 1996 G-8 Moscow summit on nuclear safety and security Prime Minister Chrétien agreed in principle to consider using U.S. and Russian WGP as fuel in Canadian reactors. The rationale was Canada 22 is committed to, and strongly advocates, world nuclear disarmament. Eliminating the risk of theft and proliferation posed by plutonium from nuclear weapons helps mankind to reach this goal. Other countries view Canada 22 as a safe and responsible country that can act as a respected third party in converting both Russian and U.S. WGP. The same rationale applies to an international repository in which spent fuel, which can either be harvested for plutonium or used in a dirty bomb, or nuclear weapons materials will be eliminated directly, rather than first being irradiated before being placed in a Canadian repository, as would have been the case had the Prime Minister's 1996 offer been taken up.

A nuclear chain reaction was first initiated in Canada 22 on Sep. 5, 1945, when the ZEEP reactor went into operation at Chalk River, Ontario. Originally part of an effort to produce plutonium for nuclear weapons, the reactor was designed by a team of Canadian, British, and French scientists and engineers assembled in Montreal and in Ottawa in 1942-43. The Montreal team had developed superior methods for extracting plutonium. This knowledge helped Britain and France to launch national nuclear weapons programs. Canada 22 has had the capability from near the dawn of the nuclear age to produce a nuclear weapon but has chosen not to do so.

The technology for producing hydrocarbons from oil sand and heavy oil is well known in the industry and does not form a part of this inventive concept. This invention proposes a method of heating in situ a block of heavy oil or oil sand in Alberta with nuclear waste to a temperature sufficient to mobilize the viscous oil so that it can be recovered at a production well. In one embodiment it maximizes the energy return from nuclear waste by producing Alberta's unconventional oil deposits. In certain embodiments it provides a politically acceptable venue for the disposition of global weapons plutonium inventories. In certain embodiments it irreversibly removes plutonium from use in nuclear weapons. In certain embodiments it provides an economically viable solution to the proliferation threat posed by plutonium separated from commercial SNF. In certain embodiments it provides a safe, secure, method of storing nuclear waste either temporarily or permanently.

Radiation is the energy released from atoms as either a wave or a tiny particle of matter. Radiation sickness is caused by exposure to a high dose of radiation. Possible sources of high-dose radiation include exposure to SNF, an accident at a nuclear industrial facility, an attack on a nuclear industrial facility, detonation of a small radioactive device, detonation of a conventional explosive device that disperses radioactive material (dirty bomb) or the detonation of a standard nuclear weapon. The terrorist attacks on the United States in 2001 along with other acts of terrorism around the world have caused some to worry about terrorists using radioactive devices that could expose many people and cause radiation sickness and deaths.

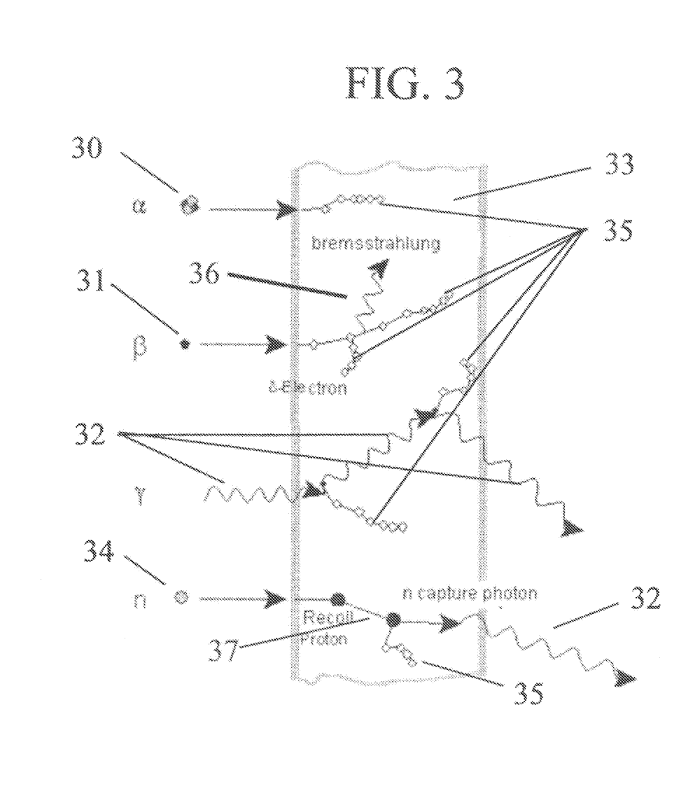

Radiation sickness occurs when high-energy radiation damages or destroys certain cells in the body. Regions of the body most vulnerable to high-energy radiation are cells in the lining of the stomach and intestinal tract and the blood cell producing cells of bone marrow. When radionuclides decay they release their extra energy in the form of ionizing radiation. Three types of ionizing radiation are shown in FIG. 3: alpha particles 30, beta particles 31, and gamma rays 32. They are called ionizing radiation because as they move through matter, they “knock” electrons out of their orbits and form ions. The ionizing radiation uses some of its energy each time it creates an ion. Eventually, the radiation uses all of its energy and can no longer cause damage. Radioactive materials usually release alpha particles 30, which are the nuclei of helium, beta particles 31, which are quickly moving electrons or positrons, or gamma rays 32. Alpha 30 and beta particles 31 can often be stopped by a piece of paper or a sheet of aluminum, respectively. They cause most damage when they are emitted inside the human body. Gamma rays 32 are less ionizing than either alpha or beta particles 31, and protection against gamma rays 32 requires thicker shielding 33. The damage they produce is similar to that caused by X-rays, and includes burns and also cancer, through mutations.

Ionizing radiation can affect living things by altering the cells that make up the living organism. Cells are made up of molecules. Cell damage is caused by interaction of radiation with these molecules, forming ions.

Radiation effects on a cell are random. That is, the same type and amount of radiation could strike the same cell many times and have a different effect, including no effect, each time. However, in general, the more radiation that strikes the cell, the greater the chance of an effect occurring. If radiation does not reach the living organism, it has no effect on that organism.

Methods of protecting people from radiation focus on reducing the amount of radiation that reaches human beings. Three factors that determine how much radiation reaches a person are time, distance, and shielding 33. The dose of radiation a person receives depends on how long the person is near the radiation source. The shorter the time spent near the source, the smaller the dose. Radiation protection procedures are designed to keep the time people spend near a source of radiation as short as possible. Similarly, the radiation dose a person receives depends on how close the person is to the source. The greater the distance between the person and the source of radiation, the smaller the dose; the dose decreases with the square of the distance. One way to minimize the amount of radiation that reaches people is to put some material, called shielding 33, between the radiation source and people. When the radiation strikes the shielding 33, it begins to create ions in the shield. Each time an ion is created, the radiation uses some of its energy. If the shield is thick enough, the radiation will use up its energy before it gets through the shield.

Any material provides some shielding 33. Common shielding 33 materials are steel (iron), concrete, lead, and soil. The shielding 33 ability of a material is measured by determining the thickness of the material required to absorb half of the radiation from a given source. This thickness of the material is called the half-thickness. Radiation that has passed through one half-thickness will be reduced by half again if it passes through another half-thickness. The half-thickness depends on both the characteristics of the shielding 33 materials and type and energy of the radiation being emitted. Some common shielding 33 materials and their half-thicknesses for high-energy gamma rays 32 are (3.6 inches) of packed soil, (2.4 inches) of concrete, (0.4 inches) of lead, (0.08 inches) of depleted uranium or (500 ft) of air.

In order for a particle to be ionizing, it must both have a high enough energy and interact with the atoms of a target. Charged particles such as electrons, positrons, and alpha particles 30 interact strongly with electrons of an atom or molecule. Neutrons 34, on the other hand, do not interact strongly with electrons, and so they cannot directly cause ionization 35 by this mechanism. However, fast neutrons 34 will interact with the protons in hydrogen (in the manner of a billiard ball hitting another, sending it away with all of the first ball's energy of motion), and this mechanism produces proton radiation (fast protons). These protons are ionizing because of their strong interaction with electrons in matter. A neutron 34 can also interact with an atomic nucleus, depending on the nucleus and the neutron's velocity; these reactions happen with fast neutrons 34 and slow neutrons 34, depending on the situation. Neutron 34 interactions in this manner often produce radioactive nuclei, which produce ionizing radiation when they decay.

In the FIG. 3, gamma rays 32 are represented by wavy lines, charged particles and neutrons 34 by straight lines. The little circles show where ionization 35 processes occur.

An ionization 35 event normally produces a positive atomic ion and an electron. High-energy beta particles 31 may produce bremsstrahlung 36 when passing through matter, or secondary electrons (δ-electrons); both can ionize in turn.

Unlike alpha 30 or beta particles 31 gamma rays 32 do not ionize all along their path, but rather interact with matter in one of three ways: the photoelectric effect, the Compton effect 37, and pair production. By way of example FIG. 3 depicts Compton effect 37: two Compton scatterings that happen sequentially. In every scattering event, the gamma ray transfers energy to an electron, and it continues on its path in a different direction and with reduced energy.

FIG. 3 also shows a neutron 34 collides with a proton of the target material, and then becomes a fast recoil proton that ionizes in turn. At the end of its path, the neutron 34 is captured by a nucleus in an (n,γ)-reaction that leads to a neutron 34 capture photon.

This invention proposes a method of minimizing the risk of radioactive exposure from SNF by distancing the fuel from the biosphere in an underground repository and shielding 33 the radiation with hundreds of meters of sedimentary rock overlaying said repository.

This invention proposes a method of minimizing the radiation risk of an accident at a nuclear industrial facility by providing a means of disposing of the SNF currently stored on site at such facilities in an underground sedimentary rock formation.

This invention proposes a method of minimizing the radiation risk of an attack on a nuclear industrial facility by providing a means of disposing of the SNF that would be the principle source of the radiation released by such an attack.

This invention proposes a method of minimizing the radiation risk from the detonation of a small radioactive device or a dirty bomb by providing a secure means of disposing of the material that might be used to make such a device.

This invention proposes a method of minimizing the radiation risk from a standard nuclear weapon by securing the plutonium required to make such a device from proliferators or terrorists.

The use of underground storage sites for nuclear waste requires control of vertical migration of mass and energy. Concentrations of excess energy in the Earth empower upward directed processes. Loss of energy from earth to outer space, slow by conduction in solids, is greatly accelerated by transport in liquids. Magmas and hydrothermal fluids penetrate the crust and issue onto the surface. Concentration of radioactive materials in small volumes of crustal rock drives convective cells similar to those from volcanic heat.

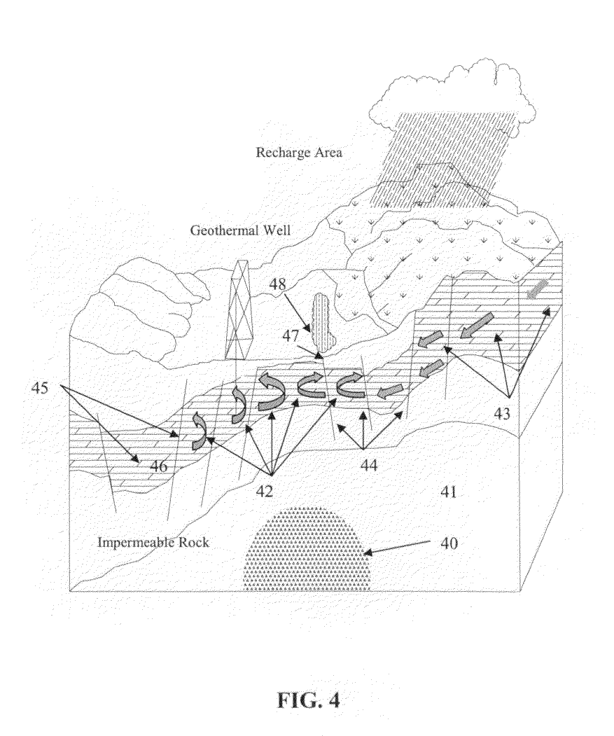

FIG. 4 is a vertical cross-section through a geothermal reservoir showing magmatic intrusion 40 in the upper crust 41 of the earth activating hydrothermal cells 42. Fluids 43 penetrate faults 44, fractures 45 and permeable rocks 46. Tectonic forces periodically brecciate 47 hydrothermally affected rocks, opening channels for fluid flow. (Geysers, hot springs, fumaroles) 48 discharge waters on the surface. Energy from nuclear waste would likewise create hydrothermal cells that could transport radionuclides from a geologic repository back to the biosphere.

Long-term processes driven by gravity need to be considered in planning a nuclear waste repository. Migration of energy through solids by thermal diffusion is slow compared to energy transported in fluids. It is an objective of this invention to dissipate the excess energy of nuclear waste that would normally drive hydrothermal cells in the form of work. In thermodynamics, work is the quantity of energy transferred from one system to another without an accompanying transfer of entropy. In one embodiment this invention transfers the heat of nuclear waste to a system that converts kerogen to oil and gas. In some embodiments this invention transfers the heat of nuclear waste to a system that fractures the geology in which unconventional oil is found to facilitate the flow of produced oil to a producing well. In some embodiments this invention transfers the heat of nuclear waste to a system that reduces the viscosity of bitumen or heavy oil. A shell forms at the cold interface of the unheated reservoir where the heated bitumen/heavy oil drains by gravity to a lower producing well.

Petroleum is usually less dense than the rocks and water it is formed with, so as it is formed, it will flow upward toward the Earth's surface through fractures or pores in the rock. If it can oil and gas will escape to the surface as seepage, where it is lost. Where it exists not only must a reservoir be overlain by an impervious layer forming a cap rock or seal (shales or evaporites are likely to be the most effective), but there must also be some sort of blockage to prevent further migration. This may be caused either by the reservoir itself dying out or by an interruption of its upwards continuity to the surface. Such a configuration of the reservoir is known as a trap. Any oil getting there will be unable to migrate further and so it starts to accumulate, by displacing the water already there in the porosity. The conditions that permit oil to accumulate are the same as those necessary to control vertical migration of hydrothermal fluids containing radionuclides that might otherwise be transported from a nuclear waste repository back into the biosphere.

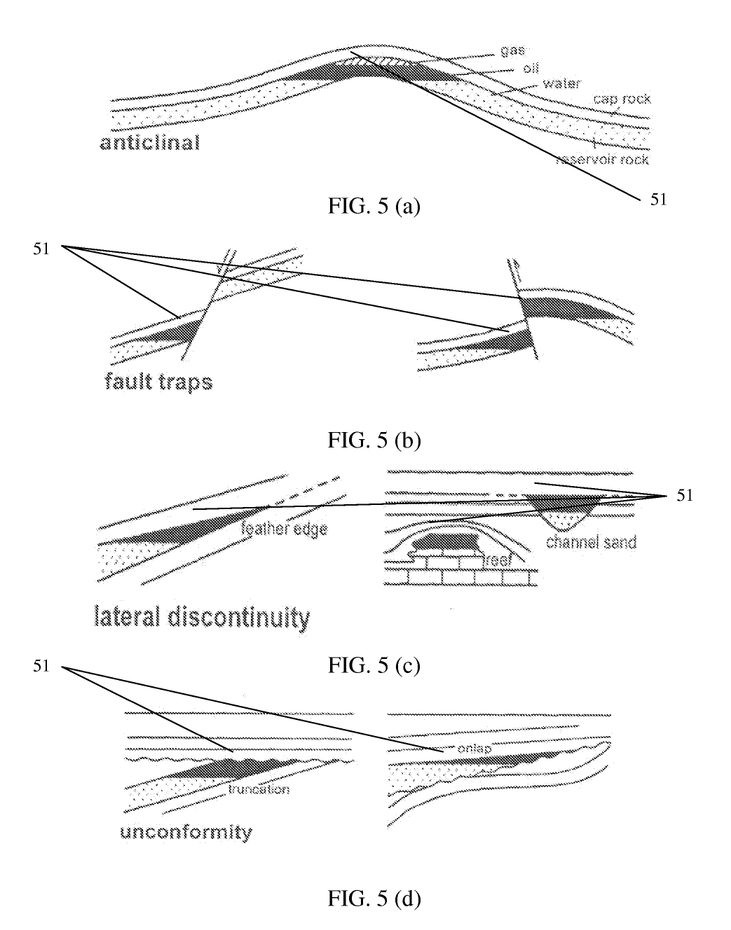

Traps can be structural as in FIG. 5(a) and FIG. 5(b), where the trap has been produced by deformation of the beds after they were deposited, either by folding or faulting. Or traps can be stratigraphic, in which case the trap is formed by changes in the nature of the rocks themselves, or in their layering, the only structural effect being a tilt to allow the oil to migrate through the reservoir as in FIG. 5(c) and FIG. 5(d).

Combination traps are formed partly by structural and partly by stratigraphic effects, but not entirely due to either. Hydrodynamic traps are rare but water flowing through a reservoir may hold oil in places where it would not otherwise be trapped.

Cap rocks 51 are usually of sedimentary origin and are formed by gravitational compaction of the sediment, which controls the reduction of porosity with burial depth and the development of high pore fluid pressures. Often, sediments contain hydrated, expandable clay (smectite) that can undergo a transition to a dehydrated, non-expandable clay (illite). During dehydration, structural water bound within the sheet layers of smectite is released into the pore space, which can increase the pore pressure and influence geological processes such as solute transport, hydrocarbon migration and hydrothermal fracturing.

Pore pressure is the pressure of fluids within the pores of a reservoir, usually hydrostatic pressure, or the pressure exerted by a column of water from the formation's depth to sea level. When impermeable rocks such as shales form as sediments are compacted, their pore fluids cannot always escape and must then support the total overlying rock column, leading to anomalously high formation pressures.

When sediment layers above the reservoir build up quickly, an impermeable layer can form underneath the reservoir as well (a process known as undercompaction), sealing it off. If more sediment is deposited at the surface, it presses down upon the fluid within the reservoir, creating a condition known as overpressure.

The formation of petroleum itself can also contribute to overpressure, as petroleum has a larger volume than the kerogen from which it is formed.

When a drill head pierces through the impermeable layer of rock above the reservoir, the pressure in the reservoir forces the mobile fluids up through the open pipe to the surface, forming a gusher.

Sediment permeability (the capacity of the sediment to transmit fluid) is controlled by size and interconnectedness of interstitial pores, and the tortuosity of fluid flow paths; such factors are in turn controlled by the grain-size distribution, grain shape, and porosity. Sediment hydraulic impedance, which controls the rate of fluid flow through a sediment column, is a function of both sediment permeability and thickness. For sediment columns ranging from 10 to 100 m thick, the hydraulic impedance can vary by five orders of magnitude for typical sediment types. As a result, the nature of fluid circulation in partially or continuously sedimented regions can depend strongly on the distribution of sediment thickness, which varies laterally, and on sediment type, which can vary both laterally and with depth.

This invention proposes a method of disposing of nuclear waste in an underground sedimentary rock formation overlain by an impervious cap rock or seal, which impedes hydrothermal convection of radionuclides from a repository up to the biosphere.

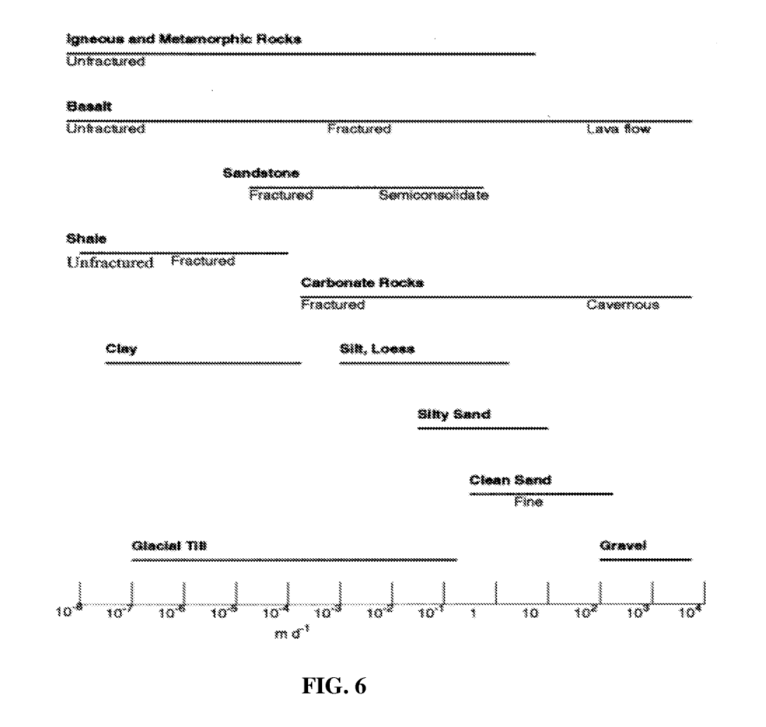

FIG. 6 is schematic of the hydraulic conductivity of various rocks and soil. Hydraulic conductivity, symbolically represented as K, is a property of soil or rock that describes the ease with which water can move through pore spaces or fractures. It depends on the intrinsic permeability of the material and on the degree of saturation.

Hydraulic conductivity is the proportionality constant in Darcy's law, which relates the amount of water, which will flow through a unit cross-sectional area of aquifer under a unit gradient of hydraulic head. The hydraulic conductivity is specific to the flow of a certain fluid (typically water, sometimes oil or air); intrinsic permeability κ is a parameter of a porous media which is independent of the fluid. This means that, for example, K will increase if the water in a porous medium is heated (reducing the viscosity of the water), but κ will remain constant. The two are related through the following equation

$$K = \frac{κ γ}{μ}$$

where:

K is the hydraulic conductivity;

κ is the intrinsic permeability of the material;

γ is the specific weight of water, and;

μ is the dynamic viscosity of water.

The hydraulic conductivity of rocks and soil can be measured by field or laboratory tests as shown in FIG. 6. Most cap rocks 51 are either clay or shale. The thicker a shale layer the greater is its resistance to fracturing and thus as FIG. 6 demonstrates the lower is its hydraulic conductivity. As shown in FIG. 6 the medium conductivity for shale (fractured or unfractured) is about 10⁻⁶ m d⁻¹. Conservatively it would take water therefore roughly 2740 years (1/(0.000001*365)) to flow 1 m through relatively unfractured shale such as would be encountered in a thick sequence of shale.

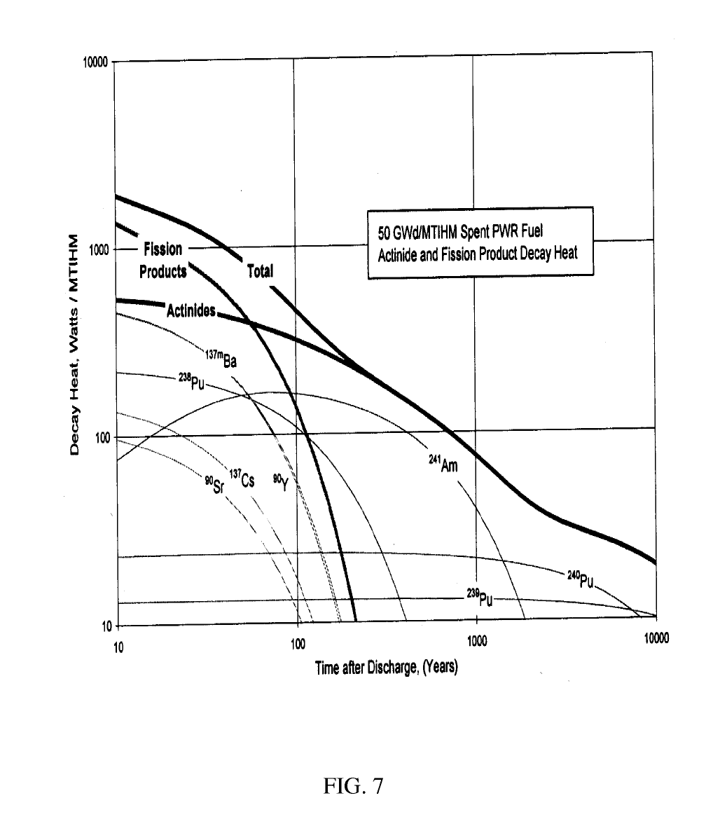

FIG. 7 depicts the average decay heat generated by spent pressurized water reactor (PWR) fuel at 50 (GWd)/(MTIHM) discharge burnup. In nuclear power technology, burnup is a measure of the neutron irradiation of the fuel. In FIG. 7 it is quoted in Gigawatt-days (GWd) per MT of initial heavy metal (MTIHM). One GW is 1,000 MW; 1 MW-day is 24,000 kilowatt hours. The unit GWd/MTIHM is the (average) thermal output, multiplied by the time of operation, and divided by the mass of fuel involved. This gives a rough measure of the number of nuclear fission events that have taken place within the fuel.

Nuclear reactor fuel may be uranium, plutonium, or a mixture of these or of either or both of these with thorium. This fuel content is often referred to as heavy metal to distinguish it from other metals present in the fuel, such as those used for cladding. The heavy metal is typically present as either metal or oxide, but other compounds such as carbides or other salts are possible.

PWRs are the most common type of power producing reactor and are widely used all over the world. More than 230 of them are in use to generate electric power, and several hundred more for naval propulsion. As shown in this FIG. 7, the decay heat drops rapidly after discharge for about the first 200 years. The decay heat is mainly generated by the decay of fission products for the first 60 years, with the contribution dominated by the radioisotope barium-137m (^{137m}Ba) and yttrium-90 (⁹⁰Y) as decay products of cesium-137 (¹³⁷Cs) and strontium-90. (⁹⁰Sr).

After 60 years, the decay heat is mostly from actinide elements, with the important actinide elements being plutonium and americium. Beyond about 200 years, the decay heat is caused almost entirely by the actinide elements plutonium and americium, out to at least 10,000 years. The slow decrease of the decay heat with time is due to the relatively long half-life of the isotope Americium-241 (²⁴¹Am) and the Plutonium isotopes, (²³⁸Pu), (²³⁹Pu) and (²⁴⁰Pu), as plotted in FIG. 7.

Generation II reactors were typically designed to achieve about 40 GWd/MTIHM. Generation II reactors include PWRs, CANDU, boiling water reactors (BWR) and advanced gas-cooled reactors (AGR). With newer fuel technology these reactors are now capable of achieving up to 60 GWd/MTIHM. Higher fuel burnup is desirable for the reactor operator to reduce downtime for refueling, reduce the number of new nuclear fuel elements required and SNF elements produce for a given output of energy and to reduce the amount of plutonium that might be diverted from spent fuel to nuclear weapons use.

Higher burnup rates have drawbacks however such as hotter and more radioactive waste. According to Nirex, which until 2006 was responsible for dealing with the United Kingdom's nuclear waste, fuel with a burn-up of 55 GWd/MTIHM irradiated in a pressurized water reactor would be around 50 per cent more radioactive than low burn-up fuel of 33 GWd/MTIHM throughout the time it needs to be stored.

To ensure that the build-up of heat is kept within safe limits, spent elements of the higher burn-up fuel would have to be stored further apart. Failure to allow for this would lead to a build-up of heat that could cause fractures in the containers in currently designed repositories or in the surrounding rock, and so increase the risk of a leak. Though the increased efficiency of high burn-up fuel means there would be less of it, more storage space will still be required overall utilizing current repository designs.

50 GWd/MTIHM is the average between the design rate of 40 GWd/MTIHM for Generation II reactors and their current capability of 60 GWd/MTIHM.

Repository design selection processes also involve tradeoffs between competing goals, including performance, economic costs, uncertainty and constructability. Thermal design goals include: Keeping temperatures below critical temperatures for engineered materials.

The Yucca Mountain repository is currently limited by legislation to a maximum capacity of 70,000 MTIHM of which 63,000 MTIHM is reserved for civilian nuclear used fuel. Various sources have estimated the “real” or “technical” capacity of Yucca Mountain could be around 125,000 MTIHM.

The capacity of Yucca Mountain is constrained by two thermal limitations. First the temperature between used nuclear fuel tunnels must remain below 96° C. Whether or not temperatures at the drift wall are above the boiling point strongly affects the likelihood of water seeping into the drift. If the local heat flux at the drift wall is greater than the product of the local liquid-phase flux and the heat of evaporation, then water cannot seep into the drift. If the converse is true, then seepage into the drift is possible. Yucca Mountain is situated above a deep Paleozoic carbonate aquifer which provides a potential pathway for groundwater transport of contaminants from the repository back to the biosphere. Water moving through the drift would facilitate this transport. Also corrosion is caused by the presence of moisture. Repository engineered materials are susceptible to electrochemical corrosion processes at temperatures above approximately 80-90° C. Dry conditions near the waste packages would lessen corrosion, and fewer packages would degrade over the thousands of years the repository would function.

The second constraint is the temperature of the surrounding rock must remain below 200° C. to avoid inducing changes to the mechanical properties of the rock. Zeolite-rich rocks, as are found in Yucca Mountain, can retard, via cation exchange, the migration of radionuclides occurring in solution as simple cations (e.g. Cs⁺, Sr²⁺, and Ba²⁺). Heating zeolites above 200° C. retard their capacity to sequester these radionuclides.

Table 1 shows the spent fuel inventory data collected from the publicly available National Reports submitted to the Second Review Meeting of the Joint Convention on the Safety of Spent Fuel Management and on the Safety of Radioactive Waste Management. In Table 1 (NPP) stands for Nuclear Power Plant.

TABLE 1
SPENT FUEL INVENTORY DATA COLLECTED FROM THE
NATIONAL REPORTS SUBMITTED TO THE SECOND
REVIEW MEETING OF THE JOINT CONVENTION HELD IN
MAY 2006

| | Contracting | | |
|---|---|---|---|
| | Parties to the | | |
| | Joint Convention | Number of | Mass/Heavy |
| | that have NPPs | assemblies | Metal ton |
| 1 | Argentina | | 3 234 |
| 2 | Belgium | 2 668 | 4 300 |
| 3 | Brazil | 943 | 113^{Note 1} |
| 4 | Bulgaria | 6 341 | 943 |
| 5 | Canada | 1 793 168 | 33 858 |
| 6 | China^{Note 2} | | |
| 7 | Czech | 7 555 | 882 |
| 8 | Finland | 9 019 | 1 377 |
| 9 | France | | 10 920 |
| 10 | Germany | | 4 738 |
| 11 | Hungary | 6 355 | 743^{Note 3} |
| 12 | Italy | 2 058 | 237 |
| 13 | Japan | | 13 000 |
| 14 | Rep. of Korea | | 7 286 |
| 15 | Lithuania | 16 087 | 1 818^{Note 4} |
| 16 | Netherlands | | 0.43 |
| 17 | Romania | 40 312 | 762^{Note 5} |
| 18 | Russia | | 18 500 |
| 19 | Slovakia | 10 609 | 1 263^{Note 6} |
| 20 | Slovenia | 732 | 285 |
| 21 | South Africa^{Note 7} | | |
| 22 | Spain | 9 676 | 3 196 |
| 23 | Sweden | 24 129 | 4 957 |
| 24 | Switzerland | 3 728 | 737 |
| 25 | UK | | 9 585 |
| 26 | Ukraine^{Note 8} | | |
| 27 | USA | | 49 352 |
| | total | | 176 419 |

^{Note 1}Brazil: Weight was calculated assuming 120 kg per assembly.
^{Note 2}China became Contracting Party after the Second Review Meeting.
^{Note 3}Hungary: Weight was calculated assuming 117 kg per assembly.
^{Note 4}Lithuania: Weight was calculated assuming 113 kg per assembly.
^{Note 5}Romania: Weight was calculated assuming 18.9 kg U per CANDU bundle.
^{Note 6}Slovakia: Weight was calculated assuming 119 kg per assembly.
^{Note 7}South Africa became Contracting Party after the Second Review Meeting.
^{Note 8}Ukraine has not made the National Report publicly available.

The total amount of spent fuel is approximately 180,000 MTIHM with the U.S. share being about 28% and Canada's share being 19%. The deadline for submission of National Reports was October 2005. Therefore most National Reports were prepared in 2005, based on the data up to the end of 2005. Different sources indicates that worldwide the spent fuel generation rate is now at about 10,500 MTIHM/year. If U.S. shares of worldwide generation remain constant the volume of waste generated in the U.S. will reach Yucca Mountain's legislated capacity for civilian nuclear fuel by 2010 and its technical capacity by 2031.

The embodiment of this invention would have neither of the thermal restraints specific to Yucca Mountain.

As explained above Hardin, E. L., et al. report the “Radioactive decay of high-level nuclear waste emplaced in a Yucca Mountain repository will produce an initial heat flux on the order of 30 to 50 times the heat flux in the Geysers geothermal reservoir in California.” According to The California Energy Commission, Geothermal Energy in California website, in 2007 California produced 13,000 gigawatt-hours of geothermal energy. Assuming the conservative estimate of 30 times this amount of heat flux for U.S. nuclear waste, approximately 390,000 gigawatt-hours of energy is produced annually by U.S. waste, which is approximately half the total annual output of operating U.S. reactors. The fuel oil equivalent of 1 gigawatt-hour [GW*h] is 563.990352583 barrels U.S., so 390,000 gigawatt-hours is the equal of roughly 220,000,000 barrels of oil (US). According to Shell, 3 units of shale oil can be produced for every unit of energy input with its ICP so the initial heat flux of America's spent fuel has the potential to produce approximately 660,000,000 barrels of oil. It would take over 1200 years to produce the estimate of 800 billion barrels of recoverable oil from oil shale in the Green River Formation 6 at that rate or 336 years using the total current inventory of spent fuel or less considering an additional 133,000,000 barrels of oil could be produced annually by the 10,500 MTIHM annual addition to the global spent fuel inventory.

Given the 5.2/1 EROI for Alberta's oil sands its 300 billion recoverable barrels of bitumen could be recovered in 75 years using the total current inventory of spent fuel.

An objective of this invention is to utilize the heat flux of SNF to produce North America's unconventional oil resources so the greater the amount of heat that is available from spent fuel, the greater the amount of unconventional oil that can be produced.

Large waste-package nuclear waste repository designs result in very high-temperature waste-package surfaces due to the heat produced by radioactive decay of fission products. In a paper, “Materials performance issues for high-level radioactive waste packages” Journal of the Minerals, Metals and Materials Society, Volume 52, Number 9/September, 2000, D. B. Bullen et al. assert with respect to a repository, “If the drifts are closed immediately after waste-package emplacement, the radioactive decay heat will cause the surface temperature of the waste package to rise to greater than 2000° C. within a few years and to slowly drop to less than the local boiling point of water within about 1,500 years.

The primary thermal-design variables that affect thermohydrologic behavior in the repository are (1) areal mass loading, (2) lineal mass loading, (3) spent fuel age, (4) waste package spacing and sequencing, (5) duration and heat-removal efficiency of drift ventilation, and (6) engineered barrier system (EBS) design (e.g., whether backfill or drip shields are emplaced).

Areal Mass Loading (AML), expressed in MT of uranium per acre, is a measure of the overall heat-generation density of waste inventory. The AML is the key factor determining the magnitude of long-term thermohydrologic effects, including the radial and vertical extent of boiling in the host rock and the duration of boiling conditions in the emplacement drifts

Lineal Mass Loading (LML), expressed in MT of uranium per meter of emplacement drift, is a measure of the average heat-generation density along the drifts. The LML is the key factor determining short-term thermohydrologic effects, such as the peak temperatures on waste packages and on the drift wall, and the temperature difference between the waste package and drift wall.

Spent-Fuel Age, expressed in years, quantifies how long since the spent-fuel assembly has been removed from the nuclear reactor core. Because the heat generation rate decays with time, younger spent fuel has a higher thermal power output than does older spent fuel. Spent-fuel age is a key factor determining short-term thermohydrologic effects, such as peak temperatures on waste packages and on the drift wall. Above-ground storage of spent fuel prior to emplacement in the repository will lower the peak temperatures.

Waste-package spacing and heat-source heterogeneity determine the variability of thermohydrologic conditions along drifts. Waste-package spacing pertains to the end-to-end distance between waste packages. If waste packages are spaced far apart from each other along the drift (“point-load” waste-package spacing), heating conditions along the drift will be highly heterogeneous. If the waste packages are spaced nearly end to end (“line-load” waste-package spacing), the line of waste packages will act like a homogeneous line-source of heat. With respect to thermal power output there are two primary classes of waste packages: (1) commercial spent-nuclear fuel (CSNF) and (2) all other waste-package types, including defense high-level waste (DSNF) and HLW. The CSNF waste packages generate much more heat than non-CSNF waste packages; thermal output from CSNF waste packages also declines much more slowly with time. Fuel blending (the mixing and matching of waste package of different thermal power) can be used to reduce the heat-source heterogeneity along the drift.

However, because of the large difference in thermal output between CSNF and non-CSNF waste packages, there is a limit to the effectiveness of fuel blending in reducing heat-source heterogeneity.

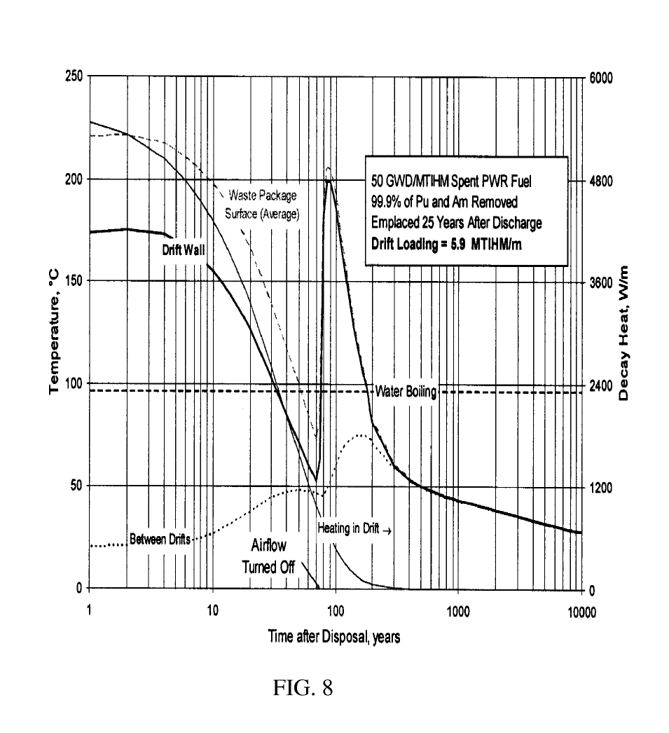

Current repository designs allow for heat-removal from a repository drift using ventilation during a pre-closure period. The percentage of heat removed from the repository system (heat-removal efficiency) increases with ventilation flow rate. FIG. 8 shows the transient thermal response of a Yucca Mountain repository with an LML of 5.9 MTIHM/m where the repository is loaded with 50 GWD/MTIHM Spent PWR Fuel with 99.9% of its Pu and Am actinides removed and the waste emplaced 25 years after it has been discharged from a reactor. The initial waste package surface and average and heating in the drift are shown in the model at roughly 225° C. With forced ventilation in the drift this rapidly declines but as soon as the airflow is turned off the waste package temperature and drift wall temperature immediately spike back to 200° C. The temperature between the drifts also triples after the ventilation is turned off. The current design for a repository at Yucca Mountain has the emplacement drifts spaced 81 m apart and the temperature between the drifts would be measured at the mid point.

In most embodiments of this invention it is desirable to be able to produce temperatures of at least 250° C. over as wide an area as possible to lower the viscosity of as much heavy oil, tar sand or bitumen as possible. In the case of oil shale a temperature of at least 270° C. is required for pyrolysis and this should be maintained over as wide an area as possible.

FIG. 8 demonstrates that these temperatures are achievable because as FIG. 7 demonstrates the removal of the actinides Pu and Am represents the removal of roughly one third of heat source from SNF in the initial 100 years after discharge. It is over the next one hundred years that it is expected conventional oil source will decline and thus it is desirable to produce more of North America's unconventional reserves to fill the expected void.

Drift loading as high as 47.0 MTIHM/m, or nearly 8 times the case shown in FIG. 8, is achievable to both reduce the overall cost of a repository and ensure the desired adjacent drift temperatures are attained.

The equation used to evaluate the contribution to the overall temperature change surrounding a repository is:

$$Δ T = \frac{Q}{[ 4 π kr ]} erfc [ \sqrt{( \frac{{r}^{2}}{4 κ ( t - {t}_{0} )} )} ] ,$$

where ΔT equals a point heat source's contribution to the total local temperature rise at time t and at a distance r away from that heat source of strength Q, initiated at time tₒ. The ability of the material to conduct heat is defined by its thermal diffusivity, κ, and its thermal conductivity, k. The parameter erfc is the complementary error function.

For Yucca Mountain the thermal properties of the host rock (i.e., thermal conductivity, k, and thermal diffusivity, κ, of the unsaturated volcanic tuff) are given are:

k=1.84 W/m-K=0.5608 W/ft-K, and

κ:=8.52×10−7 m2/s=289.36 ft2/yr but these will vary depending on the host rock.

It is an objective of this invention to provide a cost-effective solution to the problem of nuclear waste by maximizing the AML and LML of a repository in order to produce a temperature of between 250° C. and 400° C. in a substantial volume of the surrounding rock.

It is another objective of this invention to reduce the cost of the nuclear fuel cycle by providing a repository that can accommodate as well as utilize a higher burnup rated fuel.

It is another objective of this invention to minimize the need for expensive interim storage of nuclear spent fuel elements by putting the heat this storage is intended to dissipate to productive use.

It is another objective of this invention to minimize the size and thus cost of a repository by spacing and sequencing spent fuel elements in a repository close together to maximize its heat output.

It is another objective of this invention to eliminate the need and expense of ventilating a repository.

It is another objective of this invention to minimize the need for EBS and eliminate the need of expensive drip shields.

When heat is applied to a substance one of two things happens; the temperature of the substance rises or the state of the substance changes.

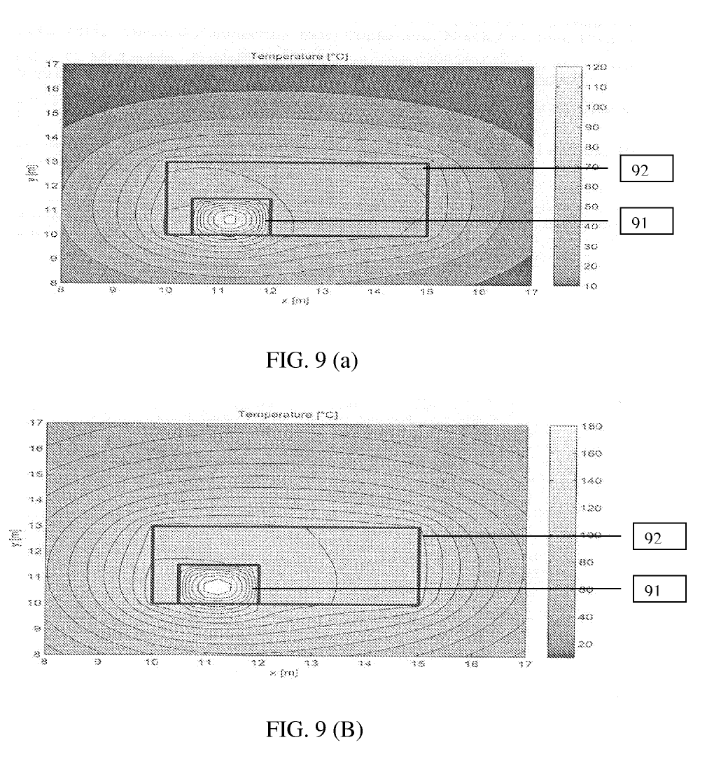

As shown in FIG. 9 the decay heat of SNF in a repository would provide a continuous and gradually diminishing source of heat to a formation in which a nuclear waste repository is placed. The formation would contain a certain amount of water in situ with a latent heat of evaporation of 2,270 kJ/kg; where kJ stands for one kilojoule (kJ), which equals 1000 Joules. A certain portion of the heat generated by nuclear waste in a repository would be absorbed as latent heat in converting water in situ to steam. Steam in a capped formation would pressurize the formation and raise the boiling point. Water would become super heated as would steam subsequently produced in the formation. In some embodiments of the current invention a portion of the heat of the produced steam and the decay heat of SNF would be absorbed converting kerogen in a solid state to bitumen, a liquid. In another embodiment of the current invention a portion of the heat of the produced steam and the decay heat of SNF would be absorbed converting bitumen, a viscous liquid, to hydrocarbon liquids and/or hydrocarbon gas. In some embodiments of the current invention a portion of the heat of the produced steam and the decay heat of SNF would be absorbed lowering the viscosity of heavy oil so that it could be recovered at a production well. A portion of the heat of SNF would raise the temperature of the formation in which it is placed.

As explained above, for most embodiments of the current invention it is desirable that the temperature of the formation in the vicinity of a repository be raised to between 250° C. and 400° C.

The most useful macroscopic thermal loading parameter in analyzing long-term thermal performance of a repository is the AML expressed in MT of heavy metal per acre. Table 2 shows the thermal performance at the center of a repository containing SNF with a burnup rate of 33,000 where; AML is express in MTIH/acre, APD is the Areal Power Density expressed in kw/acre, SNF is the Spent Fuel-Age, T 100 is the temperature of the repository after 100 years, T peak is the maximum temperature of the repository and tpeak is the number of years it would take to reach T peak. The model of the repository was constructed by T. A. Buscheck and J. J. Nitao for the American Nuclear Society International High Level Radioactive Waste Management Conference, Apr. 23-30, 1993 and is based on the Yucca Mountain repository project. Table 2 shows an AML of 248.5 MTIH/acre produces a T peak of 291.5° C. (the desired temperature range) at the center of a repository 816 years after loading. The design parameters for Yucca Mountain call for forced ventilation of the repository for between 50 and 125 years after emplacement and in some cases natural ventilation after that. It can be assumed therefore that the desired temperature range will be attained considerably faster where the repository is not ventilated, which would be the case for all embodiments of the current invention.

TABLE 2
Thermal Performance at the Center of a Repository
Containing Spent Nuclear Fuel with a burnup of 33,000 MWd/MTU

| AML | APD | Area | SNF | T 100 yr | T peak | tpeak |
|---|---|---|---|---|---|---|
| (MTIH/acre) | (kw/acre) | (acres) | age (yr) | (° C.) | (° C.) | (yr) |
| 27.1 | 20 | 3162 | 30 | 57.8 | 59.9 | 729 |
| 27.1 | 20 | 1747 | 30 | 57.8 | 59.9 | 730 |
| 43.5 | 20 | 1747 | 60 | 63.7 | 74.4 | 667 |
| 49.2 | 36.2 | 1747 | 30 | 85.1 | 89.2 | 641 |
| 49.2 | 57 | 1747 | 10 | 100 | 100.3 | 94 |
| 77.4 | 36.2 | 1747 | 60 | 95.4 | 106 | 800 |
| 77.4 | 57 | 1118 | 30 | 109.7 | 115.4 | 557 |
| 77.4 | 57 | 1747 | 30 | 109.7 | 115.3 | 601 |
| 124.3 | 57 | 1747 | 60 | 122.3 | 146.8 | 800 |
| 154.7 | 71.7 | 1747 | 60 | 145.9 | 179.9 | 800 |
| 154.7 | 114 | 559 | 30 | 191.2 | 202.9 | 605 |
| 154.7 | 114 | 1747 | 30 | 190.7 | 202.9 | 653 |
| 248.5 | 114 | 348 | 60 | 225.7 | 291.5 | 816 |

As explained above, radioactive decay heat will cause the surface temperature of the waste package in a drift closed immediately after waste emplacement to rise to greater than 2000° C. within a few years and to slowly drop to less than the local boiling point of water within about 1,500 years.

A study of the heat conduction in a radioactive waste repository, by Ivanan Pulttarova, Department of Mathematics, Faculty of Civil Engineering, Czech Technical University in Prague produced FIGS. 9(a) and 9(b) where; FIG. 9(a) shows the temperature distribution around a spent nuclear waste canister in a vault one month after installation—the temperature levels are scaled by 8 degrees—and FIG. 9(b) shows the temperature distribution to the same scale six months after installation. The small rectangle 91 represents the extent of the surrounding rock that has been heated to the boiling point (which is 96° C. at the elevation of Yucca Mountain) after one month and the large rectangle 92 is the amount of rock that has reached the boiling point after six months.

In five months the heat, represented by the rectangle, propagates 3 meters when the temperature at the center of the repository is originally 120° C. It can be assumed therefore that for a repository containing fuel bundles at a temperature of 2000° C., the volume of surrounding rock and hydrocarbon precursors contained within it that would be heated to at a minimum of 300° C. would be significant.

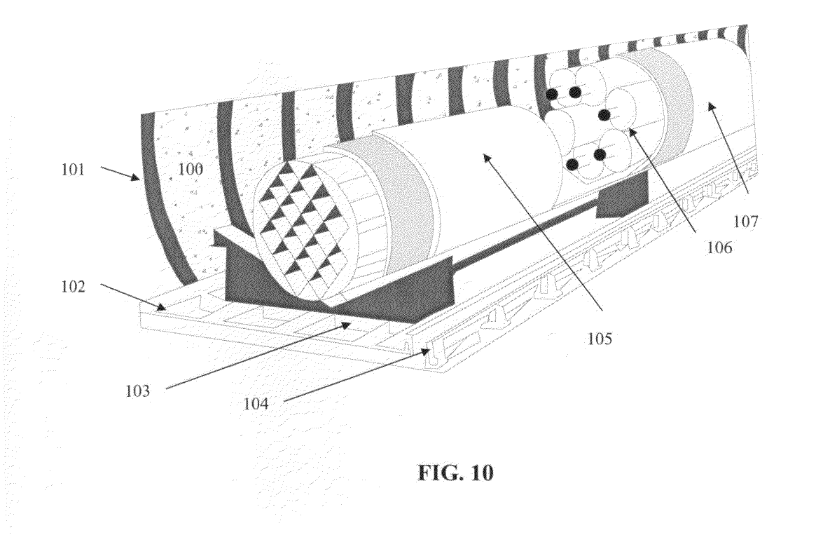

FIG. 10 shows a horizontal SNF repository 100 for reference. The technology for constructing a deep geologic repository is well know in the industry and does not form part of this inventive concept. In one embodiment of the present invention the heat generated by the decay of radioactive waste deposited in a horizontal SNF repository 100 alters the chemical and/or physical properties of a portion of the hydrocarbon material within a subterranean unconventional oil formation to allow removal of the altered material. The SNF repository 100 consists of a drift liner 101 for ground control, an emplacement drift insert 102 for supporting an emplacement trolley 103 and rails 104 for conveyance of spent fuel packages into the SNF repository 100. The SNF repository 100 will be approximately 2 m in diameter, sufficient to accommodate CSNF waste packages 105 and DSNF waste packages 106 and HLW packages 107. The waste packages will have a common diameter (1.8 m), but their lengths will vary according to the type of waste—from about 3.6 m for defense waste to 5.7 m for SNF.

A 1999 study by the Office of Civilian Radioactive Waste Management—Waste Package Operations Group, “Subsurface Shielding-specific Source Term Evaluation” MOL.19990831.0053 assumed a CSNF thermal design basis of 11.8 kW/waste package (WP), representing the maximum heat load per waste package, which is 20% over the average heat load of 9.8 kW/WP.

These assumptions were based on various combinations of the enrichment, burnup and cooling time to produce this heat as shown in Table 3 below where; E=the Initial U-235 enrichment of the fuel rod.

TABLE 3
Fuel Parameters and Source Time

| | Burnup | Cooling | Heat |
|---|---|---|---|
| | MWd/MTU | (years) | (w/MTU) |
| E = 2.0% | 21600 | 5 | 1214 |
| E = 2.5% | 22300 | 5 | 1210 |
| | 26000 | 6 | 1212 |
| | 28600 | 7 | 1210 |
| | 30500 | 8 | 1213 |
| E = 3.0% | 23000 | 5 | 1209 |
| | 26700 | 6 | 1210 |
| | 29400 | 7 | 1212 |
| | 31200 | 8 | 1212 |
| | 33700 | 10 | 1211 |
| | 37900 | 15 | 1212 |
| E = 3.5% | 27400 | 6 | 1210 |
| | 30100 | 7 | 1211 |
| | 31800 | 8 | 1209 |
| | 34400 | 10 | 1210 |
| | 38700 | 15 | 1210 |
| | 42100 | 20 | 1211 |
| | 45400 | 25 | 12111 |
| E = 4.0% | 32400 | 8 | 1212 |
| | 35000 | 10 | 1210 |
| | 39500 | 15 | 1210 |
| | 43000 | 20 | 1210 |
| | 46500 | 25 | 1213 |
| | 49900 | 30 | 1211 |
| E = 4.5% | 41000 | 16 | 1212 |
| | 43900 | 20 | 1211 |
| | 47500 | 25 | 1212 |
| | 51000 | 30 | 1212 |
| E = 5.0% | 52000 | 30 | 1210 |

For the study a CSNF 105 consists of 21 spent PWR assemblies of the fuel type used in the B&W 15×15 Mark B fuel assembly with a heavy metal loading of 0.464 MTU per assembly. Each PWR fuel assembly in the waste package generates a heat output of 562 watts. This heat output equals the WP thermal load of 11.8 kW divided by 21 fuel assemblies, implying that uniform mixing is assumed with the same heat generation rate for each assembly. It needs to be recognized that some assemblies may be hotter or colder, as long as the thermal design basis of 11.8 kW/W is met. The length of a fuel assembly is 360.18 cm therefore each PWR fuel assembly generates 156 watts along each meter of its length.

An objective of this invention is to provide a method of disposing of nuclear waste in underground sedimentary rock formations, which will bury the waste in a horizontally extending SNF repository 100 positioned well below the earth's surface.

Nuclear waste is placed and secured within a CSNF waste packages 105 or DSNF waste packages 106 and HLW packages 107. The radioactive canister is well known in the art and presently used for securing nuclear waste. Any known method for securing nuclear waste in a container or capsule for placement in a SNF repository 100 as produced by the present method may be used and does not form part of the inventive concept. It is thus not deemed necessary to further describe the process of securing the nuclear waste within the capsule. The nature of the sedimentary rock formation in which the SNF repository 100 is constructed allows for a SNF repository 100 that is 36% the diameter of the proposed emplacement drift for Yucca Mountain, which is 5.5 m. As the zone of a rock mass influenced by an excavation increases in size with at least the square, and possibly the cube, of the largest dimension of the excavation it is an objective of this invention to make approximately 1/7th the impact on the geology in which the SNF repository 100 is formed.

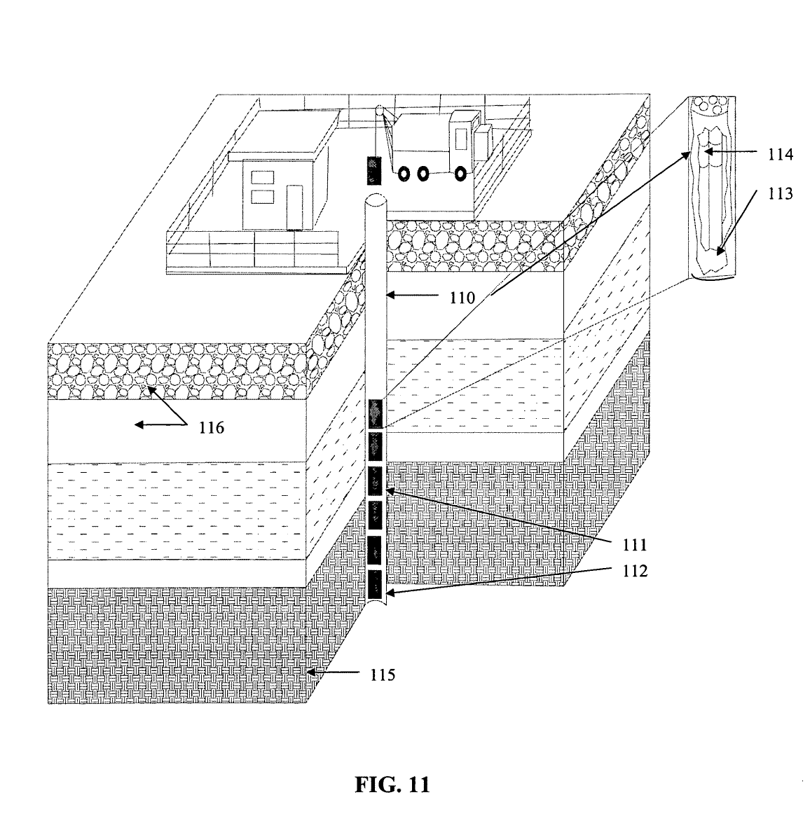

FIG. 11 depicts a vertical borehole 110 for depositing SNF 111. The technology for disposing of SNF 111 in vertical boreholes 110 is well known in the industry and does not form part of this inventive concept. The present invention exploits the heat generated by the decay of HLW 112 to alter the chemical and/or physical properties of hydrocarbon material within a subterranean unconventional oil formation to allow removal of the altered material. FIG. 11 shows a canister 113 for the disposal of SNF 111 and other HLW 112 in a vertical borehole repository 110 using currently available and proven oil, gas, and geothermal drilling technology. The canister 113 is suitable for disposal of various waste forms, such as fuel assemblies and vitrified waste. The canisters 113 use standard oil drilling casings. The inner diameter is 315.32 mm in order to accommodate a PWR assembly 114 with a width of 214 mm. At five meters tall, each canister 113 holds one PWR assembly 114. The canister 113 thickness is 12.19 mm, with an outer diameter of 339.7 mm. A liner can extend to the bottom of the emplacement zone to aid in retrievability. The liner has an outer diameter of 406.4 mm and a thickness of 9.52 mm. The standard drill bit used with a liner of this size has an outer diameter of 444.5 mm.

A “formation” includes one or more hydrocarbon containing layers 115, one or more non-hydrocarbon layers 116. The waste canister 113 will be placed only in the hydrocarbon containing layer to maximize the EROI of the waste heat. The possibility of retrieval of the deposited canister 113 is not mandatory but would be desirable in case of unforeseen environmental circumstances, or for reprocessing of the spent fuel for future energy purposes after it has cooled or possibly for relocating the spent fuel to another location to utilize its residual heat for producing another area once the recoverable oil adjacent the original placement has been fully exploited. The canisters 113 are therefore designed with a structural strength that may last for the period of time under consideration, which includes the strength required for resisting strains imposed during deposition.

The top of the borehole 110 would be sealed with asphalt and concrete and bentonite and bentonite would also fill the non-hydrocarbon layers of the borehole 110.

The technology for running objects in a borehole 110 and retrieving them is widely known in the oilfield industry. It is thus not deemed necessary to further describe the process of running nuclear waste into a borehole 110 or retrieving waste packages for the purposes of this invention.

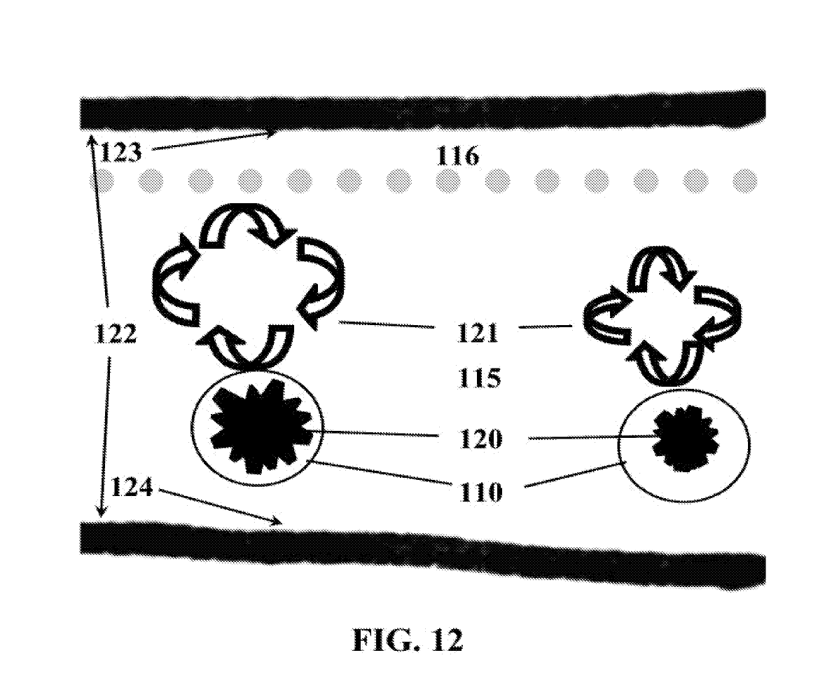

Hydrothermal convection as shown in FIG. 12 is an efficient conductor of heat. As the temperature gradient of a heat source 120, such as nuclear waste, decreases so does its capacity to drive a hydrothermal cycle 121. It is an objective of this invention to store nuclear waste in an unconventional oil formation 122 which confines the hydrothermal cycle 121 to ensure radionuclides cannot be transported back to the biosphere. Said storage must be long enough for the radioactivity of the waste, thus its capacity to produce heat, to subside sufficiently that said waste is no longer capable of driving a hydrothermal cycle 121 that is capable of returning radionuclides to the biosphere.

Heat-driven hydrothermal cycles 121 above a SNF repository 100 require tens of thousands of years to fully develop. As the thermal pulse from the SNF repository 100 propagates both vertically and radially the region over which a repository-heat-driven convection occurs continues to expand during (at least) the first 20,000 years. Models of Yucca Mountain show that after 1000 years, two convection cells develop (in cross section), extending radially approximately 2-3 km from the repository center. After 5000 years the radial extent of repository-heat-driven convection is about 5 km and after 10,000 years the radial extent of the convection cells is about 8-10 km and after 20,000 years the radial extent of the convection cells exceeds 10 km from the repository center.

An unconventional oil formation 122 includes one or more hydrocarbon containing layers 115, one or more non-hydrocarbon containing layers 116, an overburden 123, and/or an underburden 124, which may extend over a far greater subsurface area than 10 km. The overburden 123 and/or underburden 124 typically include one or more different types of impermeable materials such as shale, mudstone, or wet/tight carbonate (i.e., an impermeable carbonate without hydrocarbons). The impermeability of the overburden 123 and underburden 124 ensures the hydrothermal cycle 121 is confined between the overburden 123 and underburden 124 of the unconventional oil formation 122. Radionuclides could not therefore be transported to the surface where they could cause serious harm or death.

The ability of a unconventional oil formation 122 to confine a hydrothermal cycle 121 and thus sequester radionuclides affords the option of making the storage of nuclear waste within the unconventional oil formation 122 either permanent or temporary. The long-term fuel supply of uranium for nuclear power is assured by the 4 billion tons of uranium in the oceans, available to any nation at a per-ton cost less than that of a ton of uranium saved by reprocessing and recycling nuclear fuel. Two billion tons would feed 5,000 nuclear plants (compared with the 430 that now exist) for 2,000 years. The use of breeder reactors would extend this resource for 400,000 years, but current breeder technology has had problems and there is no immediate need to move to breeders since the plutonium in spent fuel and the plutonium that has already been separated by the civilian reprocessing industry is an available resource. Reprocessing, should it become necessary in a world with vastly more nuclear power plants, would be less dangerous were it attempted after waste had been stored long enough for the fissions products within the waste to totally decay. It might be desirable to be able to recover SNF 111 for the reasons explained above, but others argue the once through cycle where nuclear waste is permanently eliminated in a deep geologic repository is the most economical and desirable approach to the problem of nuclear waste. It is the intention of this invention to afford an immediate solution to the problem of nuclear waste that provides the flexibility of eventually recovering and reprocessing SNF 111 if that should become necessary or desirable.

From the above description, it is evident that the present invention provides a method of disposing of nuclear waste in a geologic formation 125 that provides prolonged safety from the nuclear waste and added protection to human health and the environment. This method also provides protection in case of rupturing or leaking of the canister 113 in which the waste is stored and safe storage of the waste for at least 10,000 years. It also provides storage of nuclear waste, which is impervious to surface effects such as flooding, glaciation or seismic interference.

It is an objective of the present invention to provide a method of disposing of WGP excess to defense needs and/or plutonium separated by the civilian reprocessing industry in the side walls or floor of a SNF repository 100 in the course of construction of said SNF repository 100, such that the radiological barrier provided by the SNF 111, later inserted in the SNF repository 100, will provide a level of proliferation resistance equivalent to the spent fuel standard.

A 1994 report of the U.S. National Academy of Sciences notes that even if no more WGP is produced, the United States and former Soviet republics each will have about 100 MT of surplus plutonium from the dismantlement of nuclear weapons by the year 2003. Only about five kilograms of such plutonium is needed to make a primitive nuclear weapon in the kiloton range. On the civilian side, about 330 MT of RGP will have been separated from spent fuel worldwide and be available for use by the year 2003.

Security and accountability of plutonium stockpiles are extremely important. Placement of sub-critical masses of plutonium 130 in the side wall and/or floor of a SNF repository 100, which is subsequently covered by a drift liner 101 and filled with nuclear waste, affords said plutonium at least the equivalent proliferation resistant presented by plutonium in SNF 111 and accordingly meets the spent fuel standard.

A critical mass is the smallest amount of fissile material needed for a sustained nuclear chain reaction. Table 4 shows the critical masses of the isotopes of plutonium.

TABLE 4

| Isotope | Critical Mass | | Diameter | |
|---|---|---|---|---|
| plutonium-239 | 10 | kg | 9.9 | cm |
| plutonium-240 | 40 | kg | 15 | cm |
| plutonium-241 | 12 | kg | 10.5 | cm |
| plutonium-242 | 75-100 | kg | 19-21 | cm |

A nuclear chain reaction occurs when one nuclear reaction causes an average of one or more nuclear reactions, thus leading to a self-propagating number of these reactions. The nuclear chain reaction is unique since it releases several million times more energy per reaction than any chemical reaction. A nuclear explosion occurs as a result of the rapid release of energy from an intentionally high-speed nuclear reaction. It is necessary therefore sub-critical masses of fissile materials, such as plutonium, are prevented from attaining critical mass in a SNF repository 100.

It is the intention of this invention to keep sub-critical masses of plutonium 130 from reaching critical mass by providing linear separation between the sub-critical masses in the sidewalls and/or floor of the SNF repository 100.

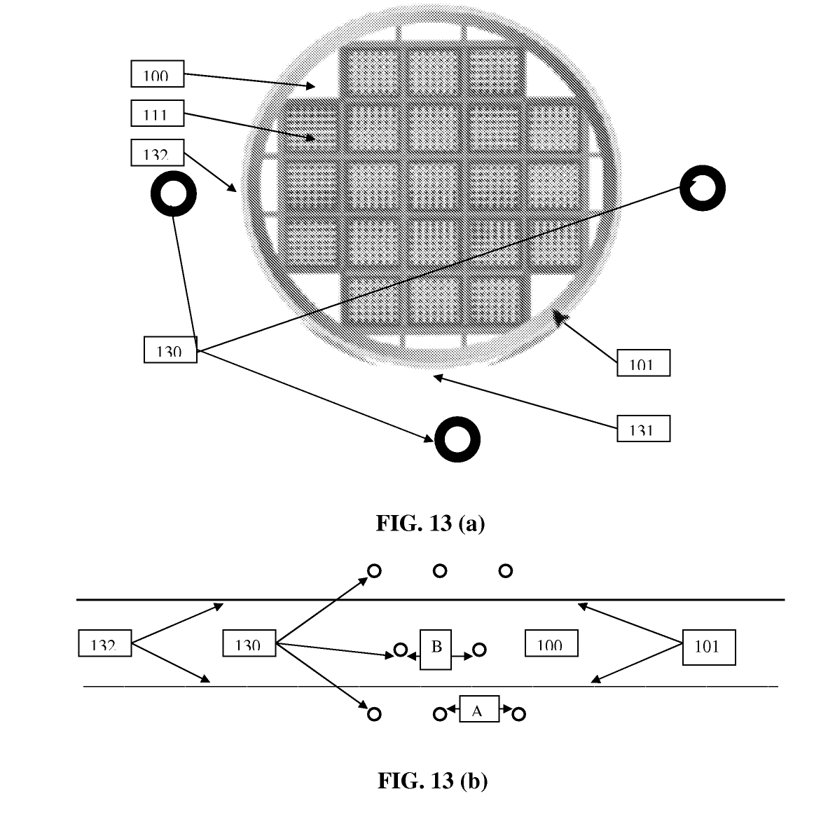

Modern tunnel boring machines, as would be used to construct a SNF repository 100, can attain average daily advance rates of as high as 45 m in ideal conditions. This is close to 2 m per hour. If plutonium is spaced in the SNF repository 100 floor 131 or sidewall 132 one meter apart to afford linear separation, it would take a minimum of a half hour for the tunnel boring machine to advance that distance, A in FIG. 13(b), to the point where the next sub-critical mass of plutonium would be placed. It is another intention of this invention to use temporal separation, of a half hour, of sub-critical masses of plutonium 130, represented by B in FIG. 13(b), to ensure no 2 sub-critical masses of plutonium 130 are in the same physical space in a SNF repository 100 at the same time.

In another embodiment of the present invention a method is proposed for disposing of WGP 130 excess to defense needs and/or plutonium separated by the civilian reprocessing industry in the deepest portion of a borehole 110 constructed in or through an unconventional oil formation 122, such that the radiological barrier provided by the SNF 111 inserted above the canister 113, at the level of the unconventional oil formation 122, will provide a level of proliferation resistance equivalent to the spent fuel standard.

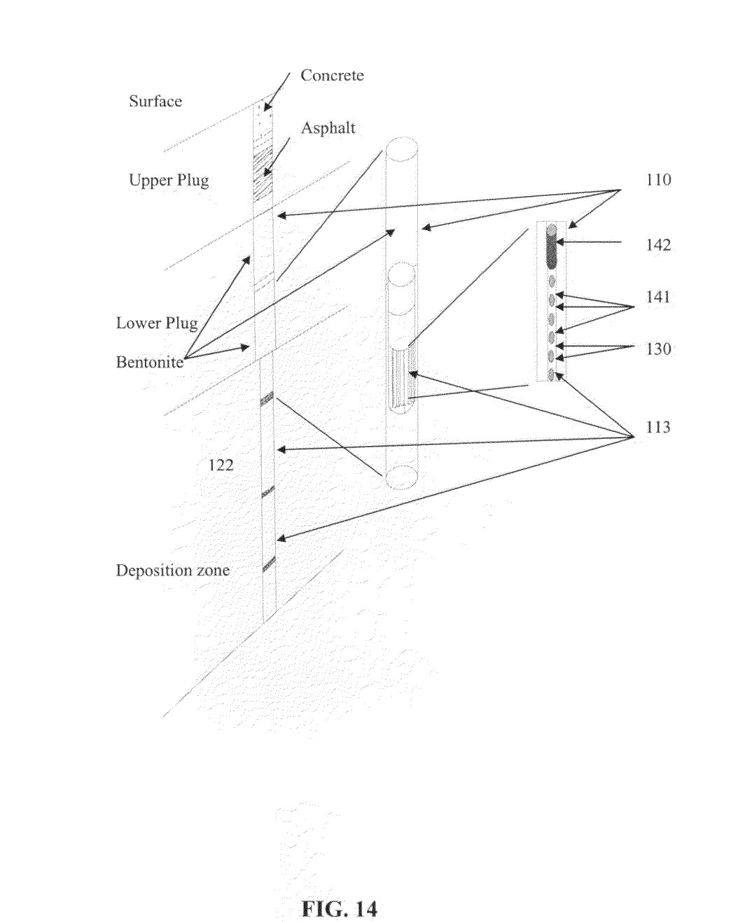

It is the intention of this invention to keep sub-critical masses of plutonium 130 from reaching critical mass by providing linear separation between the sub-critical masses in a canister 113 inserted in the deepest portion of a vertical borehole 110. The inner diameter of said canister 113 is 98 mm in order to accommodate a sub-critical mass, and no more, of any of the four isotopes of plutonium shown in Table 4. Each sub-critical unit of plutonium is separated from the others inside said canister 113 by a linear spacer 141, in FIG. 14, to prevent attainment of critical mass. The outer diameter of the canister is 115 mm in order that the canister 113 can be inserted in a 120.65 mm diameter open hole which is a standard size in the oilfield industry. The canister 113 will be 9.14 m in length, which is also a standard length of drill pipe in the oilfield industry. The borehole 110 and the insertion of the canister 113 can be accomplished with conventional oilfield equipment. Because plutonium-241 is a beta particle 31 emitter and all of the others isotopes of plutonium are alpha particle 30 emitters, the 8.5 mm thickness of the canister 113 wall will stop any radiation from reaching workers handling the canisters 113 which will be sealed top and bottom with a radiation shielding 33 plug 142. The thermal flux of the plutonium within the canisters 113 will not be sufficient to prevent the handling of the canisters 113 with minimal protection. It is desirable that WGP 130 should be made as inaccessible as possible in order that it can never be reincorporated into a warhead. Conventional oil wells are currently being drilled to depths in excess of 6500 m. Unconventional oil deposits are typically found at depths of less than 2000 m. A 9.14 m canister for disposing of plutonium could accommodate 45 sub-critical masses of plutonium-239 (WGP 130) if they were separated equidistantly in a disposal canister 113 by linear spacers 141 of 9 cms and allowing for end plugs 142 of roughly 34 cm. Each canister 113 would therefore dispose of 450 kg of WGP 130. Assuming the United States and Russia possess 200 MT of surplus WGP 130 from the dismantlement of nuclear weapons it would take 444 canisters 113 to dispose of this amount of WGP 130. Assuming 4500 m of borehole 110 is available beneath a borehole 110 drilled to 6500 m through an unconventional oil formation 122 for the disposal of WGP 130, 478 canisters 113, or approximately the amount of WGP 130 that has been allocated for disposal could be eliminated in a single borehole 110.

A 2000 study by the Swedish Nuclear Fuel and Waste Management Co. on very deep boreholes 110 for disposal of nuclear waste estimated it would take approximately 137 days to drill and case a 4000 m borehole 110 at a cost of 4.65 M euro or roughly U.S. $6.836 M.

A 6,500-m borehole 110 would accommodate all of the excess Russian and U.S. WGP 130 that is supposed to be eliminated as MOX for exponentially less than the estimated $5.8 billion cost of the MOX program, even if the current cost of the well ran upwards of the $100 million cost of a deep water well in the Gulf of Mexico.

Isotopes of plutonium generate exponentially less heat than SNF 111; therefore the problems of heat that have been identified with SNF 111 disposal in deep boreholes 110 would not apply to this embodiment of the current invention.

The 330 tons of separated civilian plutonium, 30,000 bomb equivalents, could be totally eliminated in 4×4,000 meter deep wells, between the depths of 2000 and 4000 m, ((733canisters*9.14 m)/2000) at a cost of less than U.S. $28 M. Considering it has been estimated the damage from a single terrorist bomb detonated on the island of Manhattan could be as high as U.S. $1 trillion, the cost of 4 wells for disposing of the total global inventory of loose plutonium is a prudent investment.

Organic debris derived from plants and algae is best preserved in fine-grained sediments deposited in the absence of oxygen. Low-temperature chemical and biological reactions (called diagenesis) that occur during transport to and early burial in the depositional environment modify this organic matter. Many of the chemical compounds present in sediments are in fact derived from bacteria, and were formed as dead organic matter converted to microbial tissues.

Most of this organic matter is transformed during diagenesis into very large molecules, the largest of which are called kerogen. These play a key role as the precursors for oil and much natural gas.

The earliest stage of hydrocarbon generation occurs during diagenesis. Certain microorganisms, called methanogens, convert some of the organic debris to biogenic methane. In many areas a large portion of the natural gas reserves are biogenic.

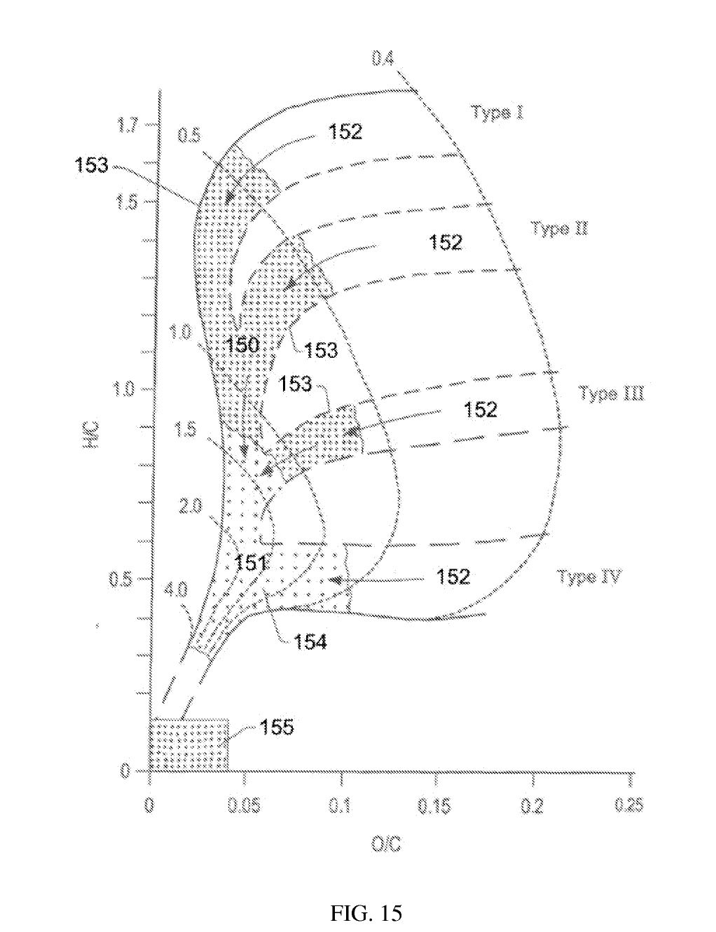

As burial depth increases, porosity and permeability decrease, and temperature increases. These changes lead to a gradual cessation of microbial activity, and thus eventually bring organic diagenesis to a halt. As temperature rises, however, thermal reactions become increasingly important. During this second transformation phase, called catagenesis represented by the stippled area 150 of FIG. 15, kerogen begins to decompose into smaller, more mobile molecules. In the early stages of catagenesis 150 most of the molecules produced from kerogen are still relatively large; these are the precursors for petroleum, and are called bitumen. In the late stages of catagenesis 150 and in the final transformation stage, called metagenesis, represented by the stippled area 151 of FIG. 15, the principal products consist of smaller gas molecules.

In recent years this relatively simple picture of hydrocarbon generation has been complicated by awareness that kerogens formed from different kinds of organic matter, or under different diagenetic conditions, are chemically distinct from each other. These differences can have a significant effect on hydrocarbon generation. Kerogen is composed of organic matter that has been transformed due to a maturation process. The maturation process for kerogen may include two stages: a biochemical stage and a geochemical stage. The biochemical stage typically involves degradation of organic material by aerobic and/or anaerobic organisms. The geochemical stage typically involves conversion of organic matter due to temperature changes and significant pressures. During maturation, oil and gas may be produced as the organic matter of the kerogen is transformed.

Kerogen is normally defined as that portion of the organic matter present in sedimentary rocks that is insoluble in ordinary organic solvents. The soluble portion is called bitumen. Lack of solubility is a direct result of the large size of kerogen molecules, which have molecular weights of several thousand or more. Each kerogen molecule is unique, because it has patchwork structures formed by the random combination of many small molecular fragments. The chemical and physical characteristics of a kerogen are strongly influenced by the type of biogenic molecules from which the kerogen is formed and by diagenetic transformations of those organic molecules.

Kerogen composition is also affected by thermal maturation processes (catagenesis 150 and metagenesis 151) that alter the original kerogen. Subsurface heating causes chemical reactions that break off small fragments of the kerogen as oil or gas molecules. The residual kerogens also undergo important changes, which are reflected in their chemical and physical properties.

Kerogen is of interest because it is the source of most of the oil and some of the gas that we exploit as fossil fuels. Diagenetic and catagenetic histories of a kerogen, as well as the nature of the organic matter from which it was formed, strongly influence the ability of the kerogen to generate oil and gas. Understanding how kerogen is formed and transformed in the subsurface affords insight into how and where hydrocarbons are generated, whether these hydrocarbons are mainly oil or gas, and how much oil or gas can be expected to be produced by a formation.

The term kerogen originally described the organic matter in oil shales that yielded oil upon retorting. Today it is used to describe the insoluble organic material in both coals and oil shales, as well as dispersed organic matter in sedimentary rocks. The amount of organic matter tied up in the form of kerogen in sediment is far greater than that in living organisms or in economically exploitable accumulations of coal, oil, and natural gas.

The process of kerogen formation actually begins during senescence of organisms, when the chemical and biological destruction and transformation of organic tissues begin. Large organic biopolymers of highly regular structure (proteins and carbohydrates, for example) are partially or completely dismantled, and the individual component parts are either destroyed or used to construct new geopolymers, large molecules that have no regular or biologically defined structure. These geopolymers are the precursors for kerogen but are not true kerogens. The smallest of these geopolymers are usually called fulvic acids; slightly larger ones, humic acids; and still larger ones, humins. During the course of diagenesis in the water column, soils, and sediments, the geopolymers become larger, more complex, and less regular in structure. True kerogens, having very high molecular weights, develop after tens or hundreds of meters of burial.

Diagenesis results mainly in loss of water, CO₂, and ammonia from the original geopolymers. If anaerobic sulfate reduction is occurring in the sediments, and if the sediments are depleted in heavy-metal ions (which is often the case in nonclastic sediments but is seldom true in shales), large amounts of sulfur may become incorporated into the kerogen structure. The amount of sulfur contributed by the original organic matter itself is very small. Carbon-carbon double bonds, which are highly reactive, are converted into saturated or cyclic structures.

Kerogen formation competes with the destruction of organic matter by oxidative processes. Most organic oxidation in sedimentary environments is microbially mediated. Microorganisms prefer to attack small molecules that are biogenic, or at least look very much like biogenic molecules. Geopolymers are more or less immune to bacterial degradation, because the bacterial enzyme systems do not know how to attack them. In an oxidizing environment many of the small biogenic molecules will be attacked by bacteria before they can form geopolymers. In a low-oxygen (reducing) environment, in contrast, the subdued level of bacterial activity allows more time for the formation of geopolymers and, therefore, better organic preservation.

Kerogens formed under reducing conditions will be composed of fragments of many kinds of biogenic molecules. Those kerogens formed under oxidizing conditions, in contrast, contain mainly the most resistant types of biogenic molecules that were ignored by microorganisms during diagenesis.

The van Krevelen diagram shown in FIG. 15 classifies various natural deposits of kerogen. Each kerogen molecule is unique, but kerogens may be classified into four distinct groups: Type I, Type II, Type III, and Type IV, which are illustrated by the four branches of the van Krevelen diagram. The van Krevelen diagram shows the maturation sequence for kerogen that typically occurs over geological time due to temperature and pressure. Classification of kerogen type may depend upon precursor materials of the kerogen. The precursor materials transform over time into macerals. Macerals are microscopic structures that have different structures and properties depending on the precursor materials from which they are derived. Macerals are essentially organic minerals; they are to kerogen what minerals are to a rock. The kerogen in a given sedimentary rock includes many individual particles that are often derived from a variety of sources. Thus few kerogens consist of a single maceral type.

Type I kerogen may result from deposits made in lacustrine environments. Type I kerogen is quite rare because it is derived principally from lacustrine algae. The best-known example is the Green River Formation 6, of middle Eocene age, from Wyoming, Utah, and Colorado. Type I kerogens are limited to anoxic lakes and to a few unusual marine environments. Type I kerogens have high generative capacities for liquid hydrocarbons.

Type II kerogens arise from several very different sources, including marine algae, pollen and spores, leaf waxes, and fossil resin. They also include contributions from bacterial-cell lipids. The various Type II kerogens are grouped together, despite their very disparate origins, because they all have great capacities to generate liquid hydrocarbons. Most Type II kerogens are found in marine sediments deposited under reducing conditions.

Type III kerogens are composed of terrestrial organic material that is lacking in fatty or waxy components. Cellulose and lignin are major contributors. Type III kerogens have much lower hydrocarbon-generative capacities than do Type II kerogens and, unless they have small inclusions of Type II material, are normally considered to generate mainly gas.

Type IV kerogens contain mainly reworked organic debris and highly oxidized material of various origins. They are generally considered to have essentially no hydrocarbon-source potential.

Hydrogen contents of immature kerogens (expressed as atomic H/C ratios) correlate with kerogen type. In the immature state, Type I (algal) kerogens have the highest hydrogen contents because they have few rings or aromatic structures. Type II (liptinitic) kerogens are also high in hydrogen. Type III (humic) kerogens, in contrast, have lower hydrogen contents because they contain extensive aromatic systems. Type IV kerogens, which mainly contain polycyclic aromatic systems, have the lowest hydrogen contents.

Heteroatom contents of kerogens also vary with kerogen type. Type IV kerogens are highly oxidized and therefore contain large amounts of oxygen. Type III kerogens have high oxygen contents because they are formed from lignin, cellulose, phenols, and carbohydrates. Type I and Type II kerogens, in contrast, contain far less oxygen because they were formed from oxygen-poor lipid materials.

A van Krevelen diagram shows maturation pathways for Types 1 to IV kerogens as traced by changes in atomic H/C and O/C ratios. The shaded areas approximately represent diagenesis, catagenesis 150, and metagenesis 151, successively.

Nitrogen and sulfur are also lost from kerogens during catagenesis 150. Nitrogen loss occurs primarily during late catagenesis 150 or metagenesis 151, after hydrogen loss is well advanced. In contrast, much of the sulfur is lost in the earliest stages of catagenesis 150, as evidenced by low maturity, high-sulfur oils found in a number of areas.

The most important implication of these chemical changes is that the remaining hydrocarbon-generative capacity of a kerogen decreases during catagenesis 150 and metagenesis 151. All kerogens become increasingly aromatic and depleted in hydrogen and oxygen during thermal maturation. In the late stages of maturity, Types I, II, and III kerogens will therefore be very similar chemically, possessing essentially no remaining hydrocarbon generative capacity.

Kerogen particles become darker during catagenesis 150 and metagenesis 151, much as a cookie browns during baking. There is a steady color progression yellow-goldenorange-light brown-dark brown-black as a result of polymerization and aromatization reactions. These reactions are intimately related to important changes in the chemical structure of kerogen, but they are not necessarily identical with hydrocarbon generation. There is therefore no necessary cause-and-effect relationship between kerogen darkening and hydrocarbon generation, and no guarantee that a particular kerogen color always heralds the onset of oil generation.

As kerogen matures and becomes more aromatic, its structure becomes more ordered, because the flat aromatic sheets can stack neatly. These structural reorganizations bring about changes in physical properties of kerogens. One property that is strongly affected, and which can be used to gauge the extent of molecular reorganization, is the ability of kerogen particles to reflect incident light coherently. The more random a kerogen's structure, the more an incident light beam will be scattered, and the less it will be reflected.

Vitrinite is a type of maceral with a shiny appearance resembling glass. It is derived from the cell-wall material or woody tissue of the plants from which coal was formed. Half a century ago coal petrologists discovered that the percentage of light reflected by vitrinite particles could be correlated with coal rank measured by other methods.

Because coal rank is merely a measure of coal maturity, and because vitrinite particles also occur in kerogens, the technique, called vitrinite reflectance, has been widely and successfully applied in assessing kerogen maturity.

Sulfur and nitrogen contents of kerogens are also variable and, in some cases, interrelated. Nitrogen is derived mainly from proteinaceous material, which is destroyed rapidly during diagenesis. Most high-nitrogen kerogens were therefore deposited under anoxic conditions where diagenesis was severely limited. Because lignins and carbohydrates contain little nitrogen, most terrestrially influenced kerogens are low in nitrogen.

Kerogen sulfur, in contrast, is derived mainly from sulfate that was reduced by anaerobic bacteria. High-sulfur kerogens (and coals) are almost always associated with marine deposition, because fresh waters are usually low in sulfate. Sulfur is only incorporated into kerogens in large quantities where sulfate reduction is extensive and where Fe²⁺ ions are absent (organic-rich, anoxic, marine, nonclastic sediments). Many high-sulfur kerogens are also high in nitrogen.

Kerogen maturation is not a reversible process. The chemical process of maturation never stops completely, even if drastic decreases in temperature occur. Chemical reaction-rate theory requires that the rates of reactions decrease as temperature decreases, but it also states that at any temperature above absolute zero reactions will be occurring at some definable rate. For practical purposes, however, the rates of catagenesis 150 are generally not important at temperatures below about 70° C. Furthermore, in most cases decreases of temperature in excess of about 20°-30° C. due to subsurface events or erosional removal will cause the rates of catagenesis 150 to decrease so much that it becomes negligible for practical purposes.

It is impossible to set precise and universal temperature limits for catagenesis 150, because time also plays a role. Old rocks will often generate hydrocarbons at significantly lower temperatures than young rocks, simply because the longer time available compensates for lower temperatures.

The cracking of any organic molecule requires hydrogen. The more hydrogen a kerogen contains the more hydrocarbons it can yield during cracking. Because many of the light product molecules are rich in hydrogen, the residual kerogen gradually becomes more aromatic and hydrogen poor as catagenesis 150 proceeds. Thus the steady decrease in hydrogen content of a kerogen (usually measured as the atomic hydrogen/carbon ratio) during heating can be used as an indicator of both kerogen catagenesis 150 and hydrocarbon generation, provided that the hydrogen content of the kerogen was known prior to the onset of catagenesis 150.

Cracking often produces free radicals, which are unpaired electrons not yet involved in chemical bonds. Kerogens, especially highly aromatic ones, contain large numbers of unpaired electrons. The concentration of free radicals in a given kerogen has been found to increase with increasing maturity. Free-radical concentrations can be measured by electron-spin resonance.

Kerogens often fluoresce when irradiated. The intensity and wavelength of the fluorescence are functions of kerogen maturity.

Some properties of kerogen change very little during catagenesis 150. For example, carbon-isotopic compositions of kerogens are affected little by maturation. Except for darkening, the visual appearance of kerogen also does not change during catagenesis 150: kerogen types are generally recognizable until the particles become black and opaque, somewhat beyond the oil-generation window.

As kerogen catagenesis 150 occurs, small molecules are broken off the kerogen matrix. Some of these are hydrocarbons, while others are small heterocompounds. These small compounds are much more mobile than the kerogen molecules and are the direct precursors of oil and gas. A general name for these molecules is bitumen.

Bitumen generation occurs mainly during catagenesis 150; during metagenesis 151 the chief product is methane. If neither expulsion from the source rock nor cracking of bitumen occurred, there would be a large and continuous build-up of bitumen in the rock as a result of catagenetic decomposition of kerogen. What actually occurs, however, is that some of the bitumen is expelled from the source rock or cracked to gas, resulting in lower bitumen contents in the source.

Effective generation of hydrocarbons requires that the generated products be expelled from the source-rock matrix and migrated to a trap. Timing and efficiency of expulsion depend on a number of factors, including rock physics and organic-geochemical considerations. Many experts believe that microfracturing of source rocks is very important for hydrocarbon expulsion. Microfracturing is related to overpressuring, which in turn is partly attributed to hydrocarbon generation itself. Rich rocks will become overpressured earlier than lean ones and thus will also expel hydrocarbons earlier. In very lean rocks expulsion may occur so late that cracking of the generated bitumen is competitive with expulsion. In such cases the expelled products will be mainly gas.

Unconventional oil formation 122 may be selected for in situ conversion based on properties of at least a portion of the formation. For example, a formation may be selected based on richness, thickness, and/or depth (i.e., thickness of overburden 123) of the formation. In addition, the types of fluids producible from the formation may be a factor in the selection of a formation for in situ conversion. In certain embodiments, the quality of the fluids to be produced may be assessed in advance of treatment. Assessment of the products that may be produced from a formation may generate significant cost savings since only formations that will produce desired products need to be subjected to in situ conversion. Properties that may be used to assess hydrocarbons in a formation include, but are not limited to, an amount of hydrocarbon liquids that may be produced from the hydrocarbons, a likely API gravity of the produced hydrocarbon liquids, an amount of hydrocarbon gas producible from the formation, and/or an amount of CO₂ and water that in situ conversion will generate.

Vitrinite reflectance of a kerogen in an unconventional oil formation 122 may indicate which fluids are producible from a formation upon heating. For example, a vitrinite reflectance of approximately 0.5% to approximately 1.5% may indicate that the kerogen will produce a large quantity of condensable fluids. In addition, a vitrinite reflectance of approximately 1.5% to 3.0% may indicate a kerogen that would produce mainly methane and H₂ when heated. A kerogen containing formation to be subjected to in situ conversion may be chosen based on a vitrinite reflectance.

The dashed lines in FIG. 15 correspond to vitrinite reflectance. Vitrinite reflectance is a measure of maturation. As kerogen undergoes maturation, the composition of the kerogen usually changes due to expulsion of volatile matter (e.g., CO₂, methane, and oil) from the kerogen. Rank classifications of kerogen indicate the level to which kerogen has matured. For example, as kerogen undergoes maturation, the rank of kerogen increases. As rank increases, the volatile matter within, and producible from, the kerogen tends to decrease. In addition, the moisture content of kerogen generally decreases as the rank increases. At higher ranks, the moisture content may reach a relatively constant value. Higher rank kerogens that have undergone significant maturation tend to have a higher carbon content and a lower volatile matter content than lower rank kerogens such as lignite.

In some in situ conversion embodiments, an unconventional oil formation 122 may be selected for treatment based on hydrogen content within the hydrocarbons in the formation. For example, a method of treating an unconventional oil formation 122 may include selecting a portion of the unconventional oil formation 122 for treatment having hydrocarbons with a hydrogen content greater than about 3 weight %, 3.5 weight %, or 4 weight % when measured on a dry, ash-free basis. In addition, a selected section of an unconventional oil formation 122 may include hydrocarbons with an atomic hydrogen to carbon ratio that falls within a range from about 0.5 to about 2, and in many instances from about 0.70 to about 1.65.

Hydrogen content of an unconventional oil formation 122 may significantly influence a composition of hydrocarbon fluids producible from the formation. Pyrolysis of hydrocarbons within heated portions of the formation may generate hydrocarbon fluids that include a double bond or a radical. Hydrogen within the formation may reduce the double bond to a single bond. Reaction of generated hydrocarbon fluids with each other and/or with additional components in the formation may be inhibited. For example, reduction of a double bond of the generated hydrocarbon fluids to a single bond may reduce polymerization of the generated hydrocarbons. Such polymerization may reduce the amount of fluids produced and may reduce the quality of fluid produced from the formation.

Hydrogen within the formation may neutralize radicals in the generated hydrocarbon fluids. Hydrogen present in the formation may inhibit reaction of hydrocarbon fragments by transforming the hydrocarbon fragments into relatively short chain hydrocarbon fluids. The hydrocarbon fluids may enter a vapor phase. Vapor phase hydrocarbons may move relatively easily through the formation to production wells. Increase in the hydrocarbon fluids in the vapor phase may significantly reduce a potential for producing less desirable products within the selected section of the formation.

A lack of bound and free hydrogen in the formation may negatively affect the amount and quality of fluids that can be produced from the formation. If too little hydrogen is naturally present, then hydrogen or other reducing fluids may be added to the formation.

When heating a portion of an unconventional oil formation 122, oxygen within the portion may form CO₂. A formation may be chosen and/or conditions in a formation may be adjusted to inhibit production of CO₂ and other oxides. In an embodiment, production of CO₂ may be reduced by selecting and treating a portion of an unconventional oil formation 122 having a vitrinite reflectance of greater than about 0.5%.

An amount of CO₂ that can be produced from a kerogen containing formation may be dependent on oxygen content initially present in the formation and/or an atomic oxygen to carbon ratio of the kerogen. In some in situ conversion embodiments, formations to be subjected to in situ conversion may include kerogen with an atomic oxygen weight percentage of less than about 20 weight %, 15 weight %, and/or 10 weight %. In some in situ conversion embodiments, formations to be subjected to in situ conversion may include kerogen with an atomic oxygen to carbon ratio of less than about 0.15. In some in situ conversion embodiments, a formation selected for treatment may have an atomic oxygen to carbon ratio of about 0.03 to about 0.12.

Heating an unconventional oil formation 122 may include providing a large amount of energy from nuclear waste located within the formation. Unconventional oil formations 122 may also contain some water. A significant portion of energy initially provided to a formation may be used to heat water within the formation and converting it to steam.

An unconventional oil formation 122 may be selected for treatment based on additional factors such as, but not limited to, thickness of hydrocarbon containing layers 115 within the formation, assessed liquid production content, location of the formation, and depth of hydrocarbon containing layers 115. An unconventional oil formation 122 may include multiple layers. Such layers may include hydrocarbon containing layers 115, as well as layers that are hydrocarbon free or have relatively low amounts of hydrocarbons. Conditions during formation may determine the thickness of hydrocarbon and non-hydrocarbon containing layers 116 in an unconventional oil formation 122. An unconventional oil formation 122 to be subjected to in situ conversion will typically include at least one hydrocarbon containing layer having a thickness sufficient for economical production of formation fluids. Richness of a hydrocarbon containing layer may be a factor used to determine if a formation will be treated by in situ conversion. A thin and rich hydrocarbon layer may be able to produce significantly more valuable hydrocarbons than a much thicker, less rich hydrocarbon layer. Producing hydrocarbons from a formation that is both thick and rich is desirable.

Each hydrocarbon containing layer of a formation may have a potential formation fluid yield or richness. The richness of a hydrocarbon layer may vary in a hydrocarbon layer and between different hydrocarbon layers in a formation. Richness may depend on many factors including the conditions under which the hydrocarbon containing layer was formed, an amount of hydrocarbons in the layer, and/or a composition of hydrocarbons in the layer. Richness of a hydrocarbon layer may be estimated in various ways. For example, richness may be measured by a Fischer Assay. The Fischer Assay is a standard method, which involves heating a sample of a hydrocarbon containing layer to approximately 500° C. in one hour, collecting products produced from the heated sample, and quantifying the amount of products produced. A sample of a hydrocarbon containing layer may be obtained from an unconventional oil formation 122 by a method such as coring or any other sample retrieval method.

An in situ conversion process may be used to treat formations with hydrocarbon layers that have thicknesses greater than about 10 m. Thick formations may allow for placement of nuclear waste so that superposition of heat from the nuclear waste efficiently heats the formation to a desired temperature. Formations having hydrocarbon layers that are less than 10 m thick may also be treated using an in situ conversion process. In some in situ conversion embodiments of thin hydrocarbon layer formations, nuclear waste may be inserted in or adjacent to the hydrocarbon layer along a length of the hydrocarbon layer (e.g., with a horizontal SNF repository 100).

A van Krevelen diagram may be useful for selecting a resource for practicing various embodiments. Treating a formation containing kerogen in region 152 may produce CO₂, non-condensable hydrocarbons, H₂, and water, along with a relatively small amount of condensable hydrocarbons. Treating a formation containing kerogen in region 153 may produce condensable and non-condensable hydrocarbons, CO₂, H₂, and water. Treating a formation containing kerogen in region 154 will in many instances produce methane and H₂. A formation containing kerogen in region 153 may be selected for treatment because treating region 153 kerogen may produce large quantities of valuable hydrocarbons, and low quantities of undesirable products such as CO₂ and water. A region 153 kerogen may produce large quantities of valuable hydrocarbons and low quantities of undesirable products because the region 153 kerogen has already undergone dehydration and/or decarboxylation over geological time. In addition, region 153 kerogen can be further treated to make other useful products (e.g., methane, H₂, and/or synthesis gas) as the kerogen transforms to region 154 kerogen.

If a formation containing kerogen in region 152 or region 153 is selected for in situ conversion, in situ thermal treatment may accelerate maturation of the kerogen along paths represented by arrows in FIG. 15. For example, region 152 kerogen may transform to region 153 kerogen and possibly then to region 154 kerogen. Region 153 kerogen may transform to region 154 kerogen. In situ conversion may expedite maturation of kerogen and allow production of valuable products from the kerogen.

If region 152 kerogen is treated, a substantial amount of CO₂ may be produced due to decarboxylation of hydrocarbons in the formation. In addition to CO₂, region 152 kerogen may produce some hydrocarbons (e.g., methane). Treating region 152 kerogen may produce substantial amounts of water due to dehydration of kerogen in the formation. Production of water from kerogen may leave hydrocarbons remaining in the formation enriched in carbon. Oxygen content of the hydrocarbons may decrease faster than hydrogen content of the hydrocarbons during production of such water and CO₂ from the formation. Therefore, production of such water and CO₂ from region 152 kerogen may result in a larger decrease in the atomic oxygen to carbon ratio than a decrease in the atomic hydrogen to carbon ratio (see region 152 arrows in FIG. 15 which depict more horizontal than vertical movement).

If region 153 kerogen is treated, some of the hydrocarbons in the formation may be pyrolyzed to produce condensable and non-condensable hydrocarbons. For example, treating region 153 kerogen may result in production of oil from hydrocarbons, as well as some CO₂ and water. In situ conversion of region 153 kerogen may produce significantly less CO₂ and water than is produced during in situ conversion of region 152 kerogen. Therefore, the atomic hydrogen to carbon ratio of the kerogen may decrease rapidly as the kerogen in region 153 is treated. The atomic oxygen to carbon ratio of the region 153 kerogen may decrease much slower than the atomic hydrogen to carbon ratio of the region 153 kerogen.

Kerogen in region 154 may be treated to generate methane and H₂. For example, if such kerogen was previously treated (e.g., it was previously region 153 kerogen), then after pyrolysis longer hydrocarbon chains of the hydrocarbons may have cracked and been produced from the formation. Carbon and hydrogen, however, may still be present in the formation.

If kerogen in region 154 were heated to a synthesis gas generating temperature and a synthesis gas generating fluid (e.g., steam) were added to the region 154 kerogen, then at least a portion of remaining hydrocarbons in the formation may be produced from the formation in the form of synthesis gas. For region 154 kerogen, the atomic hydrogen to carbon ratio and the atomic oxygen to carbon ratio in the hydrocarbons may significantly decrease as the temperature rises. Hydrocarbons in the formation may be transformed into relatively pure carbon in region 154. Heating region 154 kerogen to still higher temperatures will tend to transform such kerogen into graphite 155.

An objective of this invention is to utilize the heat flux of relatively fresh SNF 111 within a repository in a North American unconventional, sedimentary, oil formation to crack and mobilize the unconventional oil.

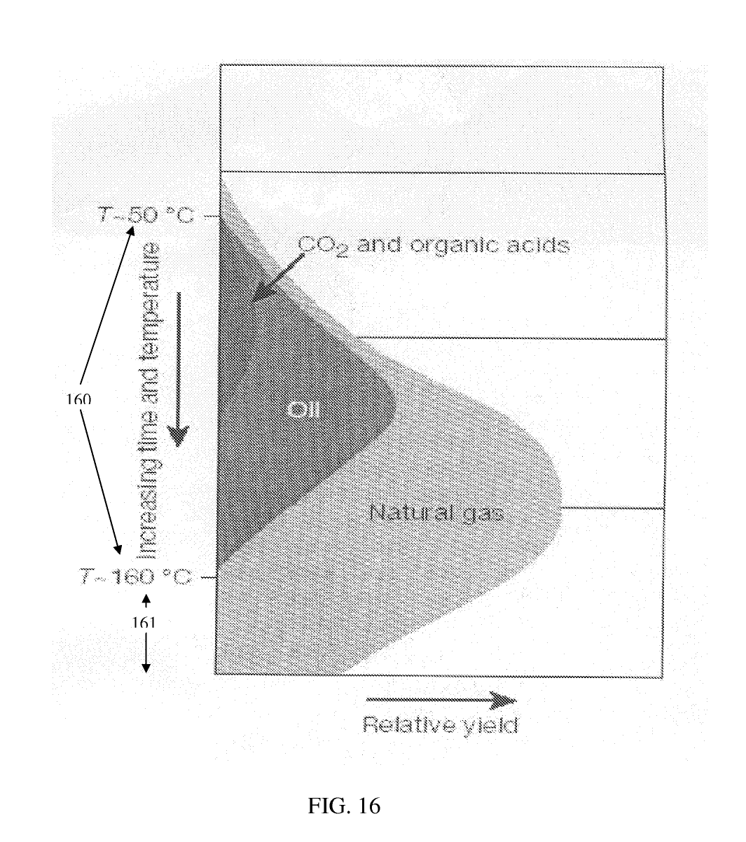

The temperature range in which oil forms is often referred to as the “oil window”. FIG. 16 is a schematic of the oil window 160. Below 50° C. oil remains trapped in the form of kerogen. Above 160° C. 161 oil is converted to natural gas through the process of thermal cracking. Although this temperature range is found at different depths below the surface throughout the world, a typical depth for the oil window is 4-6 km. Sometimes, oil which is formed at extreme depths may migrate and become trapped at much shallower depths than where it was formed. The Athabasca Oil Sands 26 is one example of this. Oil is typically derived from marine (water based) plants and animals, mainly algae that have been gently cooked for at least one million years at a temperature within the oil window.

In keeping with the predictions of chemical-kinetic theory, it is believed oil generation is dependant upon both the temperature to which the kerogen has been heated and the duration of the heating. The two factors are interchangeable: high temperature acting over a short time can have the same effect on maturation as low temperature acting over a longer period. In 1971, Lopatin, in the Soviet Union, described a simple method by which the effects of both time and temperature could be taken into account in calculating the thermal maturity of organic material in sediments. He developed a “Time-Temperature Index” of maturity (TTI) to quantify his method.

Chemical reaction-rate theory states that the rate of a reaction occurring at 90° C. (a reasonable average for oil generation) and having a pseudo-activation energy of 16,400 cal/mol will approximately double with every 10° C. increase in reaction temperature. Lopatin assumed that the rate of maturation followed this doubling rule. Testing of his model and the successful application of Lopatin's method in numerous published examples have confirmed the general validity of this assumption.

To carry out maturity calculations both a time factor and a temperature factor for each temperature interval must be defined. Lopatin defined each time factor simply as the length of time, expressed in millions of years, spent by the rock in each temperature interval.

The temperature factor, in contrast, increases exponentially with increasing temperature. Lopatin chose the 100°-110° C. interval as his base and assigned to it an index value n=0. Index values increase or decrease regularly at higher or lower temperatures intervals, respectively. Because the rate of maturation was assumed to increase by a factor of two for every 10° C. rise in temperature, for any temperature interval the temperature factor (γ) was given by: γ=2ⁿ

The temperature-factor thus reflects the exponential dependence of maturity on temperature.

Multiplying the time factor for any temperature interval by the appropriate temperature-factor for that interval gives a product called the Time-Temperature Index of maturity (TTI). This interval-TTI value represents the maturity acquired by the rock in that temperature interval during the time given. To obtain total maturity, the sum of all the interval-TTI values for the rock is taken.

Maturity always increases; it can never go backward because interval-TTI values are never negative. Furthermore, even if a rock cools down, maturity continues to increase (albeit at a slower rate) because γ is always greater than zero.

Table 5 shows Lopatin's temperature factors. As the table shows kerogen heated to a range between 340° C. and 340° C. will mature 16,777,216 times faster than kerogen at a range between 100° C. and 110° C. which in turn matures 128 times faster than kerogen at a temperature between 30° C. and 40° C.

TABLE 5

| | |
|---|---|
| Temp Interval | Temp Factor |

| | | | |
|---|---|---|---|
| 30 | 40 | ° C. | 1/128 |
| 40 | 50 | ° C. | 1/64 |
| 50 | 60 | ° C. | 1/32 |
| 60 | 70 | ° C. | 1/16 |
| 70 | 80 | ° C. | ⅛ |
| 80 | 90 | ° C. | ¼ |
| 90 | 100 | ° C. | ½ |
| 100 | 110 | ° C. | 1 |
| 110 | 120 | ° C. | 2 |
| 120 | 130 | ° C. | 4 |
| 130 | 140 | ° C. | 8 |
| 140 | 150 | ° C. | 16 |
| 150 | 160 | ° C. | 32 |
| 160 | 170 | ° C. | 64 |
| 170 | 180 | ° C. | 128 |
| 180 | 190 | ° C. | 256 |
| 190 | 200 | ° C. | 512 |
| 200 | 210 | ° C. | 1024 |
| 210 | 220 | ° C. | 2048 |
| 220 | 230 | ° C. | 4096 |
| 230 | 240 | ° C. | 8192 |
| 240 | 250 | ° C. | 16384 |
| 250 | 260 | ° C. | 32768 |
| 260 | 270 | ° C. | 65536 |
| 270 | 280 | ° C. | 131072 |
| 280 | 290 | ° C. | 262144 |
| 290 | 300 | ° C. | 524288 |
| 300 | 310 | ° C. | 1048576 |
| 310 | 320 | ° C. | 2097152 |
| 320 | 330 | ° C. | 4194304 |
| 330 | 340 | ° C. | 8388608 |
| 340 | 350 | ° C. | 16777216 |

At a temperature between 300° C. and 310° C. kerogen can be converted to oil in one year whereas at temperatures between 110° C. and 110° C. it would take the same kerogen 1 million years to go through the so called oil window.

It is an objective of the current invention to use the no carbon emitting heat of HLW 112 to accelerate the production of oil from immature kerogen. The temperature of HLW 112 emplaced in a kerogen containing unconventional oil formation 122 will be dependant on the areal mass loading, lineal mass loading, spent fuel age and waste package spacing and sequencing of the waste within the repository or borehole 110. In all embodiments of this invention the initial temperature of the waste will be in excess of 300° C. and an area surrounding the waste will initially be heated to at least 200° C. The maturation of the heated kerogen will thus be increased by no less a factor than 1000.

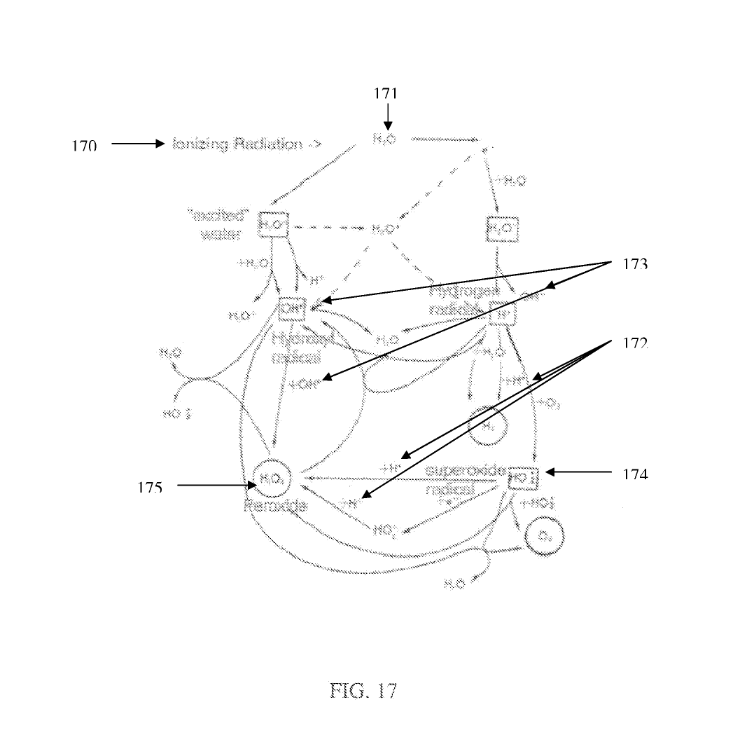

FIG. 17 is a schematic of the radiolysis of water. Ionizing radiation 170 such as is produced by HLW 112 induces high-energy radiolysis of H₂O 171 water molecules into H⁺ 172 and OH⁻ 173 radicals, which are themselves chemically reactive. These in turn may recombine to produce a variety of highly reactive radicals such as superoxide (HO₂) 174 and peroxide (H₂O₂) 175, which are highly oxidizing and can detrimentally react with spent fuel bundles and their containers increasing the possibility of migration of radionuclides beyond the confines of a repository.

As explained above all kerogens become increasingly aromatic and depleted in hydrogen and oxygen during thermal maturation. In the late stages of maturity, Types I, II, and III kerogens are very similar chemically, possessing essentially no remaining hydrocarbon generative capacity. The addition of H⁺ 172 and OH⁻ 173 radicals to a kerogen formation increases the hydrocarbon generative capacity of the formation and the combination of these free radicals with kerogen reduces their capacity to react with fuel bundles and their containers.

As explained above hydrogen present in the formation may inhibit reaction of hydrocarbon fragments by transforming the hydrocarbon fragments into relatively short chain hydrocarbon fluids. The hydrocarbon fluids may enter a vapor phase. Vapor phase hydrocarbons may move relatively easily through the formation to production wells. Increase in the hydrocarbon fluids in the vapor phase may significantly reduce a potential for producing less desirable products within the selected section of the formation.

A lack of bound and free hydrogen in the formation may negatively affect the amount and quality of fluids that can be produced from the formation.

All formations contained a certain percentage of water in situ. In the case of an oil shale formation the percentage of water in the formation may be as high as fifty percent.

A formation will be substantially shielded from the ionizing radiation of HLW 112 emplaced within it by the drift liner 101 of the repository 100 and/or the canister inserted in a borehole 110 within the formation. In view of the proximity of the HLW 112 to the formation and the extended exposure of the formation to whatever radiation is not absorbed by the drift liner 101 or canister it can be assumed some ionizing radiation 170 will reach the formation and in turn will react with the in situ water to produce H⁺ 172 and OH⁻ 173 radicals. In view of the volume of both the water in formations and the HLW 112 to which it would be exposed, the amount of radicals that will be made available to positively affect the amount and quality of fluids that can be produced from the formation will be significant.

It is an objective of the current invention to use the radiolysis of water induced by the ionizing radiation 170 of HLW 112 to increase the availability of hydrogen within an unconventional oil formation 122 and thus the capacity of a portion of the formation to produce quality fluids.

Kerogen is a mixture of organic material, rather than a specific chemical; it cannot be given a chemical formula. Its chemical composition can vary distinctively from sample to sample. Kerogen from the Green River Formation oil shale contains elements in the proportions C 215: H 330: O 12: N 5: S 1.

Hydrocarbons are composed of methane which has a single carbon atom, wet gas which has between 2 and 4 carbon atoms, light oil which has 5 to 14 carbon atoms and normal oil which is greater than 15 carbon atoms. At the heavier end of the range, paraffin wax is an alkane with approximately 25 carbon atoms, while asphalt has 35.

Cracking is the process whereby complex organic molecules such as kerogens or heavy hydrocarbons are broken down into simpler molecules (e.g. light hydrocarbons) by the breaking of carbon-carbon bonds in the precursors.

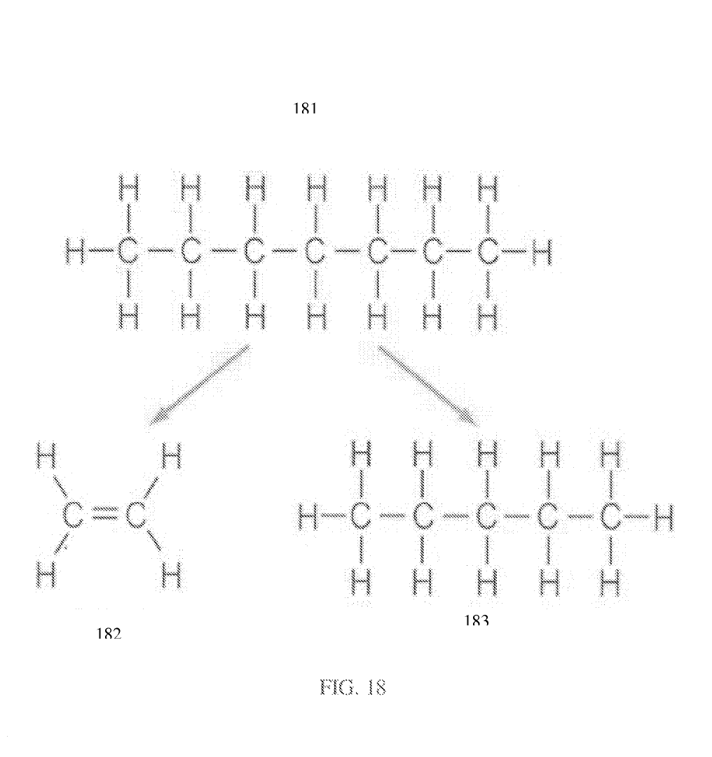

FIG. 18 depicts the cracking of a long chain molecule 181 of heptane (C₇H₁₆) into short chain molecules of ethylene (C₂H4) 182 and pentane (C₅H₁₂) 183.

Normally cracking is done under high pressures and temperatures, often in the presence of a catalyst.

A number of patents have been issued, including WO 1998004653 19980205, which relate to methods of treating heavy hydrocarbon raw material, particularly heavy fractions of crude oil, in which heavy hydrocarbon raw material is exposed to ionizing radiation 170 to liberate lighter hydro carbon fractions.

It is an objective of the current invention to expose kerogen, in situ, to some portion of the ionizing radiation 170 of HLW 112 inserted in the formation in order to liberate a portion of the light hydro carbon fractions contained in said kerogen.

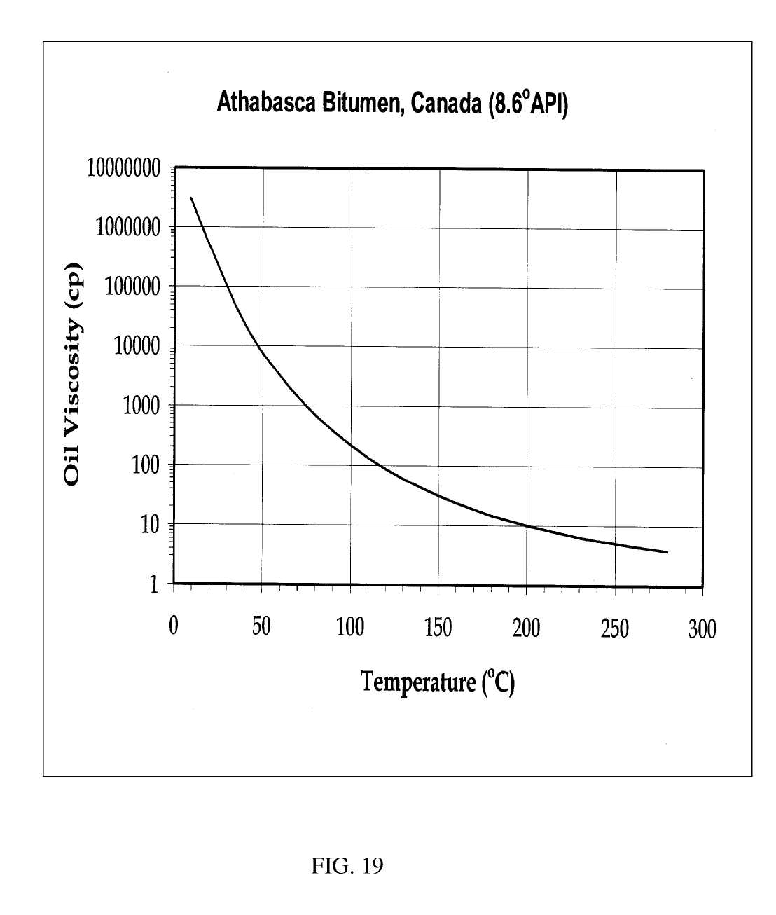

The major challenge of recovering bitumen or heavy oil from depth is to overcome its high viscosity to allow it to flow to a wellbore. The process of heating heavy oils and bitumen to reduce their viscosity is well known in the petroleum industry and does not form a part of this inventive concept. FIG. 19 is a plot of the oil viscosity in centipoise (cp) versus temperature for Athabasca Bitumen, Canada (8.6° API). The poise is the unit of dynamic viscosity in the centimeter gram second system of units. The poise is often used with the metric prefix centi-. Water has a viscosity of 1 centipoise at 20° C. while tomato paste or peanut butter has a viscosity of between 150,000-250,000 cp which is in the range of Athabasca Bitumen at 10° C. FIG. 19 shows that the viscosity of Athabasca Bitumen approaches the viscosity of water when its temperature is increased to 270° C.

It is one objective of this invention to use the heat of SNF 111 inserted in a bitumen or heavy oil formation to raise the temperature of the oil sufficiently to allow the immobile bitumen or heavy oil to flow to a producing wellbore. The advantage of this method is that the heat required to produce the heavy oil or bitumen is produced without generating the GHG CO₂. In the current art this heat is a liability and considerable costs are foreseen to mitigate this heat, such as with forced air convection for 90 years at Yucca Mountain.

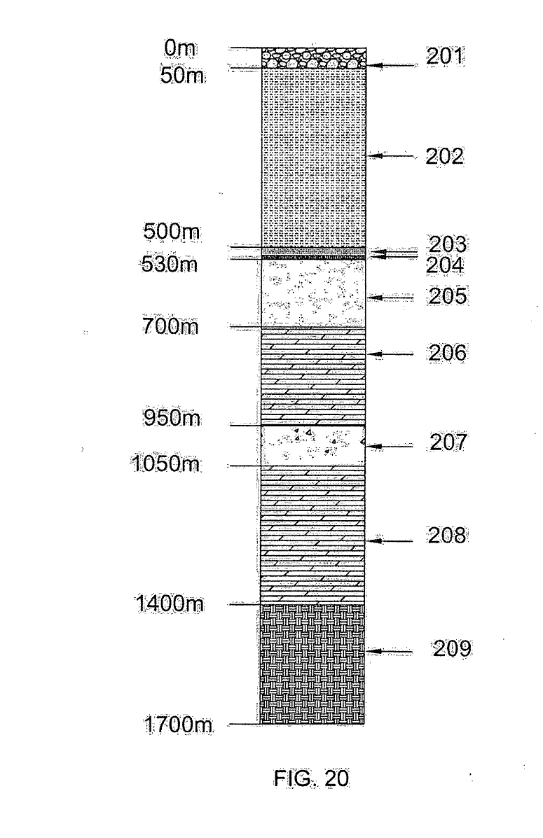

FIG. 20 shows a schematic cross-section of the heavy oil formation that straddles the border of Alberta 20 and Saskatchewan in the Lloydminster region.

The upper 50 m consists of glacial till 201, which are boulders, rocks and gravel distributed by glaciers. Beneath the till is 450 m of Cretaceous shale 202 covering a thin coal 203 and shale layer 204, covering unconsolidated sand and sandstone of the Mannville Group 205, which extends from 530 m to 700 m. The Mannville Group 205 is composed of 5-18 m thick blanket sands and many channel sands, as thick as 35 m in some areas along the axis of old river channels, which may run 30-40 km long. These sands are the oil-bearing regions of the Mannville Group 205, which are interspersed with shale and barren sand. Beneath the Mannville Group 205 are 250 m of limestone, dolomites and evaporates (the Upper Devonian layer 206), a further 100 m of prairie evaporates 207, which are gypsum and potash overlaying another 350 m limestone/dolomite/evaporate layer (the Lower Devonian layer 208), which overlays the Pre-Cambrian basement 209.

Lloydminster Heavy Oils 29 are considerably lighter in density (11-18° API gravity) and of much lower viscosity as compared to the major Alberta 20 oil sands deposits trending north and west from Lloydminster, therefore they are easier to produce and have been the focus of much recent heavy oil production activity.

Shales, as seals, play an important role controlling the migration and accumulation of petroleum and metallic mineral rich fluids in sedimentary basins. Shales behave as seals because of their unusual petrophysical properties, represented by extremely low permeabilities (3 to 10 orders of magnitude smaller than that of sandstones).

As explained above with reference to FIG. 6, the permeability of thick shale layers 204 can conservatively be assumed to be about 10⁻⁶ m d⁻¹. It would take therefore 1,232,876 years (450*(1/(0.000001/365 days))) for water, migrating from the Mannville Group 205 under the hydrothermal influence of nuclear waste placed in the Mannville Group 205, to reach the surface. Considering the decay heat of SNF 111 is mostly dissipated after 10,000 years it is unlikely water in the vicinity of a repository 100 in the Mannville Group 205 would ever permeate the overlaying Cretaceous shale 202 or transport radionuclides through this shale.

The temperature of Lloydminster Heavy Oils 29 is less than 22° C. It needs to be close to 30° C. higher to reach the lower limit of the oil window in order to complete the kerogen maturation process. Assuming a geothermal gradient of approximately 1.8° C. per 100 m it would be necessary to increase the depth of the Mannville Group 205 by another 1,666 meters to increase the subsurface temperature 30° C. Given the current net disposition rate of 1 cm per 100 years, this will take approximately 16 million years. At the minimum temperatures at this level it would take approximately 100 million years for a process of cracking the complex carbon bonds in heavy oil molecules to take place.

Lloydminster's “heavy oil problem” could be solved in 100 million years by “letting nature take its course” or, as is the objective of one embodiment of the current invention, the alternative is to speed up the process of heavy oil maturation by introducing the waste heat of SNF 111 into a repository 100 placed within the Manneville Group 205.

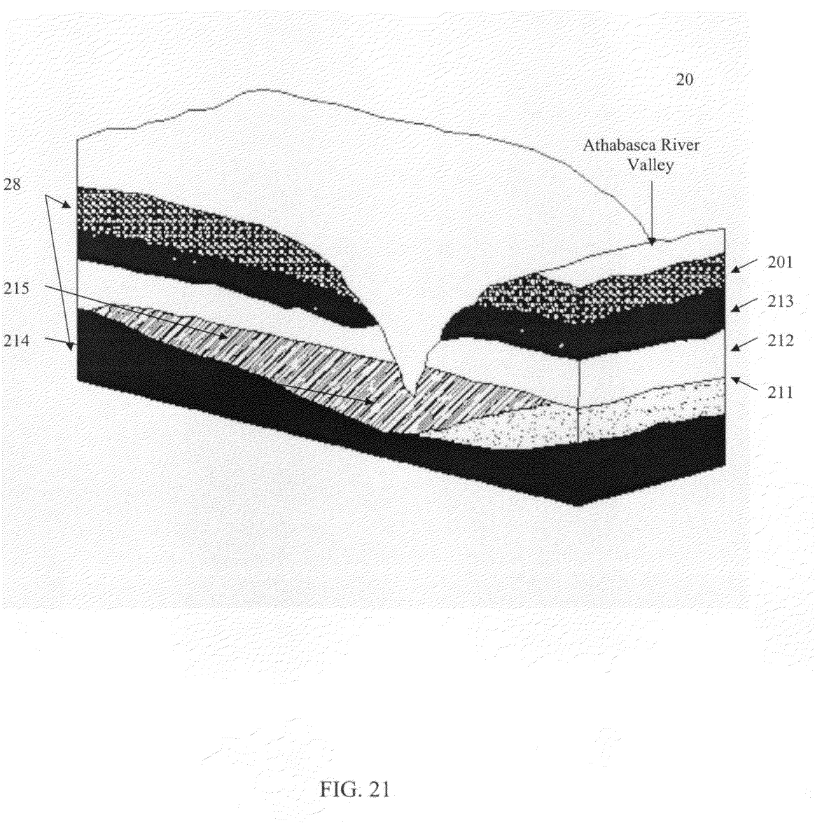

FIG. 21 is a schematic cross-section of the oil sands of Alberta 20. The Clearwater Formation 211 is the main oil reservoir of a roughly, circular region centered about 20 km north of Bonnyville, Alberta 20. It is estimated the Cold Lake Oil Sands 28 contain in excess of 60×10⁹ m³ oil in sedimentary arenaceous deposits that are classified as deltaic deposits. Cold Lake bitumen is highly viscous but considerably less so than the Athabasca Oil Sands 26 and also less sulphurous. The Clearwater Formation 211 lays between the depths of 400 m to 600 m. The thickness of the oil-saturated material varies from 15-20 m to in excess of 35 m. In the southern part of the Cold Lake Oil Sands 28 deposit, the overlying Grand Rapids Formation 212 can be an important oil bearing reservoir. The Grand Rapids Formation 212 and the Clearwater Formation 211 are both overlain by a thick layer of Colorado Group Shales 213. There are up to 180 m of Colorado Group Shales 213, which acts as a high-quality reservoir seal, capping bitumen and gas in the underlying formation. The effectiveness of the Colorado Group Shale 213 as a seal is demonstrated by the presence of many natural gas pools in the upper portions of the Grand Rapids Formation 212 within the region. This shale would also seal water and radionuclides escaping from a repository 100 in the Grand Rapids or Clearwater Formations 211 thus they would not likely ever reach the biosphere.

The Athabasca Oil Sands 26 contain in excess of 150×10⁹ m³ is the largest of Alberta 20's oil sand deposits. The bitumen is highly viscous and is often of a specific gravity greater than water (API gravity less than 10°). The sand lies at burial depths between 0 m to 600 m. The reservoir is exclusively in the McMurray Formation 214, and is up to 80-85 m in thickness in some areas. The Clearwater Formation 211 overlies the McMurray Formation 214. The Clearwater shale 211 acts as a seal on the McMurray formation 214 estuarine sands, which contain the hydrocarbons. A specific minimum thickness of the Clearwater shale 211 is required in order to facilitate steam injection to produce oil to ensure the containment of steam and heat within a steam chamber. The same containment feature that permits SAGD recovery is conducive to safe nuclear waste disposal at the same depth. As portions of the Athabasca Oil Sands 26 are produced using the SAGD method the same areas would be amenable to a HLW repository. The thicker the capping formation the safer a nuclear waste repository 100 would be thus the Cold Lake Oil Sands 28 would afford the best geologic setting for the implementation of an embodiment of this invention which would produce Alberta 20 oil sands.

The Wabasca Oil Sands 26 or (Wabiskaw) Oil Sands are estimated to contain in excess of 15××10⁹ m³ oil in sandstone deposits classified as barrier bar and beach glauconitic sands. The deposit lies above the western part of the Athabasca Oil Sands 26 and extends westwards somewhat beyond the McMurray Formation edge. In many regions the Wabasca 215 is oil rich and overlies the McMurray Formation forming two stacked reservoirs. The bitumen is highly viscous and is at a depth of 100 to 700 meters. The Wabasca 215 is classified as the lowest Member of the Clearwater Formation 211 and therefore overlies the McMurray Formation. The reservoir and the thickness of oil-saturated material vary from 0 to 10 meters and the overlying argillaceous part of the Clearwater Formation 211 forms a cap.

The Peace River Oil Sands 24 contain in excess of 30××10⁹ m³ oil at a depth of between 500 m to 700 m. The Peace River Oil Sands 24 have been produced using the SAGD method and thus could also be produced using an embodiment of the current invention.

The technology for producing hydrocarbons from oil sands by the SAGD method is well known in the industry and does not form a part of this inventive concept. It is the objective of one embodiment of this invention to replace the steam chamber and the cost of generating said steam from both an economic and environmental stand point by the waste heat of SNF 111 placed in either a horizontal repository 100 or a series of vertical boreholes 110 within the oil bearing reservoirs of one of Alberta's Oil Sands formations.

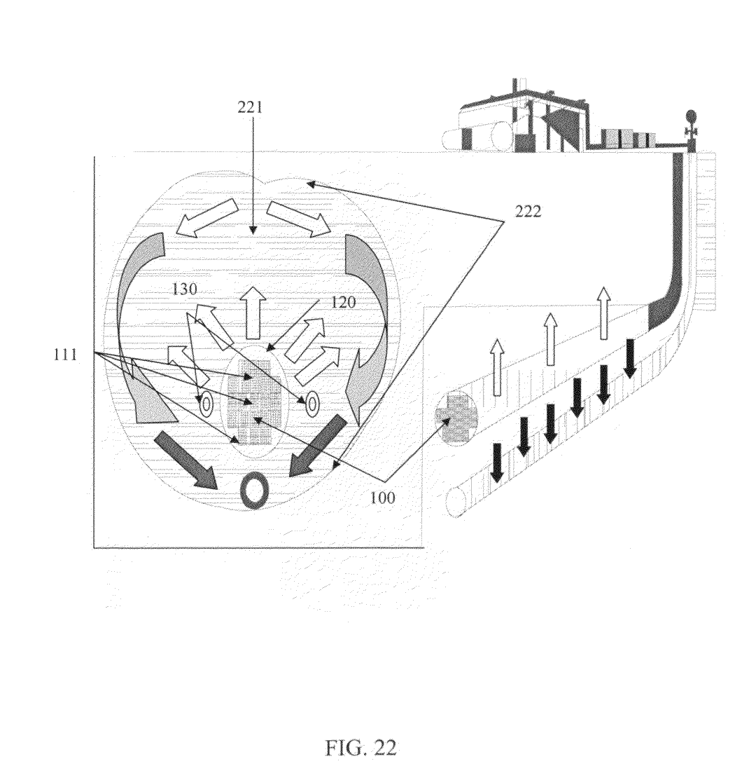

FIG. 22 depicts a Nuclear Assisted Gravity Drainage (NAGD) chamber 221 according to a one embodiment of the present invention.

Much of the current understanding of repository-heat-driven hydrothermal flow in a repository 100 is based on observations made during heater tests in a tunnel at Yucca Mountain and associated modeling studies. One of the observations of these studies is a region above a heater dries out more slowly than the region below the heater because vapor flow in fractures tends to be radially away from the heat source 120 and condensate drainage is vertically downward. Successive refluxing cycles in fractures eventually result in condensate being shed off the top and down the sides of a boiling zone FIG. 22. This “hydrothermal umbrella” effect, is the same principle employed in the SAGD method. Low-pressure steam injected into an upper wellbore produces a “steam chamber” that grows vertically and horizontally in the formation. The heat from the steam reduces the viscosity of the heavy crude oil or bitumen and allows it to flow down the margins of the steam chamber into a lower wellbore in a countercurrent, gravity driven drainage pattern similar to the “hydrothermal umbrella” effect observed in the Yucca Mountain studies.

The Alberta Oil Sands contain viscous bitumen, in an amount, which ranges from about 5 to about 20 percent by weight. Bitumen is usually immobile at typical reservoir temperatures. For example, in the Cold Lake region of Alberta 20, at a typical reservoir temperature of about 13° C., bitumen is immobile with a viscosity exceeding several thousand poises. However, at higher temperatures, such as temperatures exceeding 93° C., the bitumen generally becomes mobile with a viscosity of less than 345 centipoises.

The gravity drainage process is very slow so it is preferable to have as large a heat chamber as possible. “Chamber area 222” means the outer surface boundary of the portion of the formation heated by a nuclear waste repository. In practice SAGD well pairs drilled horizontal, parallel and vertically aligned are on the order of 1 kilometer in length and the injector wells are 5 m above the producing well. The steam chamber may expand to 30 m high by 15 m wide or larger providing a chamber area of over a hundred thousands m³. Even with viscous oil sands material such as that at Cold Lake current methods can produce total drainage rates measured in hundreds of barrels per day.

High temperature operating modes for Yucca Mountain envisage a total drift length of 60 km for the legislated maximum capacity of 70,000 MTIHM. The total global inventory of spent fuel was estimated in 2005 at 180,000 MTIHM and is estimated to increase by 10,500 MTIHM/year. The heat chamber surrounding a repository 100 would constantly expand for at least the next 10,000 years thus the NAGD embodiment of this invention has the potential to produce thousands of barrels of oil per day.

The object of the current invention is to recover bitumen from oil sands deposits that cannot be surface mined economically but are not deep enough for high-pressure steam techniques to work.

Only five per cent of Alberta's oil sands can be recovered through surface mining. Other in situ extraction techniques recover around another 15 per cent. The development of SAGD it is estimated has potentially doubled the economic viability of oil sands reserves. The prospect of the amount of CO₂ that would be produced to recover these reserves however places environmental sustainability of this recovery method in doubt.

About one third of the world's oil sands reserves are in Venezuela, one third in Canada 22 and the rest mainly in the Middle East. As one of the objectives of this invention is to keep the plutonium contained in SNF 111 out of the hands of potential terrorists or proliferators, it is not likely Venezuela or the Middle East would be seen as politically acceptable locations for the implementation of this invention. Canada 22 on the other hand has long had both the technical capability and resources to develop a nuclear weapon but has chosen not to do so. Canada 22 is widely seen as a safe and responsible country in which the global inventory of SNF 111 could be safely stored and excess stocks of WGP 130 could be rendered irretrievable.

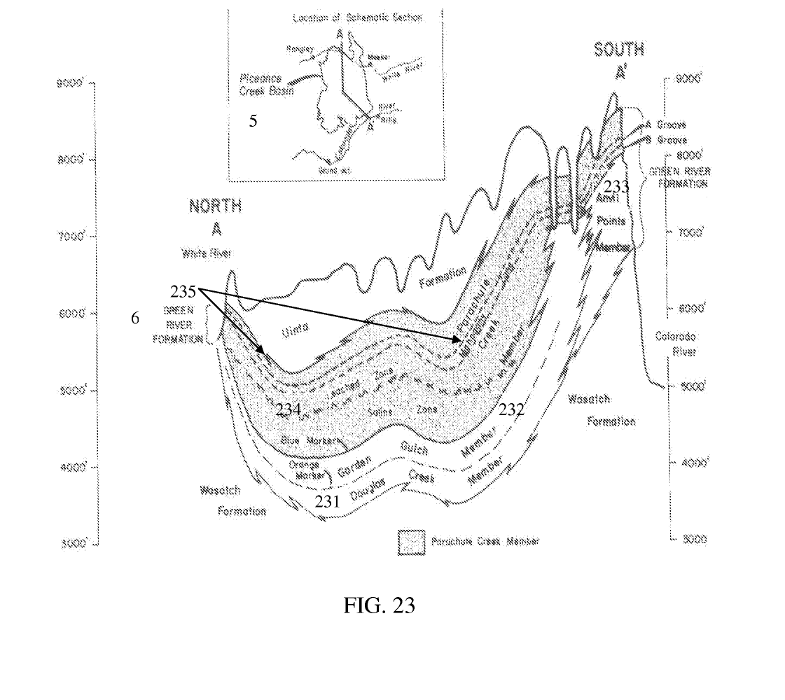

FIG. 23 shows a schematic cross-section of the Green River Oil Shale Formation 6 in the central portion of the Piceance Creek Basin 5 in Colorado. The Green River Formation 6 is divided into members: Douglas Creek 231, Garden Gulch 232, Anvil Points 233 and Parachute Creek 234. The Parachute Creek Member 234 contains the greatest amount of oil shale and it has been further divided into zones. The richest of these is the Mahogany Zone 235.

The technology for producing formation fluids from an oil shale formation is well known in the petroleum industry and does not form part of this inventive concept. The present invention exploits the heat generated by the decay heat of HLW 112 inserted in boreholes 110 in an oil shale formation to alter the chemical and/or physical properties of the kerogen in formation to recover formation fluids at a production well. Said formation fluids are recovered without producing greenhouse gases to produce the energy required to mature the kerogen in said formation. Said energy is obtain at minimal costs and in the performance of a needed socioeconomic service; disposing of a dangerous waste product of the nuclear power industry. Said waste being an impediment to the increased use of nuclear power, which is a potential offset or replacement for current offshore U.S. energy supplies.

One major question with respect to the production of the Green River Oil Shale Formation 6 is the extent to which in situ water resources would be impacted. A 1989 study performed under contract No.: DE-AI21-88MC25200 to DOE was conducted on the oil shale in the Tipton Shale Member of the Green River Formation 6 composed of interbedded shale, oil shale, and tuff with discontinuous beds of sandstone, marlstone, and siltstone. Said study determined hydraulic conductivity was small and that little water moved through the unfractured shale.

Two potential pathways by which contaminated water in an oil shale formation might move from a production site were investigated: (1) vertical flow, consisting of interformational leakage downward into the underlying aquifer; and (2) lateral flow through tuff beds, bedding planes, and fractures in the shale, or through a sandy layer at the top of the Tipton aquifer, to discharge to nearby Bitter Creek.

The investigation detected no organic contaminants in water-quality samples from either Bitter Creek or the Wasatch confining unit. The pathways by which contaminated water in the oil shale formation might move from a production site would be the same pathways by which radionuclides might escape boreholes 110 at the production site and return to the biosphere. A lack of organic contaminants is a good indication that radionuclides are not likely to escape the formation either.

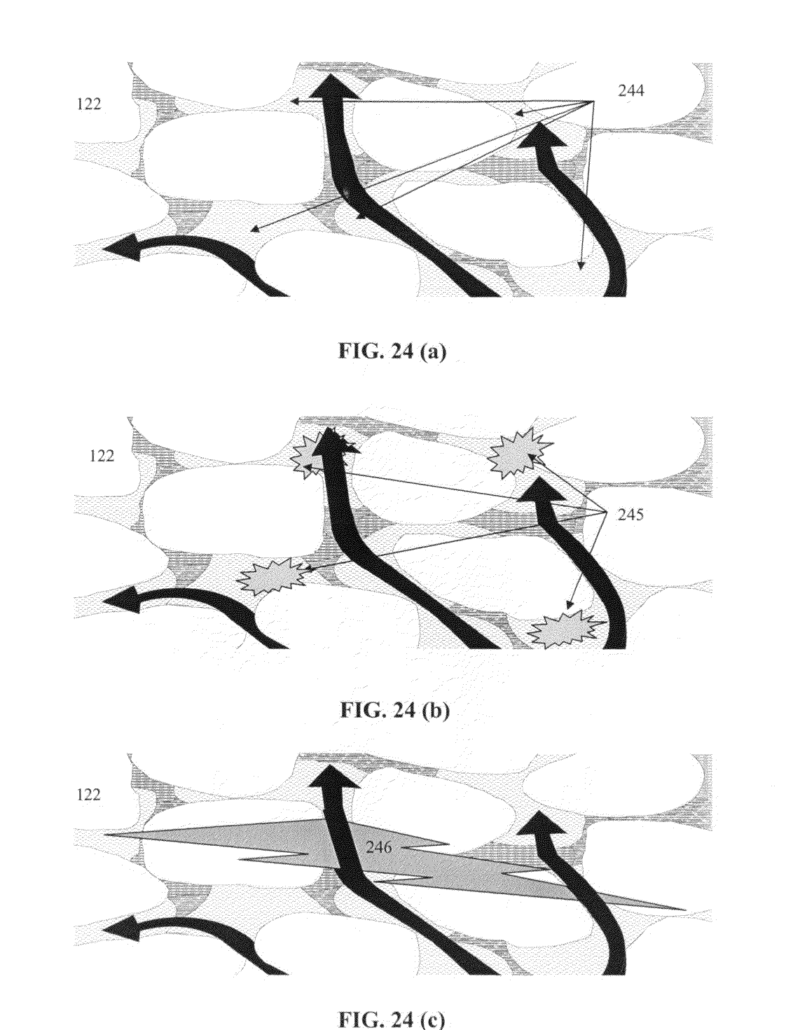

FIGS. 24(a) (b) and (c) depicts the stages of heat fracturing of an unconventional oil formation 122. In order to recover hydrocarbons the formation in which the hydrocarbons are found must be permeable. The pores 244 of the rock must be connected together so that hydrocarbons can move from one pore to another. Unless hydrocarbons can move and flow from pore to pore, the hydrocarbons remains locked in place and cannot flow into a well.

Just as impermeable rock prevents hydrothermal circulation it will also prevent produced oil from migrating from an area near a nuclear waste heat source 120 to a producing well. An objective of this invention is to use the heat flux of a nuclear waste repository 100 to fracture a portion of the unconventional oil formation 122 to facilitate the flow of synthesized oil; altered by viscosity change, radiolysis, hydrocracking and/or pyrolysis to a collecting wellbore.

The heat of the nuclear waste will vaporize fluids 245 in the rock pores 244 increasing the pore pressure, which in turn may fracture 246 portions of the formation.

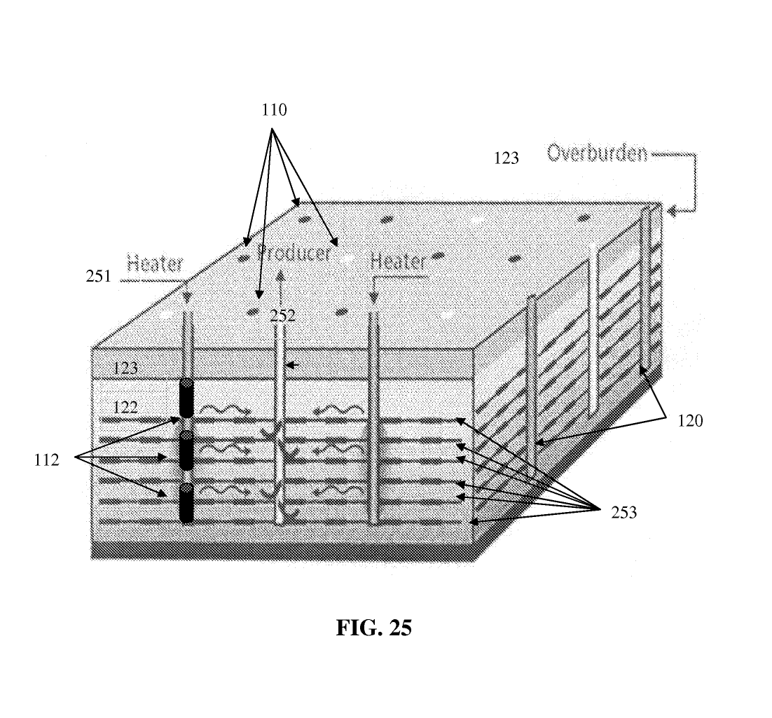

Oil shale usually displays laminations parallel to the bedding plane 253 in FIG. 25. The pores 244 in shale are so small and the pore throats so restricted that effectively the porosity is zero. The heat flux of SNF 111 placed in an oil shale formation may fracture the formation to increase the permeability of the formation. The increased permeability may allow formation fluid to travel to a production well where the fluid is removed from the oil shale formation. Fracturing the oil shale deposit may create voids occupying between 20 and 25% of the formation. The voids improve the flow of gases and fluids through the rock, thereby increasing the volume and quality of the oil produced.

In the NAGD embodiment of the current invention it would also be advantageous to fracture the heavy oil formation between the horizontal repository 100 and the producing well to assist in establishing thermal communication between the repository 100 and the production well.

The technology for in situ conversion of oil shale to hydrocarbons is well known in the industry and does not form part of this inventive concept. According to an embodiment of the present invention the non-GHG emitting, waste heat of HLW 112 is used to raise a portion of an oil shale formation to a pyrolysis temperature. The temperature of the waste inserted in substantially vertical boreholes 110 drives produced hydrocarbons to a producing well where it is recovered. FIG. 25 depicts a schematic of an oil shale pattern of boreholes 110 according to the current art. Various arrangements of heating wells 251 and producing wells 252 have been considered in the current art. In some embodiments, the array of heat sources 120 can be positioned substantially equidistant from a production well. Certain patterns (e.g., triangular arrays, hexagonal arrays, or other array patterns) may be more desirable for specific applications. In addition, the array of heat sources 120 may be disposed such that a distance between each heat source 120 may be less than about 70 feet (21 m). In addition, the in situ conversion process for hydrocarbons may include heating at least a portion of unconventional oil formation 122 lying beneath an overburden 123 with heat sources 120 disposed substantially parallel to a boundary of the hydrocarbons. Regardless of the arrangement of or distance between the heat sources 120, in certain embodiments, a ratio of heat sources 120 to production wells disposed within a formation may be greater than about 3, 5, 8, 10, 20, or more.

In certain embodiments of the current art insulated conductor heaters may be designed to operate at about 760° C. and dissipate about 820 watts/meter along the depth of the heater well. As explained above a PWR fuel assembly generates about 156 watts along each meter of its length so in order to generate a 760° C. temperatures utilizing a PWR fuel assembly heat source 120 it would be necessary to increase the ratio of heater to producer wells by a factor of 5.25 (820/156) or wait 5.25 times as long for the formation to attain the desired temperature.

In the current art, a pyrolysis temperature is attained in the oil shale formation after about 3 years of heating with insulated conductor heaters. As the estimated 800 billion barrels of recoverable oil from the Green River Formation 6 is anticipated to last 400 years, 15 years is not an unreasonable interval to wait to start full production of the formation. In the interim a portion of the unconventional oil formation 122 may be produced either with a denser configuration of heat supplying nuclear waste or by supplementing the heat generated by PWR fuel assemblies with other heat sources 120 such as insulated conductor heaters.

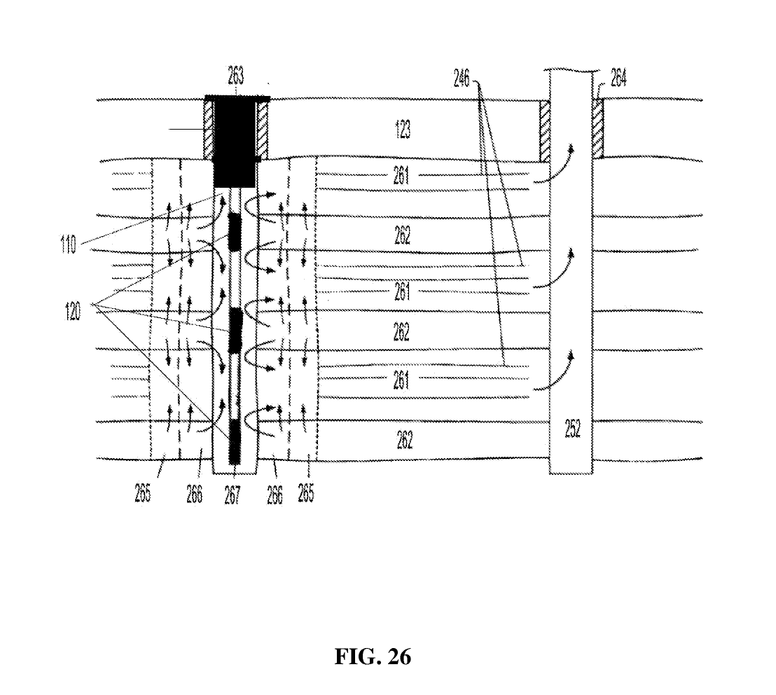

FIG. 26 depicts a cross-sectional representation of an embodiment for treating lean zones 261 and rich zones 262 of a formation. Lean zones 261 and rich zones 262 are below overburden 123. In some embodiments, lean zones 261 may be relatively permeable sections of the formation. For example, lean zones 261 may have an average permeability thickness product of greater than about 100 millidarcy feet. In certain embodiments, lean zones 261 may have an average permeability thickness product of greater than about 1000 millidarcy feet or greater than about 5000 millidarcy feet. Rich zones 262 may be sections of the formation that are selected for treatment based on a richness of the section. Rich zones 262 may have an initial average permeability thickness product of less than about 10 millidarcy feet. Certain rich zones 262 may have an initial average permeability thickness product of less than about 1 millidarcy feet or less than about 0.5 millidarcy feet.

Heat source 120 may be placed through overburden 123 and into the borehole 110 and borehole 110 is sealed with an impermeable seal 263. Heat source 120 may apply heat to lean zones 261 and/or rich zones 262.

In certain embodiments, rich zones 262 may not fracture. For example, the rich zones 262 may have a ductility that is high enough to inhibit the formation of fractures. A formation (e.g., an oil shale formation) may have one or more lean zones 261 and one or more rich zones 262 that are layered throughout the formation as shown in FIG. 26. Formation fluids formed in rich zones 262 may be produced through pre-existing fractures in lean zone 261. In some embodiments, lean zone 261 may have a permeability sufficiently high to allow production of fluids. This high permeability may be initially present in the lean zone because of, for example, water flow through the lean zone that leached out minerals over geological time prior to initiation of the in situ conversion process. In some embodiments, the application of heat to the formation from heat sources 120 may produce, or increase the size of, fractures 246 and/or increase the permeability in lean zones 261. Fractures 246 may increase the permeability of lean zones 261 by providing a pathway for fluids to propagate through the lean zones.

During early times of heating, permeability may be created near the borehole 110. Permeability may be created in permeable zone 265 adjacent the borehole 110. Permeable zone 265 will increase in size and move out radially as the heat front produced by heat source 120 moves outward. As the heat front migrates through the formation, hydrocarbons may be pyrolyzed as temperatures within rich zones 262 reach pyrolysis temperatures. Pyrolyzation of the hydrocarbons, along with heating of the rich zones 262, may increase the permeability of rich zones 262. At later times of heating, hydrocarbons in coking portion 266 of permeable zone 265 may coke as temperatures within this portion increase to coking temperatures. At some point permeable zone 265 will move outward to a distance from the borehole 110 at which no coking of hydrocarbons occurs (i.e., a distance at which temperatures do not approach coking temperatures). Permeable zone 265 may continue to expand with the migration of the heat front through the formation. If sufficient water is present, coking may be suppressed near the borehole 110.

In certain embodiments, fluids formed in rich zones 262 may flow into lean zones 261 through permeable zone 265. Coking portion 266 may inhibit the flow of fluids between rich zones 262 and lean zones 261. Fluids may continue to flow into lean zones 261 through un-coked portions of permeable zone 265. In some embodiments, fluids may flow to the borehole 110 (e.g., during early times of heating before permeable zone 265 has sufficient permeability for fluid flow into the lean zones). Fluids that flow to the borehole 110 may be allowed to flow through lean zones 261 to production well 252. In addition, during early times of heating, some coke formation may occur near the borehole 110.

Allowing formation fluids to be produced through lean zones 261 may allow for earlier production of fluids formed in rich zones 262. For example, fluids formed in rich zones 261 may be produced through lean zones 261 before sufficient permeability has been created in the rich zones 262 for fluids to flow directly within the rich zones 262 to production well 252. Producing at least some fluids through lean zone 261 may inhibit a buildup of pressure within the formation during heating of the formation.

In certain embodiments, fractures 246 may propagate in a horizontal direction. However, fractures 246 may propagate in other directions depending on, for example, a depth of the fracturing layer and structure of the fracturing layer. As an example, oil shale formations in the Piceance basin in Colorado that are deeper than about 125 m below the surface tend to have fractures 246 that propagate at an angle or vertically. In certain embodiments, the creation of angled or vertical fractures 246 may be inhibited to inhibit fracturing into an aquifer or other environmentally sensitive area.

In some embodiments, applying heat to rich zones 262 may create fractures 246 within the rich zones. Fractures 246 within rich zone 262 may be less likely to initially occur due to the more ductile (less brittle) composition of the rich zone as compared to lean zones 261. In an embodiment, fractures 246 may develop that connect lean zones 261 and rich zones 262. These fractures 246 may provide a path for propagation of fluids from one zone to the other zone.

Production well 252 may be placed at an angle, vertically, or horizontally into lean zones 261 and rich zones 262. Reinforcing material 264 (e.g., cement) may seal a portion of the production well 252 to overburden 123. Production well 252 may produce formation fluids from lean zones 261 and/or rich zones 262.

In some embodiments, more than one production well may be placed in lean zones 261 and/or rich zones 262. A number of production wells may be determined by, for example, a desired product quality of the produced fluids, a desired production rate, a desired weight percentage of a component in the produced fluids, etc.

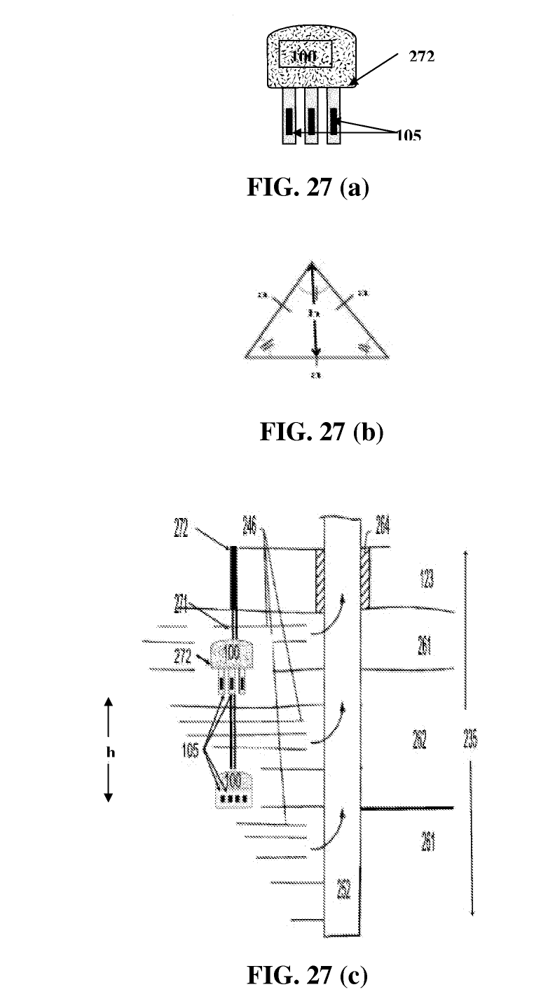

FIGS. 27(a) (b) and (c) depict the treatment of an oil shale formation using one or more horizontal repositories 100 accessed from the surface by means of a vertical shaft 271. Said vertical shaft 271 will be sealed by an impermeable seal 272 once high-level radioactive waste has been located in said SNF repository 100. FIG. 10 shows a horizontal SNF repository 100 in which CSNF 105, DSNF 106, and HLW waste packages 107 are placed within the drift. Numerous other repository 100 configurations have been considered including placement of heat producing waste in the floor 272 of the repository 100 as depicted in FIG. 27(a).

As explained above the typical CSNF package 105 will have a length of 5.7 m and a thermal load of 11.8 kW. It will produce therefore about (11,800 Kw/5.7 m) or 2070 watts per meter of its length as compared with the 820 watts/meter produced by the heaters in U.S. Pat. No. 7,225,866 to Berchenko, et al. Said U.S. Pat. No. 7,225,866 proposes the array of heat sources 120 generating said 820 watts/meter may be disposed such that a distance between each heat source 120 may be less than about 21 m.

In an embodiment of the current invention in which a series of horizontal repositories 100 are used to produce an oil shale formation, CSNF waste packages 105 would need to be spaced about 53 m ((2070 w/820 w)*21 m) to attain the same heat flux between the heaters. The formula for determining the altitude of an equilateral triangle is:

$$h = a sin {60}^{°} = \frac{1}{2} \sqrt{3} a ,$$

where a is the side length. The height (h) of an equilateral triangle of a side 53 m, as shown in FIG. 27(b), is (½*1.73205081*53 m) or 45.89 m. This would be the required drift spacing to maintain an equidistant CSNF packages 105 spacing of 53 m.

In FIG. 26 is depicted the treatment of lean 261 and rich zones 262 of an oil shale formation in which a heat source 120 may be applied either to the lean zones 261 and/or the rich zones 262 of the formation. According to the current invention in which an oil shale formation is treated with a horizontal repository 100, said repository 100 may be established either within the lean zone 261 and/or the rich zone 262 as shown in FIG. 27(c). A repository 100 may also be established in a lean zone with the heat producing CSNF waste packages 105 in the floor of the repository 100 extending into the rich zone 262.

As shown in FIG. 23, the richest zone of the Piceance Creek Basin 5 is the Mahogany Zone 235, which reaches a thickness in excess of 60 m and averages fifty-five gallons of crude shale oil per ton of rock. In order to produce this thickness of shale it may be necessary to have two tiers of drifts within a rich zone of a thickness over 53 m in order to maintain a vertical spacing of roughly 53 m between CSNF waste packages 105. This may also be accomplished by having one row of waste packages extending from the floor of a repository 100 substantially within a lean zone 261 overlaying the Mahogany Zone 235 and a second repository 100 placed within the said rich Mahogany Zone 235 as shown in FIG. 27(c).

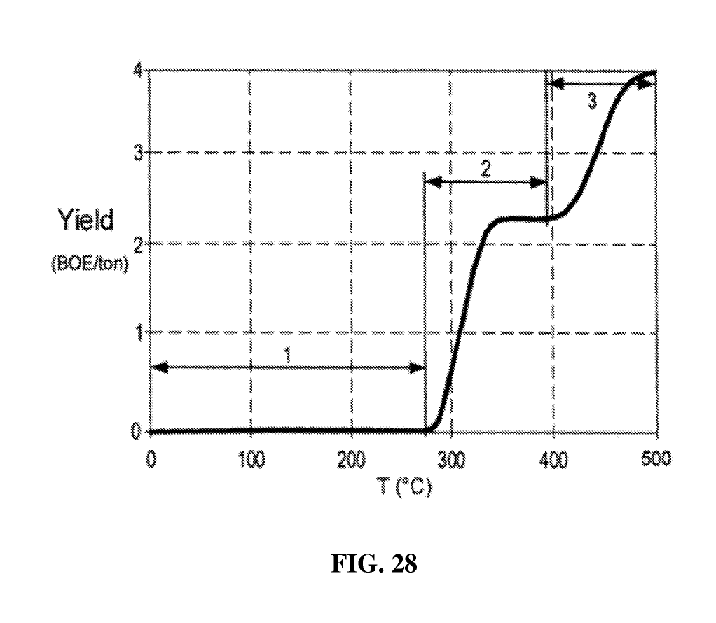

FIG. 28 illustrates several stages of heating an oil shale formation. FIG. 28 also depicts an example of yield (barrels of oil equivalent per ton) (y axis) of formation fluids from an oil shale formation versus temperature (° C.) (x axis) of the formation.

Desorption of methane and vaporization of water occurs during stage 1 heating. Heating of the formation through stage 1 may be performed as quickly as possible. For example, when an oil shale formation is initially heated, hydrocarbons in the formation may desorb adsorbed methane. The desorbed methane may be produced from the formation. If the oil shale formation is heated further, water within the oil shale formation may be vaporized. Water may occupy, in some oil shale formations, between about 10% to about 50% of the pore volume in the formation. In other formations, water may occupy larger or smaller portions of the pore volume. Water typically is vaporized in a formation between about 160° C. and about 285° C. for pressures of about 6 bars absolute to 70 bars absolute. In some embodiments, the vaporized water may produce wettability changes in the formation and/or increase formation pressure. The wettability changes and/or increased pressure may affect pyrolysis reactions or other reactions in the formation. In certain embodiments, the vaporized water may be produced from the formation. In other embodiments, the vaporized water may be used for steam extraction and/or distillation in the formation or outside the formation. Removing the water from and increasing the pore volume in the formation may increase the storage space for hydrocarbons within the pore volume.

After stage 1 heating, the formation may be heated further, such that a temperature within the formation reaches (at least) an initial pyrolyzation temperature (e.g., a temperature at the lower end of the temperature range shown as stage 2). Hydrocarbons within the formation may be pyrolyzed throughout stage 2. A pyrolysis temperature range may vary depending on types of hydrocarbons within the formation. A pyrolysis temperature range may include temperatures between about 250° C. and about 900° C. A pyrolysis temperature range for producing desired products may extend through only a portion of the total pyrolysis temperature range. In some embodiments, a pyrolysis temperature range for producing desired products may include temperatures between about 250° C. to about 400° C. If a temperature of hydrocarbons in a formation is slowly raised through a temperature range from about 250° C. to about 400° C., production of pyrolysis products may be substantially complete when the temperature approaches 400° C. Heating the oil shale formation with a plurality of heat sources 120 may establish thermal gradients around the heat sources 120 that slowly raise the temperature of hydrocarbons in the formation through a pyrolysis temperature range.

In some in situ conversion embodiments, a temperature of the hydrocarbons to be subjected to pyrolysis may not be slowly increased throughout a temperature range from about 250° C. to about 400° C. The hydrocarbons in the formation may be heated to a desired temperature (e.g., about 325° C.). Other temperatures may be selected as the desired temperature. Superposition of heat from heat sources 120 may allow the desired temperature to be relatively quickly and efficiently established in the formation. Energy input into the formation from the heat sources 120 may be adjusted to maintain the temperature in the formation substantially at the desired temperature. The hydrocarbons may be maintained substantially at the desired temperature until pyrolysis declines such that production of desired formation fluids from the formation becomes uneconomical.

Formation fluids including pyrolyzation fluids may be produced from the formation. The pyrolyzation fluids may include, but are not limited to, hydrocarbons, H₂, CO₂, carbon monoxide, hydrogen sulfide, ammonia, nitrogen, water, and mixtures thereof. As the temperature of the formation increases, the amount of condensable hydrocarbons in the produced formation fluid tends to decrease. At high temperatures, the formation may produce mostly methane and/or H₂. If an oil shale formation is heated throughout an entire pyrolysis range, the formation may produce only small amounts of H₂ towards an upper limit of the pyrolysis range. After all of the available hydrogen is depleted, a minimal amount of fluid production from the formation will typically occur.

After pyrolysis of hydrocarbons, a large amount of carbon and some hydrogen may still be present in the formation. A significant portion of remaining carbon in the formation can be produced from the formation in the form of synthesis gas. Synthesis gas generation may take place during stage 3 heating depicted in FIG. 28. Stage 3 may include heating an oil shale formation to a temperature sufficient to allow synthesis gas generation. For example, synthesis gas may be produced within a temperature range from about 400° C. to about 1200° C. The temperature of the formation when the synthesis gas generating fluid is introduced to the formation may determine the composition of synthesis gas produced within the formation. If a synthesis gas generating fluid is introduced into a formation at a temperature sufficient to allow synthesis gas generation, synthesis gas may be generated within the formation. The generated synthesis gas may be removed from the formation through a production well or production wells. A large volume of synthesis gas may be produced during generation of synthesis gas.

Total energy content of fluids produced from an oil shale formation may stay relatively constant throughout pyrolysis and synthesis gas generation. During pyrolysis at relatively low formation temperatures, a significant portion of the produced fluid may be condensable hydrocarbons that have a high energy content. At higher pyrolysis temperatures, however, less of the formation fluid may include condensable hydrocarbons. More non-condensable formation fluids may be produced from the formation. Energy content per unit volume of the produced fluid may decline slightly during generation of predominantly non-condensable formation fluids. During synthesis gas generation, energy content per unit volume of produced synthesis gas declines significantly compared to energy content of pyrolyzation fluid. The volume of the produced synthesis gas, however, will in many instances increase substantially, thereby compensating for the decreased energy content.

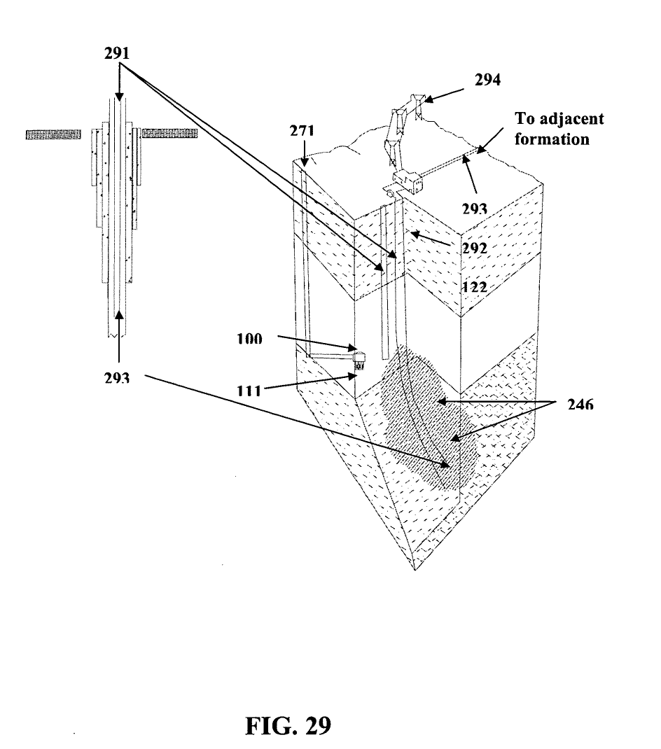

FIG. 29 is a schematic vertical cross section of geothermal energy production according to one embodiment of the current invention. As shown above as an oil shale formation is initially heated, water within the formation may be vaporized. U.S. Pat. No. 5,085,276 to Rivas, et al. describes a method for producing oil from low permeability formations by sequential steam fracturing. Cyclical injection of wet steam in a short cycling sequence heats the formation through controllably induced formation fractures 246. Oil is subsequently produced from the fractured low permeability formation.

It may be advantageous to the production of an unconventional oil formation 122 to allow the initial steam pressure within the formation to build to a pressure exceeding the fracture pressure of the formation. Said pressure could be sequenced by periodically venting said steam from the formation. As described above said steam may be produced from the formation and could be used to generate power or could be injected into an adjacent portion of the formation to build heat into said adjacent portion.

The fracturing of a portion of an unconventional oil formation 122, such as a rich zone of an oil shale formation, and the subsequent removal of the water from the formation as described above, increases the pore volume in the formation and may increase the storage space for hydrocarbons within the pore volume.

As illustrated in FIG. 28, the yield in barrels of oil equivalent per ton of an oil shale formation and the nature of the formation fluids produced from an oil shale formation are dependent on the temperature of the formation.

SNF 111 produces heat constantly until such time as its radioactivity has completely decayed. It cannot be cycled off and on. The process of radioactive decay is slow thus nuclear waste within an unconventional oil formation 122 is likely to produce heat long after all of the available hydrocarbons within the formation in which the waste has been placed have been recovered. With nuclear energy constantly radiating heat into said formation, the temperature of the formation will continue to rise and the heat front within the formation will continuously expand. As shown above a pyrolysis temperature range for producing desired products from an oil shale formation, such as condensable hydrocarbons, may extend through only a portion of the total pyrolysis temperature range. In some embodiments, a pyrolysis temperature range for producing desired products may include temperatures between about 250° C. to about 400° C. If a temperature of hydrocarbons in a formation is slowly raised through a temperature range from about 250° C. to about 400° C., production of pyrolysis products may be substantially complete when the temperature approaches 400° C.

According to an embodiment of the current invention, the temperature within the formation may be throttled in order that the temperature of hydrocarbons in the formation is slowly raised through the desired temperature range by injecting water back down a well 291 used to initially vent steam from the formation. This would be similar to the CSS method in reverse. Said injected water would absorb a portion of the nuclear energy input into the formation, be vaporized and returned to the surface as steam 293 up a central collecting pipe inserted within the injection well 291 or through an adjacent well 292. Said steam 293 could then be used to generate power or could be injected into an adjacent portion of the formation to build heat into said adjacent portion.

Once production of the pyrolysis products within a portion of an oil shale formation, or the recovery of bitumen or heavy oil within a portion of an unconventional oil formation 122, using the nuclear energy of SNF 111, is complete the remaining nuclear energy input into the formation may be recovered as steam 293, as described above, either to be recirculated into an adjacent undepleted portion of the formation or to produce others forms of energy such as electrical power 294. Some of which might be used, in accordance with the art described in U.S. Pat. No. 7,225,866 to Berchenko, et al., to process other undepleted portions the oil shale formation.

In the alternative heat producing SNF 111 could be removed from a portion of an unconventional oil formation 122 that has been fully produced and returned to an undepleted portion of the formation in order that hydrocarbons could be recovered from said undepleted portion.

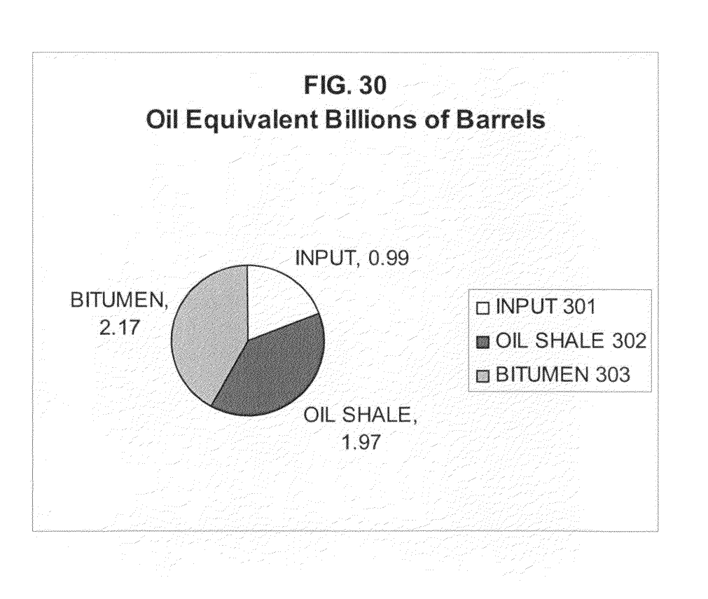

FIG. 30 is a pie chart of the potential energy saving afforded by this invention to produce North America's unconventional oil

The total pie represents the number of barrels of oil that potentially could be produced by the heat flux of the North American inventory of spent fuel. As shown in Table 1 said inventory is 33,858 tons for Canada 22 and 49,352 for the USA as of 2005, for a total of 83,210 tons. As above Hardin estimates the heat flux of US spent at between 30 and 50 times 13,000 gigawatt-hours per year, or conservatively 390,000 gigawatt-hours per year. Including Canada's waste this would come to roughly 390,000*(83,210/49,352) or 657,560 gigawatt-hours per year.

Per Table 3 however the heat produced per metric ton of heavy metal is 1212 watts. The total initial wattage produce by the heat flux of North American spent fuel per hour should therefore be ((83210 tons*1212 watts*2000 lbs)(/2240 lbs), or 90,045,107 watts or 324.16213857 Gigawatt-hours−((90,045,107 watts*60 seconds*60 minutes)/1,000,000,000). Per year this is 324.16*24*365 or 2,838,240 Gigawatt-hours.

The median between this two estimates is (657,560+2,838,240)/2 or 1,747,900 Gigawatt-hours of energy, which will be the quantity used for the purpose of this demonstration.

The oil equivalent of a Gigawatt hour is 563.990352583 barrels U.S., so the number of barrel equivalents for 1 years worth of power generated by the heat flux of the North American inventory of SNF 111 is estimated at (1,747,900 Gigawatt-hours*563.990352583 barrels/Gigawatt-hour) or 985,798,121 barrels of oil, which is shown in billions as 301 or input in FIG. 30

As stated above, Shell reports its ICP would produce 3 Btu's for every Btu consumed. Utilizing SNF 111 to produce oil shale in place of Shell's heaters therefore has the potential to produce 3*985,798,121 barrels or 2,957,394,363 barrels. The 1.971596242 billion barrel increase this represents over the 0.98 barrel input is 302 of FIG. 30.

As indicated above the EROI for bitumen is 5.2/1 therefore 5.2*985,798,121 or 5,126,150,229 barrels of oil could potentially be produced from Alberta's bitumen by the heat flux of North America's SNF 111. This increment is shown as 303 of FIG. 30 for a total of 5.13 billion barrels.

Regardless of the price of power or the true heat flux of North America's spent fuel inventory, the heat flux of SNF 111 has the potential to produce significant amounts of unconventional oil at minimal to no cost for energy. Whereas recent costs estimates for a Yucca Mountain repository 100 are in the range of U.S. $100 billion, and said costs offers zero potential return on investment.

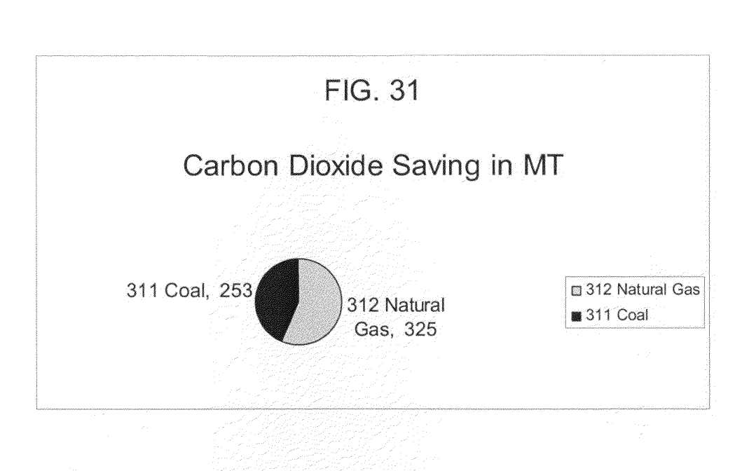

FIG. 31 depicts the total estimated CO₂ saving afforded by the current invention.

Burning natural gas, which is widely available in the oil sands area, currently produces most of the energy used to extract Alberta's bitumen. To extract oil shale deposits from the Green River Formation 6 it is anticipated coal will be the primary energy source.

One ton of coal is the equivalent of 4.879 barrels of crude oil, so 985,798,121 barrels of oil, as would be equivalent amount of heat available from the North American inventory of SNF 111 to produce oil from the Green River Formation 6, is the equivalent of (985,798,121 barrels/4.879) or 202,049,215 tons of coal. The burning of 1 ton of coal produces 2.86 short tons of CO₂ so by utilizing the heat flux of North America's spent fuel inventory to produce oil shale, an annual saving of approximately (202,049,215*2.86) or 577,860,755 short tons of CO₂ would result. This saving is represented by the total pie in FIG. 31.

Coal produces 1.78 times as much CO₂ to produce a unit of energy, as does the burning of natural gas. The annual heat flux of North America's nuclear waste inventory used to produce Alberta bitumen would therefore save (577,860,755/1.78) or 324,640,874 short tons of CO₂ which is the increment represented by 312 in FIG. 31. The 253 MT of CO₂ that would be produced to produce oil from oil shale utilizing coal, over and above the amount produced by natural gas to produce Alberta's bitumen, is represented by 311 of FIG. 31.

The oil sand industry is one of the major GHG emitters in Canada 22 and the entire process approximately doubles to triples the amount of CO₂ released per barrel of petroleum used compared to conventional extraction.

In 2002 Canada 22 agreed to reduce their GHG emissions by 6% compared to their 1990 emissions in the Annex I period of the Kyoto protocol (2008-2012). By 2004, however, Canada's GHG emissions had risen by 28% above 1990 levels. In 2006, Canada 22 declared it could not meet their Kyoto targets and even considered removing policies designed to meet the targets.

While the emissions intensity of producing oil sands has decreased substantially, i.e., 26% over the past decade, total emissions are expected to increase due to higher production levels. Currently, to produce one barrel of oil from the oil sands releases almost 75 kg of GHG with total emissions estimated to be 67 megatonne (Mt) per year by 2015.

In January 2008, the Alberta government released Alberta's 2008 Climate Change Strategy. Alberta's emissions are projected to grow to 400 Mt by 2050, largely due to forecast growth in the oil sands sector The new plan will cut the projected 400 Mt in half by 2050, with a 139 Mt reduction coming from carbon capture and storage—the bulk of those reductions (100 Mt) will come from activities related to oil sands production

The use of the North American inventory of SNF 111 on the other hand could save 324 Mt of CO₂ annually, produce more oil, and eliminate the major impediment to the production of Alberta's bitumen resources such as Section 526 of the U.S. Energy Independence and Security Act of 2007. As state above Section 526 sets a standard for GHG emissions that no existing technology, aside from the current invention, can meet. No U.S. federal agency therefore should be able to legally enter into a contract to procure synthetic fuel produced by any method other than by an embodiment of the current invention.

The current invention may also be the only means whereby Canada 22 can meet its commitment under the Kyoto protocol.

Putting a price on the emissions generated by fossil fuels has become a mainstream idea, endorsed by many in industry and government. The province of British Columbia introduced a $10-a-tonne carbon tax on all fuels Jul. 1, 2008, which will rise to $30 a tonne by 2010. Numerous others suggest the price per tonne should fall in a range of between $10 and $200. Under any such system a method, as embodied in this invention, that would save between 324 and 577 Mt of CO₂ producing a diminishing hydrocarbon resource, at the same time as it eliminated the major roadblock to the expansion of nuclear power, would be economically advantageous and publicly beneficial.

The embodiments of the invention in which an exclusive property or privilege is claimed are defined as follows:

1. A method forming at least one repository for high-level radioactive waste comprising locating the waste in an unconventional oil formation at or near ambient temperatures and pressures wherein said unconventional oil formation may contain heavy hydrocarbon raw material such as:
a. heavy oil having an API gravity less than 20 and/or;
b. sand and/or clay with bitumen and/or;
c. oil shale.

2. A method as claimed in claim 1 wherein:
a. one or more said repositories may be substantially horizontal drifts excavated from one or more substantially vertical shafts excavated into said unconventional oil formation;
b. one or more said repositories may be substantially vertical wellbores penetrating said unconventional oil formation;
c. said high-level radioactive waste is situated in said repository beneath a capping sedimentary rock formation having a hydraulic conductivity of approximately 10-6 meters per day or less;
d. the cross section of said repository is minimally larger than the diameter of the high-level radioactive waste packages, wherein said minimal cross section preserves the geologic containment properties of the formation;
e. heavy hydrocarbon raw material are treated with ionizing radiation, the source of which is said high-level radioactive waste, wherein said ionization radiation fractures a portion of the heavy hydrocarbon raw material to liberate a portion of the light hydrocarbon fractions having relatively low molecular weights in the range of gases and light liquids;
f. said high-level radioactive waste irradiates a portion of the in situ water resident in the unconventional oil formation such that a portion of said water is dissociated by radiation into H⁺ and OH⁻ radicals, wherein said H³⁰ radicals assist in cracking a portion of the heavy hydrocarbon raw material to liberate a portion of the light hydrocarbon fractions having relatively low molecular weights in the range of gases and light liquids; and
g. decay heat of said high-level radioactive waste transfers to the unconventional oil formation.

3. A method as claimed in claim 2 wherein:
a. the portion of said vertical shafts or said wellbores above said capping sedimentary rock formation is sealed by an impermeable seal once high-level radioactive waste has been located in said repository; and
b. said capping sedimentary rock formation is of sufficient thickness to resist fracturing.

4. A method as claimed in claim 2 comprising the transfer of said decay heat substantially by radiation wherein:
a. said decay heat may lower the viscosity of heavy oil, which is substantially immobile at prevailing formation temperatures;
b. said decay heat may raise the temperature of heavy hydrocarbon raw material contained in the unconventional oil formation through a range of between 50° C. and 160° C., which is referred to as the oil window, wherein a portion of said heavy hydrocarbon raw material is converted to crude oil; and/or
c. said decay heat may raise the temperature of heavy hydrocarbon raw material in an unconventional oil formation to a pyrolyzation temperature liberating a portion of the light hydrocarbon fractions having relatively low molecular weights in the range of gases and light liquids.

5. A sustainable method as claimed in claim 2 wherein said decay heat is produced absent the creation of the greenhouse gas CO₂.

6. An economical and energy-efficient method as claimed in claim 2 wherein said decay heat is waste heat.

7. A method as claimed in claim 2 wherein the transfer of said decay heat is controlled by the insertion of a well for injecting fluids adjacent the repository such that said fluids absorb excess heat which is then produced from said well either in the form of liquid or vapor.

8. A method as claimed in claim 1, claim 2 and claim 4 for recovering heavy oil, produced oil and light hydrocarbon fractions from an unconventional oil formation comprising:
a. penetrating said unconventional oil formation with at least one well for producing said heavy oil, and/or produced oil and/or light hydrocarbon fractions, wherein said repository and said well are constructed and arranged so as to promote the growth of a heated region in said formation adjacent to said repository;
b. completing said well so that said heated and mobilized heavy oil, produced oil and/or light hydrocarbon fractions flow towards said well; and
c. producing said heavy oil, produced oil and/or light hydrocarbon fractions through said well.

9. A method as claimed in claim 8 wherein:
a. said well may be substantially vertical within said formation; and/or
b. said well may be substantially horizontal and is situated beneath said repository, wherein produced hydrocarbons drains to the well under the influence of gravity.

10. An economical and proliferation resistant method for eliminating plutonium excess to defense needs and/or separated from spent commercial nuclear fuel wherein:
a. said plutonium is placed in the sidewalls and or floor of a horizontal repository prior to filling said repository with high-level radioactive waste, wherein said high-level radioactive waste renders the plutonium as proliferation resistant as plutonium contained in spent nuclear fuel; or
b. said plutonium may be placed in the deepest portion of a wellbore prior to inserting high-level radioactive waste above said repository, wherein said high-level waste renders plutonium as proliferation resistant as plutonium contained in spent nuclear fuel.
